(19) United States
(12) Patent Application Publication
(10) Pub. No.: US 2018/0223542 A1
(43) Pub. Date: Aug. 9, 2018

(54) OUTDOOR WOOD DECKING BOARD

(71) Applicants: Terry Allen Tebb, Gig Harbor, WA (US); Travis Mark Tebb, Gig Harbor, WA (US)

(72) Inventors: Terry Allen Tebb, Gig Harbor, WA (US); Travis Mark Tebb, Gig Harbor, WA (US)

(21) Appl. No.: 15/426,036

(22) Filed: Feb. 6, 2017

(51) Int. Cl. E04F 15/04; B32B 7/12; B32B 21/14; B32B 37/12; B32B 37/14; E04B 1/00

(52) U.S. Cl. CPC E04F 15/04; B32B 7/12; B32B 21/14; B32B 37/12; B32B 2309/105; E04B 1/003; E04F 15/043; E04F 15/041; B32B 2419/00; B32B 37/14

(57) ABSTRACT

An outdoor wood decking board for use in construction of an outdoor deck floor, the outdoor wood decking board including a wood core, formed from a first wood species preselected from any one of a common grade North American Softwood, as a three dimensional solid rigid wood body. A facing wood veneer formed from a second wood species of superior grade North American Softwood species as a three dimensional solid rigid wood finishing layer is permanently seamlessly attached via a pressure sensitive liquid adhesive to a first wood face of the wood core. In another embodiment the facing wood veneer is formed of a third wood species including an exotic hardwood species. In another embodiment the wood core is formed from a wood plastic composite. In another embodiment, the wood core is formed from a cement board. Methods of manufacture of the outdoor wood decking board are embodied and disclosed.

### FIELD OF THE DISCLOSURE

The present disclosure relates to an outdoor wood decking board for use in the outdoor deck floor construction industry. More specifically, the present disclosure relates to an outdoor wood decking board for use in construction of an outdoor deck floor, the outdoor wood decking board constructed in a layered arrangement with a wood core including a facing wood veneer manufactured with a high grade wood species layered upon the wood core, the facing wood veneer visible to a user. The outdoor wood decking board can include a dual veneered wood core.

### BACKGROUND

Embodiments described herein relate generally to outdoor wood decking boards for use in the construction of an outdoor deck floor, the outdoor wood decking board constructed in a layered arrangement with a wood core having a facing wood veneer layered upon a first face of the wood core, the facing wood veneer manufactured with a superior grade wood species visible to a user so that the outdoor wood decking board is aesthetically pleasing to the viewer, or consumer. In another embodiment, an outdoor wood decking boards includes a second facing wood veneer of high grade wood species is layered upon a second face of the wood core, the second high grade wood veneer visible to the user from underneath the outdoor deck floor,

In another embodiment, the facing wood veneer is formed from an exotic hardwood species.

In another embodiment the wood core is formed from a wood plastic composite. In yet another embodiment, the wood core is formed from a concrete board.

In the construction of outdoor deck floors, it is often desirable to utilize a plurality of outdoor wood decking boards made from a superior grade wood species, such as a clear grade vertical grain western red cedar. The outdoor deck floor made from the plurality of outdoor wood decking boards made from the superior grade wood species can exhaust the natural resources of the wood species in a particular geographical area and can be very expensive. It is not uncommon for construction wood materials to increase exponentially in cost for every increase in use of high grade woods, increase in length or width of the construction wood materials for use in the construction of the outdoor deck floor.

An alternative approach has been developed in the disclosed embodiments where the outdoor wood decking board includes a wood core manufactured with a low grade wood species; the wood core is layered on the first face of the wood core with a facing wood veneer formed from a superior grade wood species. In another embodiment, a second facing wood veneer formed from a high grade wood species is layered upon a second face of the wood core, the second facing wood veneer visible to a user from underneath the outdoor deck floor.

The use of the veneer layers manufactured with high grade wood species is a novel embodiment of outdoor wood decking boards with the purpose of preserving high grade wood species and preventing excessive consumption of high grade woods in the manufacture of outdoor wood decking boards. In addition, the use of veneer layers with high grade wood species provides an aesthetic look to the outdoor deck floor adding value to the outdoor deck floor and to the home attached thereof, whereas the outdoor wood decking boards are cost efficient because the core is manufactured from a less expensive wood species.

Superior grade outdoor deck floors typically require manufacturing each outdoor wood decking board for use in the construction of outdoor decks using an enormity of natural wood resources of high grade wood species so that each outdoor wood decking board is completely manufactured with a piece of a high grade wood species. A known problem to this approach is that the natural resources including a variety of high grade wood species are exposed to exhaustion of the wood species particular to a certain geographical region. In addition, this method is not cost prohibitive.

An additional problem of the conventional manufactured outdoor wood decking boards for use in the construction of outdoor deck floors is that the formed outdoor wood decking boards when manufactured with low grade outdoor wood decking boards are susceptible to the wood splintering. Therefore, the common grade outdoor wood decking boards must be treated with agents to prevent the splinters. The use of superior grade woods for the manufacture of the facing wood veneers eliminates the need to treat the low grade wood cores with anti-splintering agents.

Thus, there is a need for an effective way to manufacture superior grade outdoor wood decking boards for use in the construction of outdoor deck floors without substantially threatening the natural resources of high grade wood species in a particular geographic area. In addition, there is a need for a way to effectively deal with high costs of manufacturing the high grade wood cores necessary in the construction of the outdoor wood decking boards for use in construction of outdoor deck floors by minimizing the amount of high grade wood species expended in the process. Also, there is a need for an effective way to reduce splintering of low grade wood cores by increasing outdoor deck floor smoothness and aesthetics, while still maintaining low costs and durability of the outdoor wood decking boards for outdoor use in the construction of the outdoor deck floors.

### SUMMARY

Therefore, Applicant has developed an outdoor wood decking board for use in construction of an outdoor deck floor, embodiments of the outdoor wood decking board of which are disclosed herein. The outdoor wood decking board is adapted for use as an outdoor wood decking board including a wood core having a facing wood veneer permanently attached thereon a first wood face of the wood core forming a three dimensional solid rigid wood body including a thickness (T), a width (W), and a length (L). The wood core is manufactured from a first wood species, the first wood species preselected from any one of a common grade or general purpose grade of North American Softwood species; and the facing wood veneer is manufactured from a second wood species, the second wood species preselected from any one of a superior grade of North American Softwood species including a clear vertical grain western red cedar species, and clear grain of the North American Softwood species. In another embodiment, the facing wood veneer is formed from an exotic hardwood species.

A pressure sensitive liquid adhesive seamlessly permanently attaches the facing wood veneer against the wood core thereby a plurality of outdoor wood decking boards adapted to be arranged along interior longitudinal wood side edges of each other form an assemble simulated non-cactile superior grade outdoor deck floor, including a clear vertical grain western red cedar outdoor deck floor of preconfigured dimensions.

In one exemplary embodiment, the outdoor wood decking boards are embodied with a first facing wood veneer seamlessly permanently attached upon a first face of the wood core.

In another exemplary embodiment, the outdoor wood decking boards are embodied with a first facing wood veneer and a second facing wood veneer seamlessly permanently attached to the wood core forming an upper facing wood veneered wood core and a lower facing wood veneered wood core. In this embodiment, a first facing wood veneer is seamlessly permanently attached on a first face of the wood core; and the second facing wood veneer is seamlessly permanently attached to a second face of the wood core.

In another exemplary embodiment, the outdoor wood decking boards are embodied including two wood cores aligned longitudinally to each other and seamlessly permanently attached to each other to form a face-to-face wood core. A facing wood veneer formed from a high quality wood species of high grade is seamlessly permanently attached to the wood core.

In another exemplary embodiment, the outdoor wood decking boards are embodied including a composite wood core assembly, the composite wood core assembly including a series of wood cores joined together along a longitudinal axis thereof to form a simulated single unit solid rigid wood core, wherein the simulated single unit solid rigid wood core is embodied with a high quality facing wood veneer seamlessly permanently attached to the simulated single unit solid rigid wood core.

### BRIEF DESCRIPTION

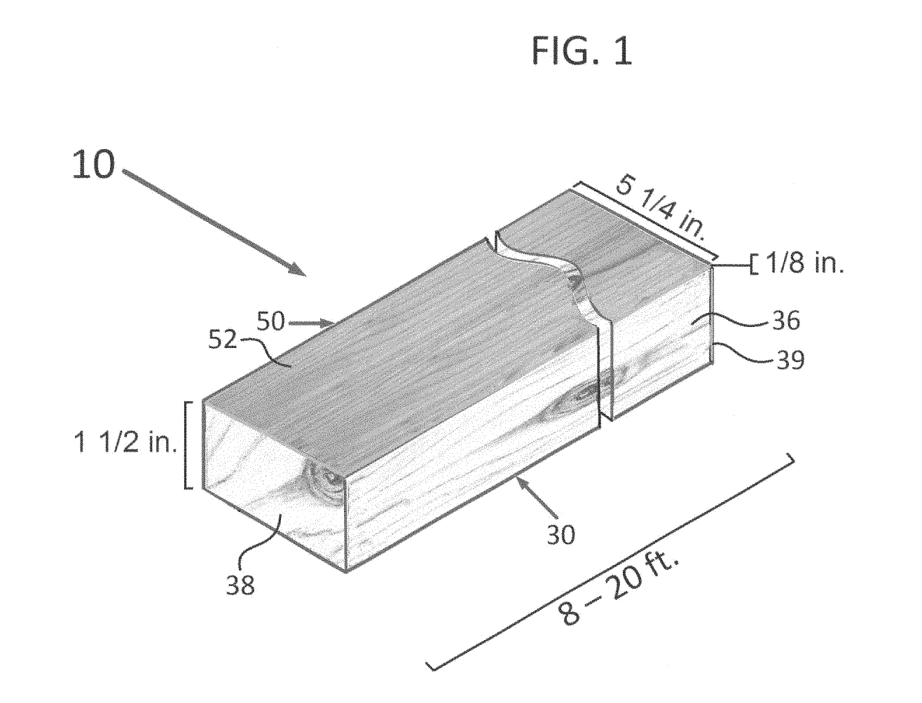

FIG. 1 is a perspective view of an outdoor wood decking board, according to an embodiment of the present disclosure.

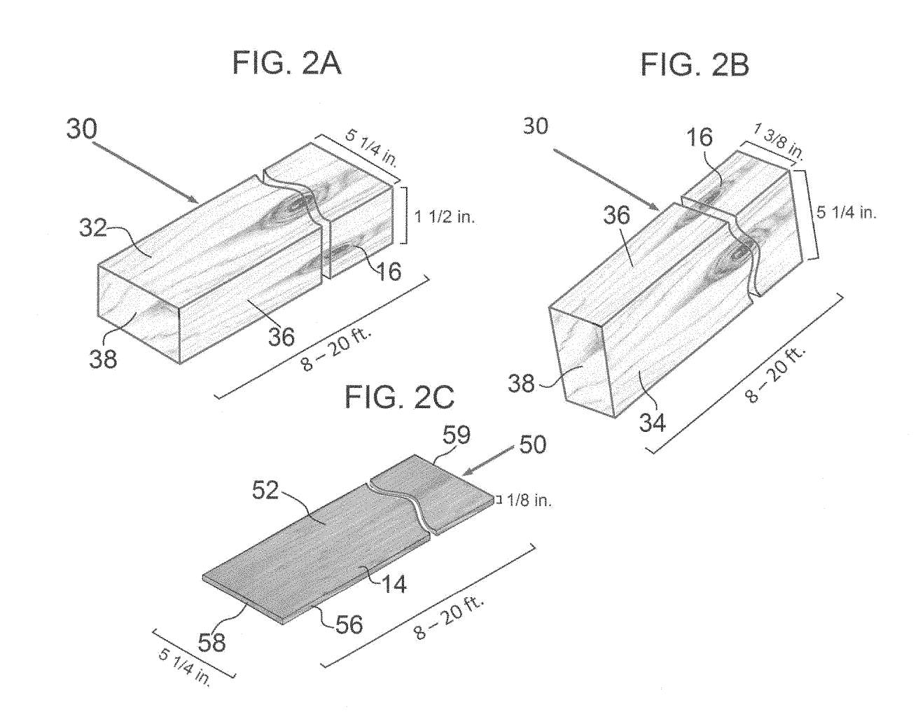

FIG. 2A is a top perspective view of a wood core of the outdoor wood decking board of FIG. 1, according to an embodiment of the disclosure.

FIG. 2B is a side perspective view of the wood core of FIG. 2A, according to an embodiment of the disclosure.

FIG. 2C is a top perspective view of a facing wood veneer of the outdoor wood decking board of FIG. 1, according to an embodiment of the disclosure.

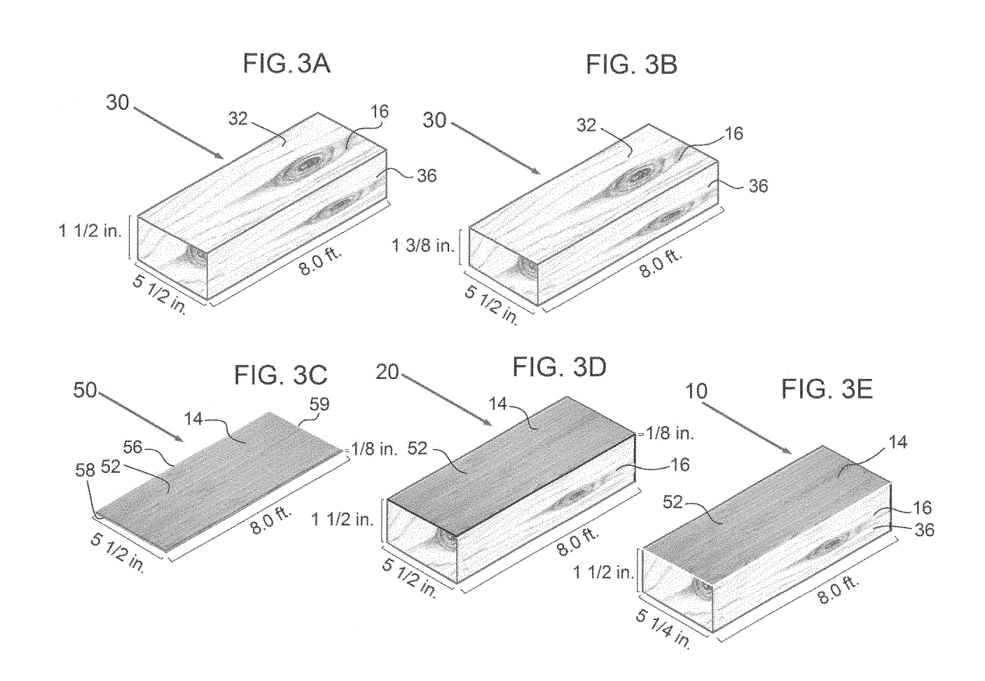

FIG. 3A is a top perspective view of a wood core of an outdoor wood decking board, according to an embodiment of the disclosure.

FIG. 3B is a top perspective view of the wood core of FIG. 3A illustrating sizing of the wood core of FIG. 3A, according to an embodiment of the disclosure.

FIG. 3C is a top perspective view of a facing wood veneer of the outdoor wood decking board, according to an embodiment of the disclosure.

FIG. 3D is a top perspective view of a facing wood veneered wood core, according to an embodiment of the disclosure.

FIG. 3E is a top perspective view of the outdoor wood decking board, according to an embodiment of the disclosure.

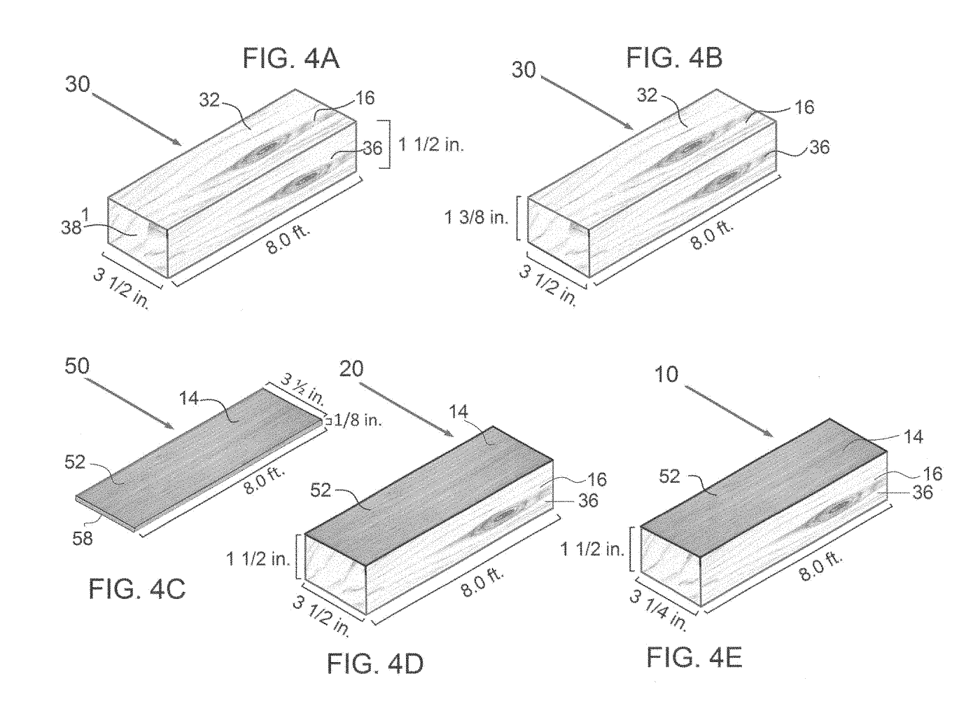

FIG. 4A is a top perspective view of a wood core of an outdoor wood decking board, according to an embodiment of the disclosure.

FIG. 4B is a top perspective view of the wood core of FIG. 4A illustrating sizing of the wood core of FIG. 4A, according to an embodiment of the disclosure.

FIG. 4C is a top perspective view of a facing wood veneer of the outdoor wood decking board, according to an embodiment of the disclosure.

FIG. 4D is a top perspective view of a facing wood veneered wood core, according to an embodiment of the disclosure.

FIG. 4E is a top perspective view of the outdoor wood decking board, according to an embodiment of the disclosure.

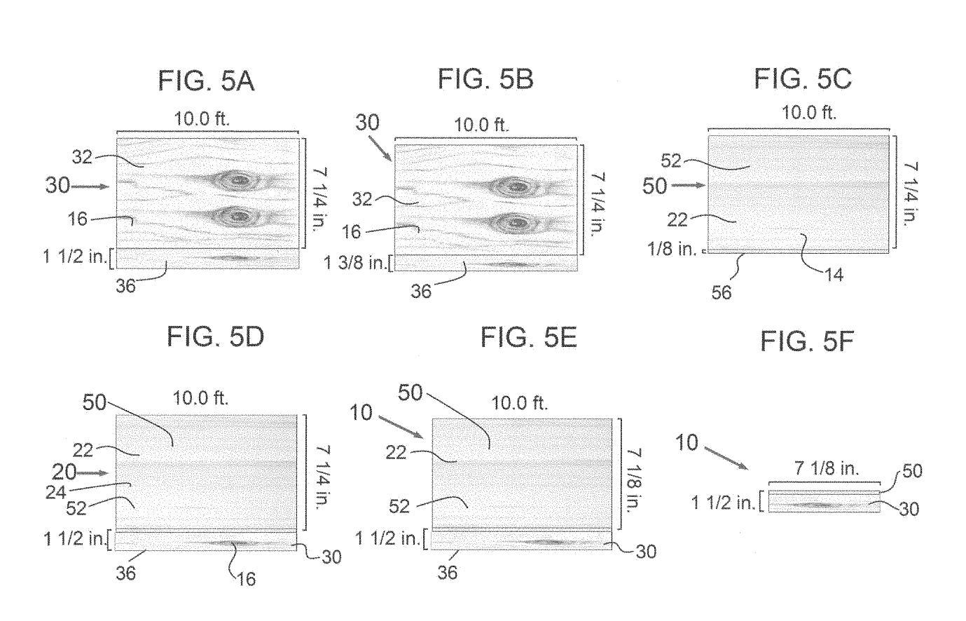

FIG. 5A is a top perspective view of a wood core of an outdoor wood decking board, according to an embodiment of the disclosure.

FIG. 5B is a top perspective view of the wood core of FIG. 5A illustrating sizing of the wood core of FIG. 5A, according to an embodiment of the disclosure.

FIG. 5C is a top perspective view of a facing wood veneer of the outdoor wood decking board, according to an embodiment of the disclosure.

FIG. 5D is a top perspective view of a facing wood veneered wood core of the outdoor wood decking board, according to an embodiment of the disclosure.

FIG. 5E is a top perspective view of the outdoor wood core, according to an embodiment of the disclosure.

FIG. 5F is a side planar view of the outdoor wood core of FIG. 5E, according to an embodiment of the disclosure.

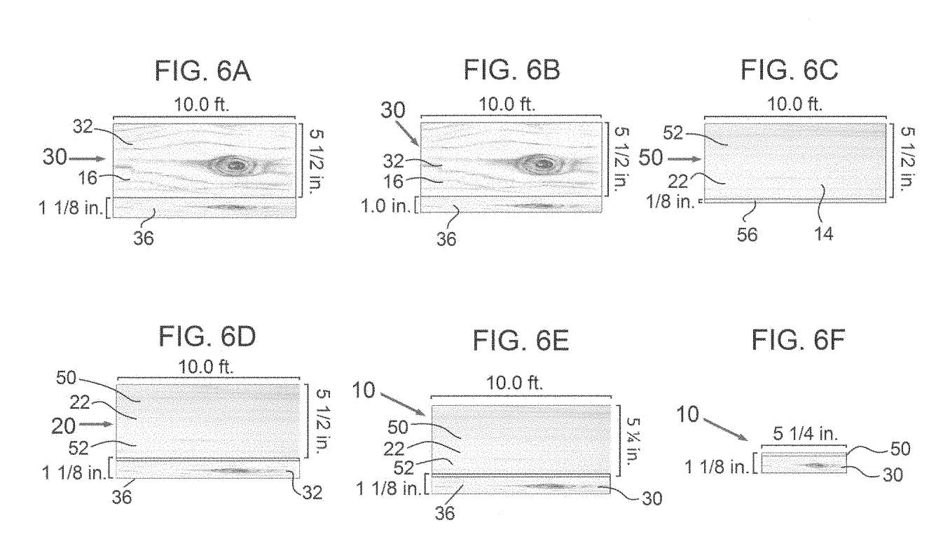

FIG. 6A is a top perspective view of a wood core of an outdoor wood decking board, according to an embodiment of the disclosure.

FIG. 6B is a top perspective view of the wood core of FIG. 6A illustrating sizing of the wood core of FIG. 6A, according to an embodiment of the disclosure.

FIG. 6C is a top perspective view of a facing wood veneer of the wood decking board, according to an embodiment of the disclosure..

FIG. 6D is a top perspective view of a facing wood veneered wood core, according to an embodiment of the disclosure.

FIG. 6E is a top perspective view of the outdoor wood decking board, according to an embodiment of the disclosure,

FIG. 6F is a side planar view of the outdoor wood decking board of FIG. 6E, according to an embodiment of the disclosure.

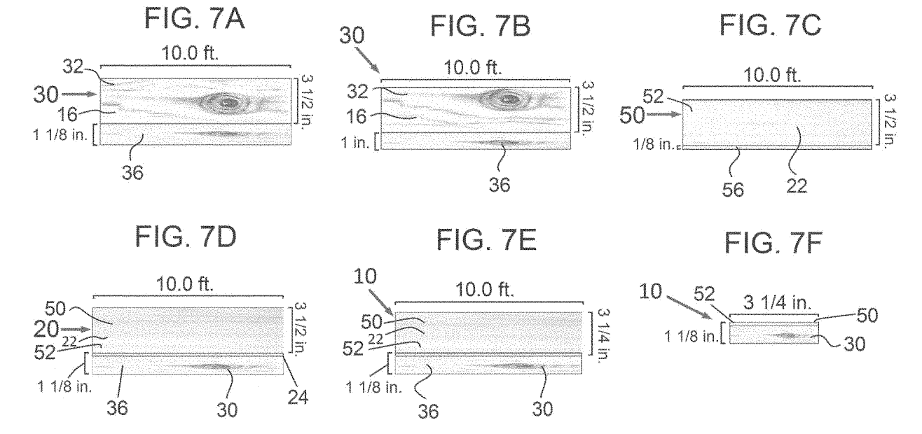

FIG. 7A is a top perspective view of a wood core of an outdoor wood decking board, according to an embodiment of the disclosure.

FIG. 7B is a top perspective view of the wood core of FIG. 7A illustrating sizing of the wood core of FIG. 7A, according to an embodiment of the disclosure.

FIG. 7C is a top perspective view of a facing wood veneer of the wood decking board, according to an embodiment of the disclosure.

FIG. 7D is a top perspective view of a facing wood veneered wood core, according to an embodiment of the disclosure.

FIG. 7E is a top perspective view of the outdoor wood decking board, according to an embodiment of the disclosure.

FIG. 7F is a side planar view of the facing wood veneered wood core of FIG. 7E, according to an embodiment of the disclosure.

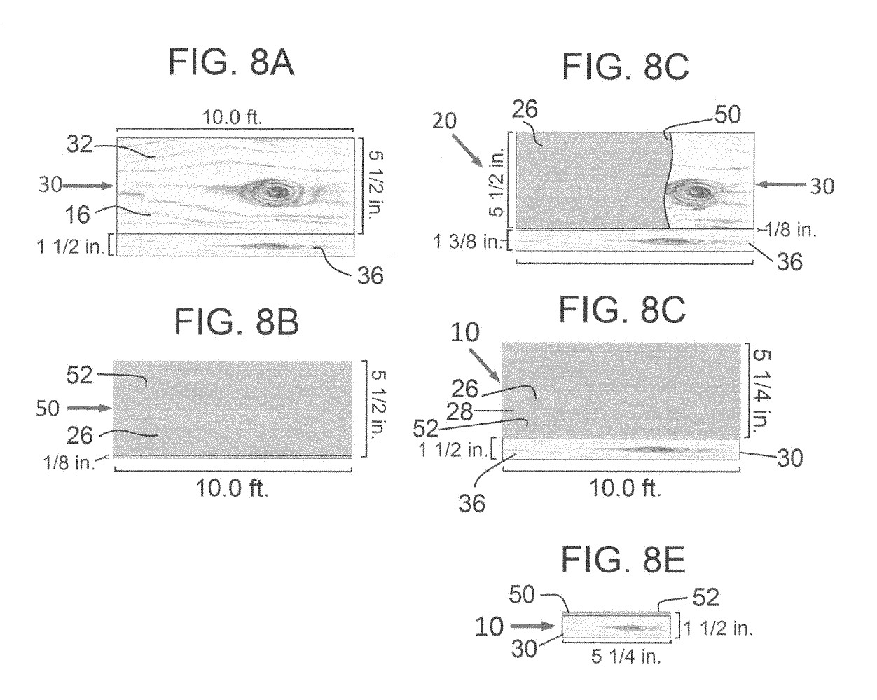

FIG. 8A is a top perspective view of a wood core of an outdoor wood decking board, according to an embodiment of the disclosure.

FIG. 8B is a top perspective view of a facing wood veneered wood core, according to an embodiment of the disclosure.

FIG. 8C is a top perspective view of a facing wood veneer of the outdoor wood decking board showing a sized wood core of FIG. 8A layered beneath the facing wood veneer of FIG. 8B, according to an embodiment of the disclosure.

FIG. 8D is a top perspective view of the outdoor wood decking board, according to an embodiment of the disclosure.

FIG. 8E is a side planar view of the outdoor wood decking board of FIG. 8D, according to an embodiment of the disclosure.

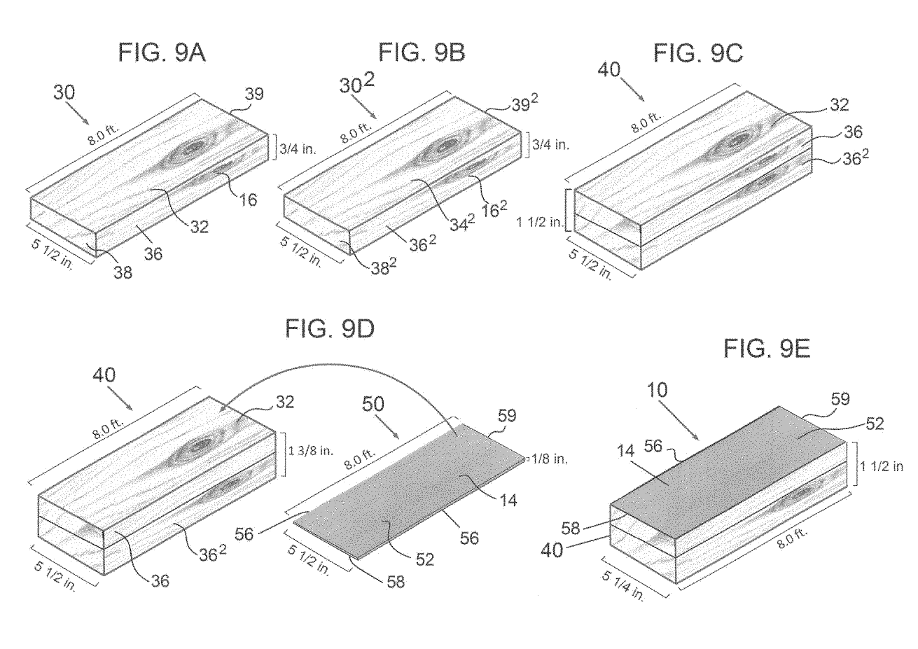

FIG. 9A is a top perspective view of a first wood core of an outdoor wood decking board, according to an embodiment of the disclosure.

FIG. 9B is a top perspective view of a second wood core of the outdoor wood decking board, according to an embodiment of the disclosure.

FIG. 9C is a top perspective view of a face-to-face wood core of the outdoor wood decking board, according to an embodiment of the disclosure.

FIG. 9D is a schematic illustration of a facing wood veneer to be overlayed onto the face-to-face wood core of FIG. 9C, according to an embodiment of the disclosure.

FIG. 9E is a top perspective view of the outdoor wood decking board, according to an embodiment of the disclosure.

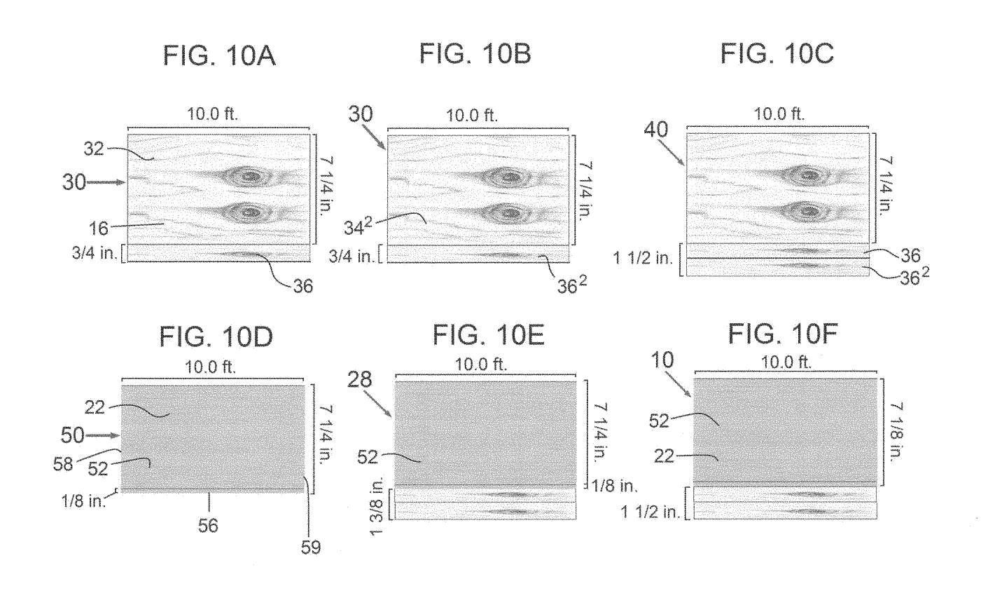

FIG. 10A is a top perspective view of a first wood core of an outdoor wood decking board, according to an embodiment of the disclosure.

FIG. 10B is a top perspective view of a second wood core of the outdoor wood decking board, according to an embodiment of the disclosure.

FIG. 10C is a top perspective view of a face-to-face wood core of the outdoor wood decking board, according to an embodiment of the disclosure.

FIG. 10D is a top perspective view of a facing wood veneer of the outdoor wood decking board, according to an embodiment of the disclosure.

FIG. 10E is a top perspective view of a facing wood veneered wood core, according to an embodiment of the disclosure.

FIG. 10F is a top perspective view of the outdoor wood decking board, according to an embodiment of the disclosure.

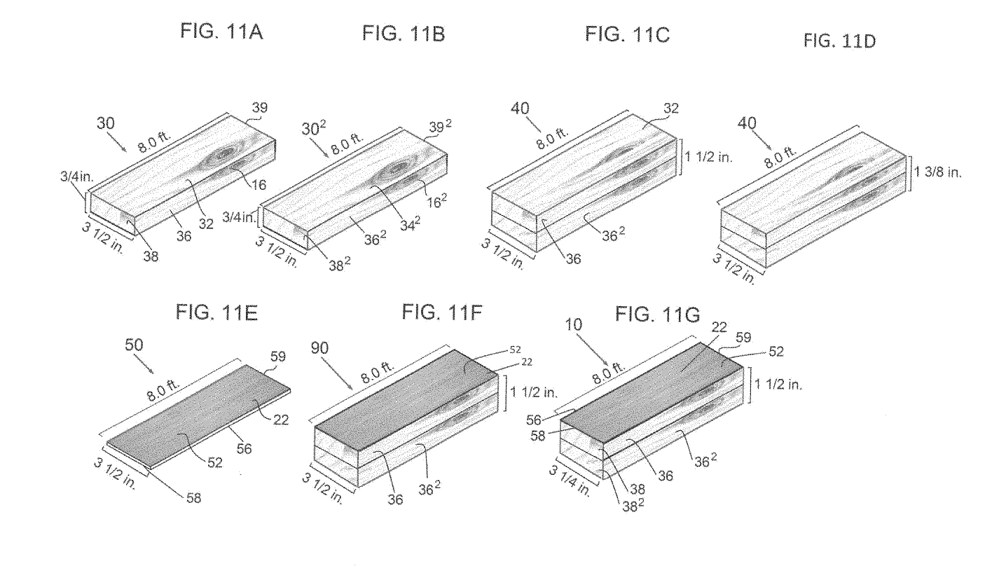

FIG. 11A is a top perspective view of a first wood core of an outdoor wood decking board, according to an embodiment of the disclosure.

FIG. 11B is a top perspective view of a second wood core of an outdoor wood decking board, according to an embodiment of the disclosure.

FIG. 11C is a top perspective view of a face-to-face wood core of the outdoor wood decking board, according to an embodiment of the disclosure.

FIG. 11D is a top perspective view of the face-to-face wood core of FIG. 11C as sized, according to an embodiment of the disclosure.

FIG. 11E is a top perspective view of a facing wood veneer of the outdoor wood decking board, according to an embodiment of the disclosure.

FIG. 11F is a top perspective view of a facing wood veneered face-to-face wood core, according to an embodiment of the disclosure.

FIG. 11G is a top perspective view of the outdoor wood decking board, according to an embodiment of the disclosure.

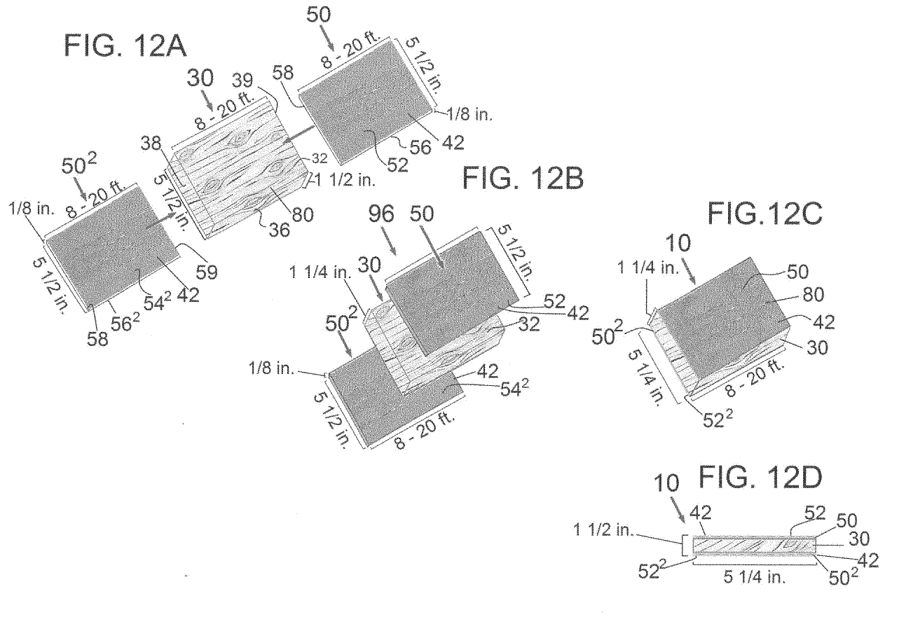

FIG. 12A is a schematic illustrating a first facing wood veneer, a wood core, and a second facing wood core of an outdoor wood decking board, according to an embodiment of the disclosure.

FIG. 12B is a schematic illustrating the first facing wood veneer, the wood core, and the second facing wood veneer of FIG. 12A showing the first facing wood veneer to be attached to a first face of the wood core, and the second facing wood veneer to be attached to a second face of the wood core, according to an embodiment of the disclosure.

FIG. 12C is a top perspective view of an outdoor wood decking board, according to an embodiment of the disclosure.

FIG. 12D is a side planar view of the outdoor wood decking board of FIG. 12C, according to an embodiment of the disclosure.

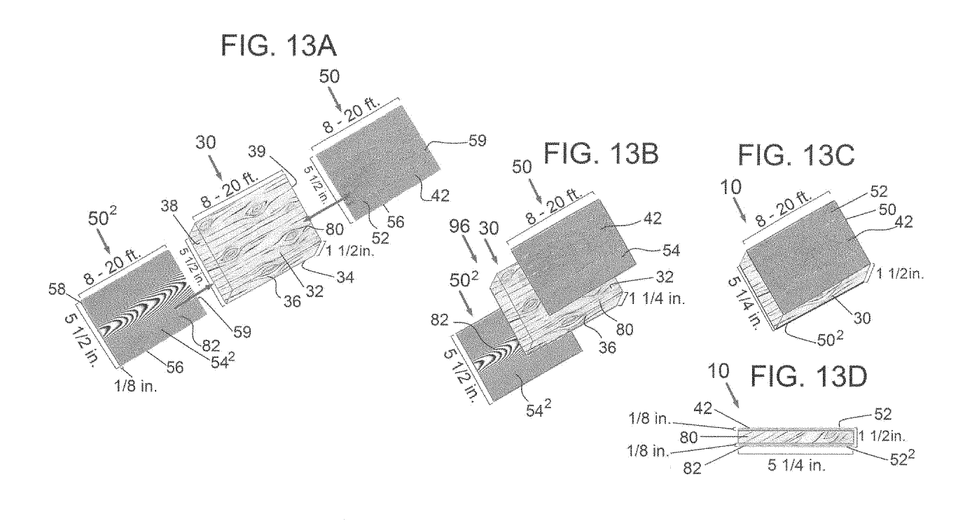

FIG. 13A is a schematic illustrating a first facing wood veneer, a wood core, and a second facing wood core of an outdoor wood decking board, according to an embodiment of the disclosure.

FIG. 13B is a schematic illustrating the first facing wood veneer, the wood core, and the second facing wood veneer of FIG. 13A showing the first facing wood veneer to be attached to a first face of the wood core, and the second facing wood veneer to be attached to a second face of the wood core.

FIG. 13C is a top perspective view of the outdoor wood decking board, according to an embodiment of the disclosure.

FIG. 13D is a side planar view of the outdoor wood decking board of FIG. 13C, according to an embodiment of the disclosure.

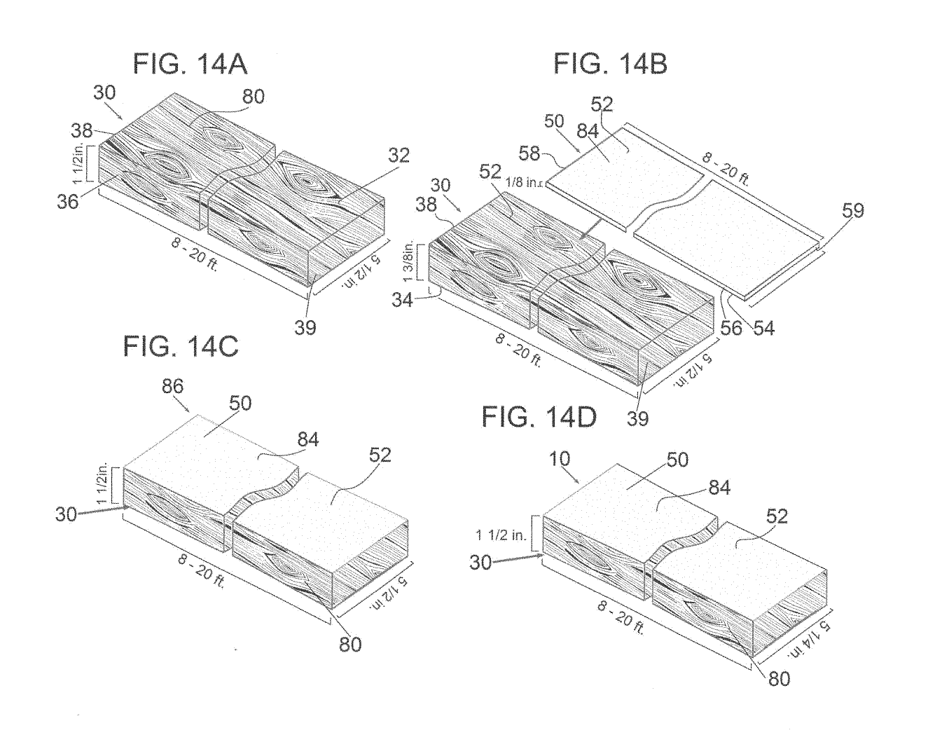

FIG. 14A is a top perspective view of a wood core, of an outdoor wood decking board, according to an embodiment of the disclosure,

FIG. 14B is a schematic illustrating the facing wood veneer to be attached to the first wood face of the wood core.

FIG. 14C is a top perspective view of a facing wood veneered wood core, according to an embodiment of the disclosure.

FIG. 14D is a top perspective view of an outdoor wood decking board, according to an embodiment of the disclosure.

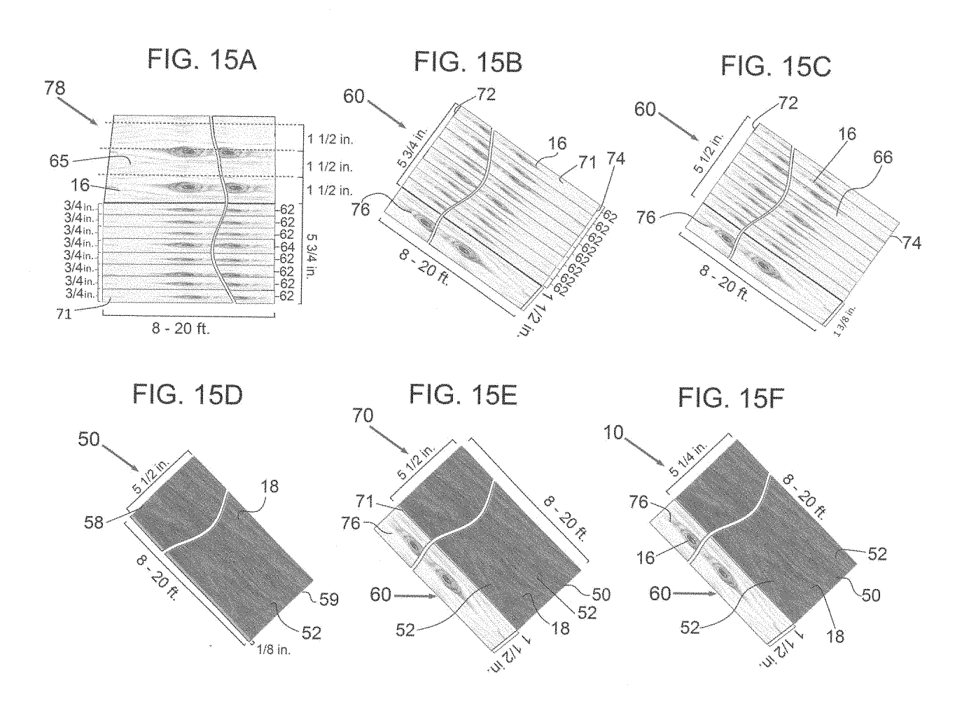

FIG. 15A is a top perspective view of a complex wood core assembly block, according to an embodiment of the disclosure.

FIG. 15B is a top perspective view of a complex wood core assembly of an outdoor wood decking board, according to an embodiment of the disclosure.

FIG. 15C is a top perspective view of the complex wood core assembly of FIG. 15B as sized, according to an embodiment of the disclosure.

FIG. 15D is a top perspective view of a facing wood veneer, according to an embodiment of the disclosure.

FIG. 15E is a top perspective view of a facing wood veneered complex wood core assembly, according to an embodiment of the disclosure.

FIG. 15F is a top perspective view of the outdoor wood decking board, according to an embodiment of the disclosure.

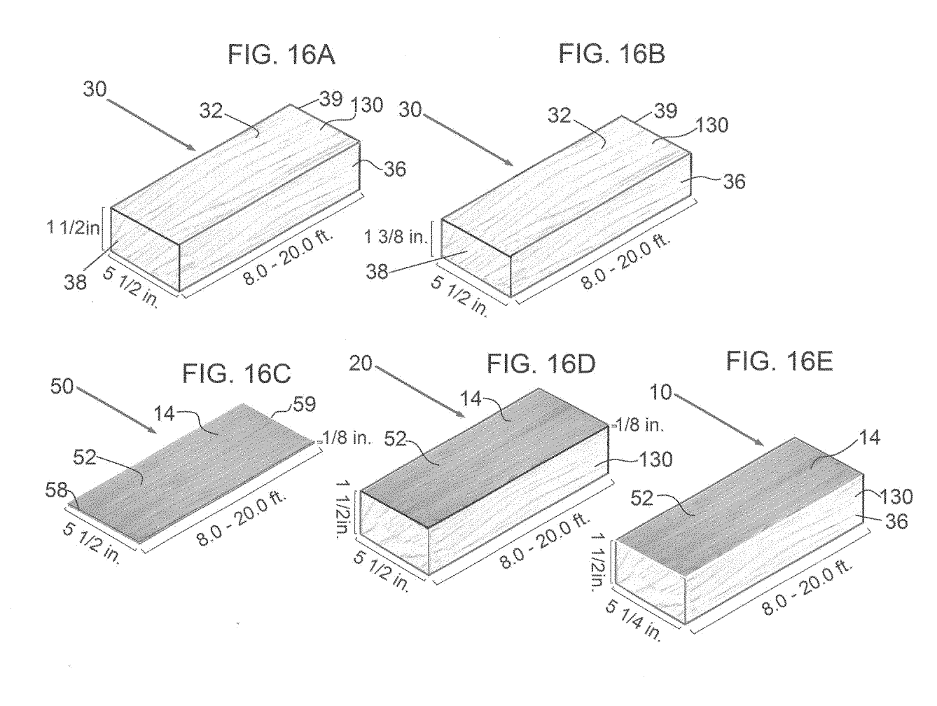

FIG. 16A is a top perspective view of a core including a wood plastic composite of an outdoor wood decking board, according to an embodiment of the disclosure.

FIG. 16B is a top perspective view of the core of FIG. 16A illustrating sizing of the core of FIG. 16A, according to an embodiment of the disclosure.

FIG. 16C is a top perspective view of a facing wood veneer of the outdoor wood decking board, according to an embodiment of the disclosure.

FIG. 16D is a top perspective view of a facing wood veneered core, according to an embodiment of the disclosure.

FIG. 16E is a top perspective view of the outdoor wood decking board, according to an embodiment of the disclosure.

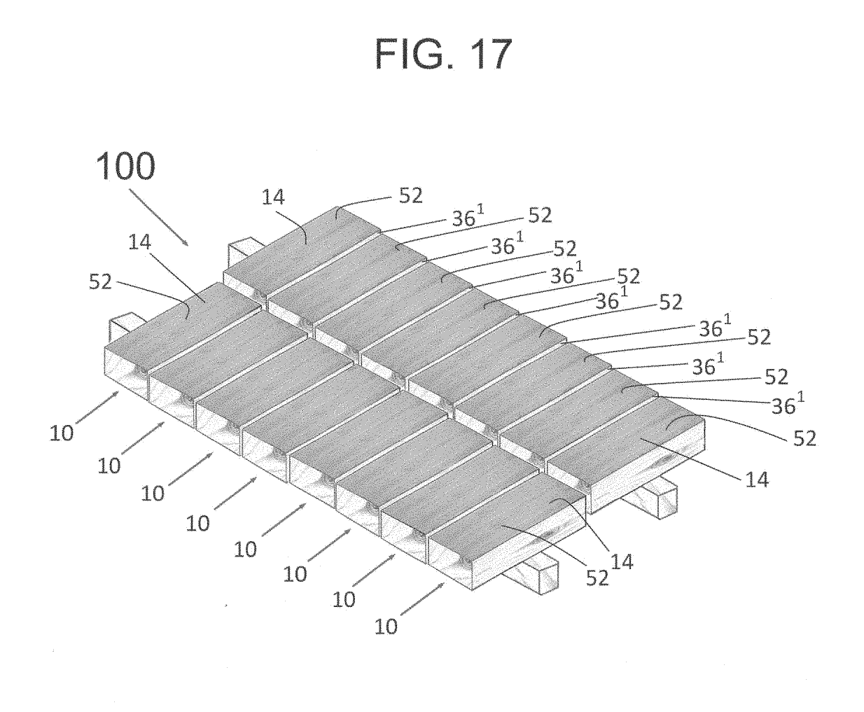

FIG. 17 is a top perspective view of an outdoor wood decking floor including a plurality of outdoor wood decking boards, according to an embodiment of the disclosure.

### DETAILED DESCRIPTION

An outdoor wood decking board for use in construction of an outdoor deck floor are disclosed herein, with reference to FIGS. 1-17. The outdoor wood decking boards 10 can be used to provide an aesthetically pleasing outdoor deck floor 100 to simulate an outdoor deck floor 100 constructed from outdoor wood decking boards 10 of superior quality grade wood species at a low cost and, more particularly, at an increased conservation of the superior grade wood species. The outdoor wood decking boards 10 are formed using a variety of wood species. In particular, the outdoor wood decking boards 10 can be formed from a variety of wood species, including common grade or general purpose grade North American Softwood species of North American Softwood wood species. The outdoor wood decking board 10 includes a facing wood veneer 50 formed from a superior grade North American Softwood species, and in another embodiment, include some of the finest exotic hardwoods found globally. Embodiments, of the outdoor wood decking board 10 disclosed herein provides an important embodiment to improve the conservation of wood species in the global environment and development stage. In addition, the superior grade wood species including the exotic hardwoods provide an outdoor wood decking board 10 that is a strong, aesthetically pleasing outdoor wood decking board 10 used for the construction of, consequentially, a strong and aesthetically pleasing outdoor wood deck floor 100.

The International Union for Conservation of Nature Red List of Threatened Species (“IUCN”) was implemented to guide the selected wood species utilized in the embodiments of the outdoor wood decking boards 10. The IUCN Red List of Threatened Species (also known as the IUCN Red List or Red Data List), founded in 1964, is the world's most comprehensive inventory of the global conservation status of biological species. The International Union for Conservation of Nature (IUCN) is the world's main authority on the conservation status of species. A series of Regional Red Lists are produced by countries or organizations, which assess the risk of extinction to species within a political management unit and can be retrieved at http://www.iucnredlist.org/.

The IUCN Red List is set upon precise criteria to evaluate the extinction risk of thousands of species and subspecies. These criteria are relevant to all species and all regions of the world. The aim is to convey the urgency of conservation issues to the public and policy makers, as well as help the international community to try to reduce species extinction. According to IUCN (1996), the formally stated goals of the Red List are to provide scientifically based information on the status of species and subspecies at a global level, to draw attention to the magnitude and importance of threatened biodiversity, to influence national and international policy and decision-making, and to provide information to guide actions to conserve biological diversity,

The Red Data Book categories provide an easily and widely understood method for highlighting those species under higher extinction risk, so as to focus attention on conservation measures designed to protect them.

Outdoor wood decking boards 10 formed using facing wood veneers 50 formed from a superior grade of wood species, or exotic hardwoods are environmental compliant and economical replacements for use of integral or one piece outdoor wood decking boards 10 of superior grade wood species in the conventional construction of outdoor deck floors. The ability of an outdoor wood decking board 10 to be formed of a fractional amount of a superior grade wood species embodied in a facing wood veneer 50 seamlessly permanently attached to a wood core 30 of a lower grade wood species is environmentally prudent aligned with the objectives of the IUCN, and economically pragmatic. The outdoor wood decking board 10 allows for the formation of an outdoor deck floor 100 of similar dimensions and strength of an outdoor deck floor 100 made from an integral or one piece outdoor wood decking boards 10 of superior grade wood species, and exotic hardwood species, that are aesthetically pleasing to the viewer or consumer at a fraction of the cost and at a fraction of the negative impact on the natural resources of the high grade wood species.

Various superior grade wood species that include smooth or non-cactile surfaces are provided in the embodiments of the disclosure for the formation of the facing wood veneers 50 attached to a first wood face 32 of the wood core 30; and in another embodiment to the second wood face 34 of the wood core 30 to form a dual veneered wood core 30. Use of common grade or general purpose wood species for the manufacture of outdoor wood decking boards 10 promote splintering of the outdoor wood core 30 along the wood grain, while wood cores 30 formed of common grade wood species including a facing wood veneer 50 formed of a superior grade wood species have inherently smooth surfaces or sanded smooth surfaces to form non-cactile surfaces can form a plurality of outdoor wood decking boards 10 arranged to form an assembled simulated non-cactile outdoor deck floor 100 formed of superior grade wood species.

FIG. 1 depicts an embodiment of an outdoor wood decking board 10. The outdoor wood decking board 10 embodied for use in construction of an assembled simulated superior grade wood species non-cactile outdoor deck floor 100 comprises a wood core 30, a facing wood veneer 50, a pressure sensitive liquid adhesive 120. The facing wood veneer 50 is seamlessly permanently attached to a first wood face 32 of the wood core 30 by means of the pressure sensitive liquid adhesive 120.

Referring to FIGS. 1-2C, the wood core 30 is formed from a first wood species WP1, as a three dimensional solid rigid wood body including a thickness (T¹), a width (W¹), and a length (L¹). The wood core 30 includes a first wood face 32, a second wood face 34 opposed to the first wood face 32, and dual opposite longitudinal wood side edges 36, the dual opposite longitudinal wood side edges 36 including interior longitudinal wood side edges 36¹ and exterior longitudinal wood side edges 36². The wood core 30 includes a first end 38 and a second end 39. The wood core 30 includes a longitudinal axis (LA). The wood core 30 is sized via a planar or a moulder to a configuration including a thickness of (T⁵) which is equal to (T¹)−⅛ inch), as shown in FIG. 2B.

The wood core 30 is sized to the thickness of (T⁵) to account for the thickness of the facing wood veneer 50 upon the permanent attachment of the facing wood veneer 50 to the wood core 30, wherein the facing wood veneer 50 includes a thickness (T²) of about ⅛ inch. Implementing this feature, provides for consistency in providing a facing wood veneered wood core 20, as shown in FIG. 3D is configured with a consistent thickness (T¹) of about 1½ inches, and the outdoor wood decking board 10 post being sized is configured consistently having a thickness (T¹) of about 1½ inches, a width (W²) of about 5¼ inches, and a length (L¹) of about 8.00-20.00 feet inclusive.

In an embodiment of the disclosure, the wood core 30 is formed from the first wood species WP1 wherein the first wood species WP1 is preselected from any one of a North American Softwood species including, generally, a common grade or general purpose grade of wood species. In an embodiment of the disclosure, the wood core 30 is formed from a knotty grade of western red cedar species, more particularly, a tight knot western red cedar species 16, as shown in FIGS. 1-3E.

The North American Softwood species that are implemented in the embodiment of the disclosure includes the first wood species WP1 of the wood core 30 which is formed from any one of a superior grade of North American Softwood species selected from the group consisting of tight knot Western Red Cedar (Thuja plicata), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In another embodiment of the disclosure, the wood core 30 is formed from any one of the North American Softwood species that are of common grade or general purpose grade that do not include a distinct tight knot. In another embodiment of the disclosure, the wood core 30 is formed from any one of the first wood species WP1 of North American Softwood species that are common grade or general purpose grade of reclaimed wood selected from the North American Softwood species.

Referring again to FIGS. 1-3E, the facing wood veneer 50, is formed from a second wood species WP2, as a three dimensional solid rigid finishing layer including a thickness (T²), the thickness (T²) being less than the core thickness (T¹), the width (W¹), and the length (L¹). FIG. 1 shows the effectiveness of a facing wood veneer 50 manufactured from a superior grade wood species including a clear vertical grain western red cedar 14 species, or, also, referred to a clear grain western red cedar species.

The second wood species WP2 includes, generally, a superior grade in quality and appearance of the North American Softwood species. The second wood species WP2 of the facing wood veneer 50, can be selected from clear vertical grains, or clear grains of the group consisting of western red-cedar, (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In another embodiment of the disclosure, the facing wood veneer 50 is formed from any one of a superior grade of the second wood species WP2, wherein the wood of the second wood species WP2 is reclaimed wood of the North American Softwood species.

Referring to FIG. 2, the facing wood veneer 50, as shown in FIG. 2C includes a first wood finishing face 52, a second wood finishing face 54 opposed to the first wood finishing face 52, and dual opposing longitudinal facing wood veneer side edges 56, the dual opposing longitudinal facing wood veneer side edges 56 including interior longitudinal facing wood veneer side edges 56¹ and exterior longitudinal facing wood veneer side edges 56². The facing wood veneer 50 includes a facing wood veneer first end 58 and a facing wood veneer second end 59. The facing wood veneer 50 includes a longitudinal axis (LA²).

The facing wood veneer 50 is manufactured from a wood species selected from the second wood species WP2. As shown in FIG. 2C the facing wood veneer is formed from a clear vertical grain western red cedar species 14.

In another embodiment, as discussed below, the facing wood veneer 50 is manufactured from a third wood species WP3, wherein the third wood species WP3 includes exotic hardwoods. The exotic hardwood species is selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macraphylla; and Cuba Mahogany Swietenia mahogany; and Mexican Mahogany (Swietnia bumilis), Swietenia mahogani; Bamboo (Phllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Militia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

In another embodiment, the facing wood veneer 50 is formed from any one of the third wood species WP3, as listed above, where the exotic hardwoods are reclaimed exotic hardwoods selected from the third wood species WP3.

In another embodiment of the disclosure, the wood core 30 is formed from a first wood species WP1 of common grade or general purpose grade of reclaimed wood. Within the context of the exemplary embodiment, the facing wood veneer 50 is formed from a superior grade reclaimed wood selected from the second wood species WP2. In another embodiment, the facing wood veneer 50 is formed from reclaimed exotic hardwood species of a third wood species WP3.

The wood core 30 formed of the first wood species WP1 including the common quality grade or the general purpose grade of the first wood species WP1 is layered with the facing wood veneer 50 where the facing wood veneer 50 is seamlessly permanently attached to the wood core 30. The facing wood veneer 50 is formed from the second wood species WP2, generally, of superior grade wood species than the first wood species WP1 of the wood core 30. The second wood species WP2 of the facing wood veneer 50 is preferably preselected from any one of a clear vertical grain western red cedar species, superior grade of North American Softwood species, as listed above, free from growth characteristics that affect appearance or performance. In some wood manufacturing houses the clear vertical grain is referred to as clear grain.

In another exemplary embodiment, the facing wood veneer 50 is formed from any one of a third wood species WP3. The exotic hardwood species, as listed above, is selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Militia excelsa, M, regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandraphragma cylindricum); Shedua (Ovangkol) (Guibourtia ehia); Sirari (Guibourtia hymenaeifolia); Spanish Cedar (Cedrela odorata); Tamarind (Tamarindus indica);Teak (Tectoria grandis); Ebony Blackbead (Ebenopsis ebano); African Blackwood (Dalbergia melanoxylon); and Bismarck Black Myzomela (Myzomela pammelaena).

No species of exotic wood or exotic hardwoods are utilized where the exotic hardwoods are placed on the CITES Appendices, or listed on the IUCN Red List as endangered, critically endangered, or extinct to prevent population reduction in generations caused by decline in its natural range and exploitation. Unless the exotic wood species is being utilized as recycled or reclaimed exotic wood.

However, exotic hardwoods in the vulnerable range are listed, as way of example, for manufacturers to embrace the embodiment of the disclosure in implementing facing wood veneers 50 including a thickness of the range of about 1/16- 3/16 inch for the objective of preventing the wood species falling into the extinction range.

Exotic hardwoods in the third wood species WP3 that are utilized in the embodiment of the disclosure include those wood species listed above. Information on a variety of the exotic hardwoods can be found in the WOOD DATA BASE http://www.wood-database.com/. As way of example, included in the third wood species WP3 is African Padauk, Pterocarpus soyauxii (“Padauk”). Padauk is listed as one of the third wood species WP3 utilized for the formation of the facing wood veneer 50 of the outdoor wood decking board 10 Padauk distributed in Central and tropical west Africa. The average dried weight is 47 lbs/ft³ (745 kg/m³) having a specific gravity (Basic, 12% MC) of 0.61, 0.75 and a Janka Hardness of 1,970 lb_{f} (8,760 N). The color appearance of African Padauk can vary ranging from a pale pinkish orange to a deep brownish red. Most pieces tend to start reddish orange when freshly cut, darkening substantially over time to a reddish/purplish brown (some lighter pieces age to a grayish brown. Grain is usually straight, but can sometimes be interlocked. With a coarse, open texture that can be sanded to a smooth veneer and good natural luster. African Padauk has excellent decay resistance, and is rated as durable to very durable. African Padauk is also reported to be resistant to termites and other insects. African Padauk is moderately heavy, strong, and stiff, with exceptional stability.

The African Padauk wood species is not listed in the CITES Appendices or on the IUCN Red List of Threatened Species. Therefore, the outdoor wood decking board 10 embodied in the disclosure herein utilizing a facing wood veneer 50 having a thickness of about 1/16- 3/16 inch, a fraction of the amount of that used in whole wood decking boards manufactured with the exotic hardwoods would be important and imperative to conserve the exotic hardwood species in their natural embodiment and prevent the exotic wood species from being placed into a risk of being threatened.

Another exotic hard wood species listed among the third wood species WP3 is Bamboo of which many timber-producing bamboos are from the Phyllostachys and Bambusa genera. Most timber producing bamboos are from South Asia. The average dried weight is 31 lbs/ft³ (500 kg/m³) to 53 lbs/ft³ (850 kg/m³) having a specific gravity 0.38 to 0.64; 0.50 to 0.85. Janka hardness is 1,410 lb_{f} (6,270 N) to 1,610 lb_{f} (7,170 N). Crushing strength is 8,990 lb_{f}/in² (62.0 MPa) to 13,490 lb_{f}/in² (93.0 MPa). Being a monocot in the grass family, bamboo does not have any sapwood/heartwood or growth rings. Generally a uniform and pale yellow to almost white. Bamboo is not listed in the CITES Appendices or on the IUCN Red List of Threatened Species. Bamboo provides a special aesthetics for its unique, down-to-earth appeal. Bamboo, also, has mechanical properties because bamboo possess some of the best stiffness/strength characteristics, and strength-to-weight ratios of any woody material on the planet.

Another exotic wood species listed among the variety of exotic hardwoods in the third wood species WP3 is Bosse, (Guarea spp., G. cedrata and G. thompsonii) distributed from West and Central Africa. The heartwood is initially a pale pinkish brown, darkening with age to a more golden to medium brown. Pale yellowish sapwood is well defined. Can be highly figured, with grain patterns such as pommele being sought after in veneer form. The grain can be straight, interlocked, wavy, or anything in between. This wood is vaguely reminiscent of Sapele (both are in the Meliaceae family). Texture is medium to fine, with a good natural luster. Bosse also has fair resistance against insect attacks and has good weathering characteristics. This wood species is not listed in the CITES Appendices, but is on the IUCN Red List. It is listed as vulnerable due to a population reduction of over 20% in the past three generations, caused by a decline in its natural range. Again, implementation of the outdoor wood decking board 10 according to the present disclosure can prevent against extinction of the Bosse and other exotic hardwood species. Again, the disclosure does not encourage use of the vulnerable species but encourages the implementation of the wood decking board 10 disclosed to prevent the further exploitation of the exotic hardwood.

Another exotic hardwood of the variety of exotic hardwoods listed in the third wood species WP3 is Bulletwood, Massaranduba (Manilkara bidentate) distributed from Caribbean, and Central America. The average dried weight is 67 lbs/ft (1,080 kg/m³) having a specific gravity of 0.85, 1.08 and Janka Hardness of 67 lbs/ft³ (1,080 kg/m. The heartwood is a medium to dark reddish brown. Bulletwood is an incredibly strong, dense wood which has good durability in exterior applications. Color tends to darken with age. Pale yellow sapwood is clearly differentiated from the heartwood, though not always sharply demarcated. Grain straight to interlocked or wavy. Fine uniform texture with low natural luster. Bulletwood, Massaranduba is rated as very durable, with good resistance to most insect attack. Susceptible to marine borers. This wood species is not listed in the CITES Appendices or on the IUCN Red List of Threatened Species.

In an embodiment of the disclosure, the pressure sensitive liquid adhesive 120 provides a means to seamlessly permanently attach the first wood finishing face 52 of the facing wood veneer 50 against the first wood face 32 of the wood core 30, to form the outdoor wood decking board 10, methods of which are disclosed in more detail below, so that the first wood finishing face 52 of the facing wood veneer 50 formed from a clear vertical grain, or clear grain, or superior grade of the second wood species WP2 visible to a user, homeowner, consumer, or guest, providing an aesthetically pleasing appearance to the outdoor wood decking board 10, as shown in FIG. 1.

Implementing this feature of the embodiment, of facing wood veneers 50 formed from superior grades of North American Softwood species, exemplified in the clear vertical grain western red cedar, and preselected from any one of a clear vertical grain red cedar wood species, or clear grain red cedar wood species, or any one of the superior grades of North American Softwood species, listed above, of the second wood species WP2, or preselected from any one of the third wood species WP3 of exotic hardwoods, a plurality of outdoor wood decking boards 10 are adapted to be arranged along interior longitudinal wood side edges 36¹ of each other to form the assembled simulated superior grade wood species non-cactile outdoor wood deck floor 100 of preconfigured dimensions.

More particularly, a plurality of outdoor wood decking boards 10 are adapted to be arranged along interior longitudinal wood side edges 36¹ of each other to form an assembled simulated superior quality grade wood species non-cactile outdoor deck floor 100 of preconfigured dimensions displaying any one of the second wood species WP2 of the group consisting of clear vertical grain or clear grain, Western Red Cedar (Thuja plicata), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species) to the user, homeowner, consumer, guest observing the outdoor wood decking boards 10 of an assembled simulated superior quality grade wood species non-cactile outdoor deck floor 100. FIG. 17 shows an outdoor wood deck floor 100 including an outdoor wood decking board 10 comprising a tight knot western red cedar 16 wood core 30 having a clear vertical grain western red cedar 14 facing wood veneer seamlessly permanently attached thereon.

In another embodiment of the disclosure, as shown in FIGS. 12A-12D and FIGS. 13A-13D, and discussed in more detail below, a second facing wood veneer 50² is seamlessly permanently attached to the second wood face 34 of the wood core 30 to form an outdoor wood decking board 10 as shown in FIGS. 12C-12D and FIGS. 13C-13D including a dual facing wood veneered wood core 96. As shown in FIGS. 12A and 13A, the second facing wood veneer 50² is formed as a three dimensional solid rigid finishing layer² including the thickness (T²), the width (W¹), and the length (L¹). The second facing wood veneer 50² includes a first wood finishing face² 52², a second wood finishing face² 54² opposed to the first wood finishing face² 52², and dual opposing longitudinal facing wood veneer side edges² 56².

The second facing wood veneer 50² can be formed from any one of the second wood species WP2 of the North American Softwood species including the clear vertical grain red cedar wood 14 species. The second wood species WP2 includes any one of the second wood species WP2 of the group consisting of superior grade of North American Softwood species selected from the group consisting of Western Red Cedar (Thuja plicata), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In another embodiment, the second facing wood veneer 50² can be formed from any one of the third wood species WP3. As discussed above, the third wood species WP³ includes the exotic hardwood species selected from the group consisting of exotic hardwood species selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus): Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Militia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp,); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

Referring to FIGS. 12A-12D and FIGS. 13A-13D, and described in more detail below, the second facing wood veneer 50² is permanently attached to the second wood face 34 of the wood core 30 by means of the pressure sensitive liquid adhesive 120 so that a first wood finishing face² 52² of a second facing wood veneer 50² to form an outdoor wood decking board 10 where the second facing wood veneer 50² is visible to a viewer, user, homeowner, consumer, or guest, from beneath a newly formed outdoor wood deck floor 100. In this manner, that the outdoor wood decking boards 10 provides an outdoor ceiling to an outdoor room beneath the outdoor wood decking boards 10 of the newly formed outdoor deck floor 100.

The wood core 30 of the outdoor wood decking board 10 includes the second facing wood veneer 50² seamlessly permanently attached to the second wood face 34 of the wood core 30 such that the first wood finishing face² 52² of the second facing wood veneer 50² formed from the second wood species WP2 including any one of the superior grade second wood species WP2 of the group consisting of Western Red Cedar (Thuja plicata), (Thuja occidentalis), Douglas Fir (Pseudotsuga menziesii), Western Larch (Larix occidentalis), Alpine Larch (Larix Lyallii), Alaskan Yellow-Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species) is displayed to the viewer from below the assembled outdoor wood decking boards 10 thereby, a plurality of outdoor wood decking boards 10 adapted to be arranged along interior longitudinal wood side edges 56 of each other can form an assembled simulated non-cactile clear vertical grain western red cedar outdoor deck floor 100 of pre-configured dimensions.

In another embodiment, the plurality of outdoor wood decking boards 10 adapted to be arranged along interior longitudinal wood side edges 56 of each other can form an assembled simulated non-cactile clear grain western red cedar outdoor deck floor 100 of pre-configured dimensions, as shown in FIG. 17. The outdoor wood decking board 10 can be embodied in any one of the wood cores 30 formed from the common grade or general purpose grade wood species selected from the first wood species WP1 in combination of any one of the facing wood veneers 50 embodied in any one of the superior grade wood species selected from the second wood species WP2 or the third wood species WP3 thereby forming a variety of outdoor wood decking boards 10 including a plurality of a variety of facing wood veneers 50 including a variety of wood species to form a plurality of outdoor wood deck floors 100 representing a variety of wood species.

In another embodiment of the disclosure the facing wood veneer 50 and the second facing wood veneer 50² is formed from a clear cedar including a quartersawn vertical grain.

In another embodiment, the second facing wood veneer 50² is formed from the third wood species WP3, the exotic hardwood species, the exotic hardwood species, as listed above, thereby forming the outdoor wood decking board 10 including an exotic hardwood species WP3 so that when a plurality of outdoor wood decking boards 10 are adapted to be arranged along interior longitudinal wood side edges 56 of each other the plurality of outdoor wood decking boards 10 can form an assembled simulated non-cactile exotic wood species outdoor deck floor 100 of pre-configured dimensions, as shown in FIG. 17.

The wood species preselected for the second facing wood veneer 50² to layer the wood core 30 can be formed from the same wood species preselected for the first facing wood veneer 50 of the wood core 30. In the alternative, the second facing wood veneer 50² is formed from a different wood species from the wood species preselected for the first facing wood veneer 50.

As shown in FIG. 12A-12D, the wood core 30 is formed from a first wood species WP1, namely Douglas fir 80, and the first facing wood veneer 50 is formed from a third wood species WP2, namely, Sapele (Entandrophragma cylindricum) 42, and the second facing wood veneer 50² is formed from the same wood species, Sapele (Entandrophragma cylindricum) 42.

In the alternative the first facing wood veneer 50 is formed from a first wood species and the second facing wood veneer 50² is formed from a different wood species from the first facing wood veneer 50.

Implementing this feature of the embodiment of the disclosure, the outdoor wood decking boards 10 allows a user to display a first facing wood veneer 50 of the assembled simulated superior quality grade wood species non-cactile outdoor deck floor 100 showcasing a first aesthetic appearance complimentary to the surrounding natural environment of the assembled simulated superior quality grade wood species non-cactile outdoor deck floor 100 and consubstantially allows the user to display a second facing wood veneer 50² of the assembled simulated superior quality grade wood species non-cactile outdoor deck floor 100 to a viewer below the assembled simulated superior quality grade wood species non-cactile outdoor deck floor 100 showcasing a second aesthetic appearance complimentary to the surrounding environment, for example, in an outside room created by the disposition of the assembled simulated superior quality grade wood species non-cactile lower outdoor deck floor 100 devised as a ceiling to the outside room.

The use of the facing wood veneers 50 and second facing wood veneers 50² manufactured with superior quality grade wood species is a novel embodiment of outdoor wood decking boards 10 with the purpose of conservation of high grade wood species in their natural geographic environment and preventing excessive consumption of superior quality grade woods in the manufacture of outdoor wood decking boards 10. In addition, the use of facing wood veneers 50 and second facing wood veneers 50² with superior grade wood species provides an aesthetic look to the outdoor wood decking boards 10 of the outdoor deck floor 100 simulating a superior grade wood non-cactile outdoor deck floor 100, as shown in FIG. 17, increasing the value to the home and facility attached thereof, whereas the outdoor wood decking boards 10 are cost efficient because the wood core 30 is manufactured from a less expensive wood species, and the facing wood veneer 50 utilizes a small amount of a superior quality wood species rather than utilizing the superior quality wood species for the manufacture of the entire wood core 30 of the outdoor wood decking board 10.

The facing wood veneer 50 can be manufactured from virgin wood species or recycled wood species.

Typically construction of outdoor deck floors include a plurality of outdoor decking boards made of wood which require manufacturing each outdoor wood decking board from an enormity of natural wood resources of superior grade wood species or exotic hardwood species so that each outdoor wood decking board is completely manufactured with a piece of a superior grade wood species. A known problem to this approach is that the natural resources including a variety of superior grade wood species are exposed to exhaustion, vulnerable, endangered, critically endangered, and extinction of the wood species particular to a certain geographical region. In addition, this method is not cost prohibitive. Therefore, the embodiments disclosed herein provide a solution to the negative impact of outdoor deck floors on the natural resources of superior grade wood species and to the cost of constructing outdoor decking boards used for the construction of outdoor deck floors.

As shown in FIGS. 1-17, the outdoor wood decking board 10 for use in construction of an outdoor deck floor 100, embodied herein includes wood cores 30 configured with specific dimensions having facing wood veneers 50 configured with specific dimensions to fill a variety of specifications of outdoor wood decking boards 10 for use in the construction of outdoor deck floors 100. Each wood core 30 includes like features and for the sake of brevity the features will be described using like numbers throughout the embodiments of the disclosure for consistency.

In addition, the embodiments of the disclosure are described with the use of the pressure sensitive liquid adhesive 120 in the formation of the outdoor wood decking board 10, described in detail, here, for brevity, and not be described in detail below. In an embodiment of the disclosure, the pressure sensitive liquid adhesive 120 can be a polyvinylacetate. In another embodiment, the pressure sensitive liquid adhesive is a crosslinking vinyl acetate, wherein the crosslinking vinyl acetate has a solid content of about 52% and a ph of about 5.5-6.0. The crosslinking vinyl acetate has an off white color, a viscosity of BKFLD RVF @75° F. approx.2500 cps. The crosslinking vinyl acetate is available through Pacific Adhesives Company, Inc., technical data sheet:EWG-2227.

In yet another embodiment, the crosslinking vinyl acetate has a solid content of about 46% and a ph of about 4.5-5.5, white color, viscosity BKFLD RVF @75° F. approx, 3500 cps. This crosslinking vinyl acetate is available through Pacific Adhesives Company, Inc., technical data sheet: R-517BWG.

In another embodiment, the pressure sensitive liquid adhesive is a melamine resin adhesive including melamine-formaldehyde resin methyl alcohol and formaldehyde. The melamine resin adhesive is commercially available through Akzo Nobel Coatings, Inc., Casco Adhesives, product number Adhesive: C1263.

In another embodiment, the pressure sensitive liquid adhesive 120 is a melamine resin adhesive including a liquid hardener..

In another embodiment, the pressure sensitive liquid adhesive 120 is a polymerized polyurethane reactive adhesive. The pressure sensitive liquid adhesive 120 is a polyurethane reactive adhesive, or polymerized polyurethane reactive adhesives. The polyurethane reactive adhesives have been known to be used in construction. They have been utilized in outdoors, boasting effective weatherproofing qualities and high impact bonding strength.

In another embodiment of the disclosure, the pressure sensitive liquid adhesive 120 can be a polyurethane resin adhesives can even withstand exposure to salt water. Polyurethane resin adhesives boast excellent resistance to high temperatures, UV and weather conditions to provide a tough, hard wearing bond.

With reference to FIGS. 1, 2A-2B, and 3A in an embodiment of the disclosure, the wood core 30 is configured including the thickness (T¹) of about 1½ inches, the width (W¹) of about 5½ inches, and the length (L¹) of about 8.00 feet-20.00 feet inclusive. Subsequently, the wood core 30, as shown in FIGS. 2B and 3B, is sized via a planar or moulder to a configuration including a thickness (T⁵) of about 1⅜ inches, the width (W¹) of about 5½ inches, and the length (L) of about 8.00 feet-20.00 feet inclusive thereof. The wood core 30 is sized to accommodate for the thickness (T²) of the facing wood veneer 50.

As shown in FIGS. 1, 2C, and 3C, the facing wood veneer 50 is configured including the thickness (T²) of about ⅛ inch, the width (W¹) of about 5½ inches, and the length (L¹) of about 8.00 feet, and can be configured at the range of 8.00-20.00 feet inclusive thereof. Subsequent to the seamless permanent attachment of the facing wood veneer 50 to the wood core 30 the wood core 30 is sized via the planer or moulder to the thickness (T⁵) of about 1⅜ inches to accommodate for the thickness of the facing wood veneer 50 having a thickness (T²) of about ⅛ inch, as shown in FIGS. 2B and 3B.

In another embodiment, the thickness of the facing wood veneer 50 can be ⅛ inch+/−1 1/16 inch and thereby the thickness of the wood veneer 50 can include a range of about 1/16- 3/16 inch and, compatibly, the wood core 30 shall be sized accordingly to accommodate the thickness of the facing wood veneer 50 so that the final thickness of the outdoor wood decking board 10 is 1½ inches thick.

Referring to FIGS. 3A-3E, showing the wood core 30 is a tight knot western red cedar 16 wood core 30 and the facing wood veneer 50 is a clear vertical grain western red cedar 14 facing wood veneer 50 embodied in the formation of the outdoor wood decking board 10 in FIG. 3E. As shown in FIG. 3D, the facing wood veneer 50 seamlessly permanently attached to the wood core 30 via the pressure sensitive liquid adhesive 120 applied to the first wood face 32 of the wood core 30 through an adhesive spreading machine, and pressed against the second wood finishing face 54 of the facing wood veneer 50 through an automated hydraulic press under heat and pressure to form a facing wood veneered wood core 20, as shown in FIG. 3D. More particularly, FIG. 3D, shows a clear vertical grain western red cedar 14 veneered tight knot western red cedar 16 wood core 20, configured including the thickness (T¹) of about 1½ inches, the width (W¹) of about 5½ inches, and the length (L¹) of about 8.00 feet, but not limited to. The length of the wood core 30 and the facing wood veneer 50 and consequentially the outdoor wood decking board 10 can be configured including a length (L¹) of about 8.00 feet, and can be configured including a range of 8.00-20.00 feet inclusive.

Subsequently, the facing wood veneered wood core 20, more particularly, the clear vertical clear vertical grain western red cedar 14 veneered tight knot western red cedar 16 wood core 20 is sized via the planer or moulder to form the outdoor wood decking board 10, as shown in FIGS. 1 and 3E, including the thickness (T¹) of about 1½ inches, a width (W²) of about 5¼ inches, and the length (L¹) of about 8.00-20.00 feet inclusive thereof.

In another embodiment of the disclosure, the outdoor wood decking board 10 and the facing wood veneer 50 can be configured with another set of dimensions to form an outdoor wood decking board 10 including a narrower width (W). FIGS. 4A-4E shows the wood core 30 and the facing wood veneer 50 embodied in the formation of the outdoor wood decking board 10 as shown in FIG. 4E. More particularly, FIGS. 4A-4B shows the wood core tight knot western red cedar 16 wood core 30 and the clear vertical grain western red cedar 14 facing wood veneer 50 embodied in the formation of the outdoor wood decking board 10 as shown in FIG. 3E for use in construction of an outdoor deck floor 100.

Referring to FIGS. 4A-4E, showing the wood core 30 is a tight knot western red cedar 16 wood core 30 and the facing wood veneer 50 is a clear vertical grain western red cedar 14 embodied in the formation of the outdoor wood decking board 10 in FIG. 4E. In this exemplary embodiment, the wood core 30, as shown in FIG. 4A, is configured including the thickness (T¹) of about 1½ inches, a width (W³) of about 3½ inches, and the length (L¹) of about 8.00 feet but not limited to. The wood core 30 is formed from the first wood species WP1 including the tight knot western red cedar 16.

Subsequently, the wood core 30 is sized via a planer or moulder to a configuration including the thickness (T⁵) of about 1⅜ inches, a width (W³) of about 3½ inches, and the length (L¹) of about 8.00 feet, but not limited to, as shown in FIG. 4B to accommodate the thickness (T²) of the facing wood veneer 50 having a thickness of about ⅛ inch. The wood core 30 is sized to accommodate for the thickness (T²) of the facing wood veneer 50.

As shown in FIG. 4C, the facing wood veneer 50 is formed from the wood species selected from the second wood species WP2, the clear vertical grain western red cedar 14, as shown in FIG. 4C, configured including the thickness (T²) of about ⅛ inch, the width (W³) of about 3½ inches, and the length (L¹) of about 8.00 feet, but not limited to.

Subsequent to the seamless permanent attachment of the facing wood veneer 50 to the wood core 30, more particularly, the tight knot western red cedar 16 wood core 30 is sized via the planer or moulder from the thickness (T¹) of about 1½ inches to a thickness (T⁵) of about 1⅜ inches, as shown in FIG. 4B, to accommodate the thickness (T²) of the facing wood veneer 50 having a thickness of about ⅛ inch.

As shown in FIG. 4C, the facing wood veneer 50, more particularly, the clear vertical grain western red cedar veneered tight knot western red cedar wood core 20 is shown including the thickness (T¹) of about 1½ inches, the width (W³) of 3½ inches, and the length (L¹) of about 8.00 feet, but not limited to.

FIG. 4D shows the facing wood veneer 50 seamlessly permanently attached to the wood core 30. As shown in FIG. 4D, the facing wood veneer 50, more particularly, the clear vertical grain western red cedar 14 facing wood veneer 50 is seamlessly permanently attached to the tight knot western red cedar 16 wood core 30 via the pressure sensitive liquid adhesive 120 applied to the entire first wood face 32 of the wood core 30 through an adhesive spreading machine, and the second wood finishing face 54 of the facing wood veneer 50 pressed against the first wood face 32 of the wood core 30 through an automated hydraulic press under heat and pressure to form a facing wood veneered wood core 20, more particularly, a clear vertical grain western red cedar 14 veneered tight knot western red cedar 16 wood core 20 as shown in FIG. 4D. More particularly, FIG. 4D, shows a clear vertical grain western red cedar 14 veneered tight knot western red cedar 16 wood core 20, configured including the thickness (T1) of about 1½ inches, the width (W³) of about 3½ inches, and the length (L¹) of about 8.00 feet, but not limited to. The length (L¹) of the wood core 30 and the facing wood veneer 50 and consequentially the outdoor wood decking board 10 can be configured including a length (L¹) of about 8.00 feet, and can be configured including a range of 8.00-20.00 feet inclusive.

Subsequently, the facing wood veneered wood core 20, more particularly, the clear vertical grain western red cedar 14 veneered tight knot western red cedar 16 wood core 20 is sized via the planer or moulder to form an outdoor wood decking board 10, as shown in FIG. 4E, including a configuration including the thickness (T¹) of about 1½ inches, a width (W⁴) of about 3¼ inches, and the length (L) of about 8.00 feet but not limited to.

In another embodiment of the disclosure, as shown in FIGS. 5A-5F the outdoor wood decking board 10 for use in construction of an outdoor deck floor 100 includes a wood core 30 and a facing wood veneer 50 of the outdoor wood decking board 10 shown in FIG. 5E, embodied in yet another dimensions. The wood core 30, as shown in FIG. 5A is formed from the first wood species WP1 including a tight knot western red cedar 16 species. The wood core 30, more particularly, the tight knot western red cedar 16 wood core 50 is configured including the thickness (T¹) of about 1½ inches, a width (W⁵) of about 7¼ inches, and the length (L¹) of about 10.00 feet, but not limited to. Subsequently, as shown in FIG. 5B, the wood core 30, more particularly, the tight knot western red cedar 16 wood core 30 is sized via the planer or moulder to a configuration including the thickness (T⁵) of about 1⅜ inches, the width (W⁵) of about 7¼inches, and the length (L¹) of about 10.00 feet but not limited to, to accommodate the thickness (T²) of the facing wood veneer 50 having a thickness of about ⅛ inch.

The facing wood veneer 50, as shown in FIG. 5C, is formed from the second wood species WP2, including the Alaskan Yellow Cedar 22. The facing wood veneer 50, more particularly, the Alaskan Yellow Cedar 22 facing wood veneer 50 is configured including the thickness (T²) of about ⅛ inch, the width (W⁵) of about 7¼ inches, and the length (L¹) of about 10.00 feet, but not limited to. The facing wood veneer 50, more particularly, the Alaskan Yellow Cedar 22 facing wood veneer 50 is seamlessly permanently attached via the pressure sensitive liquid adhesive 120 through the adhesive spreading machine, and pressed though the automated hydraulic press under heat and pressure to form the facing wood veneered wood core 20, more particularly, an Alaskan Yellow Cedar 22 veneered tight knot western red cedar 16 wood core 30, as shown in FIG. 5D configured including the thickness (T¹) of about 1½ inches, the width (W⁵) of about 7¼ inches, and the length of about 10.00 feet, but not limited to.

Subsequently, the facing wood veneered wood core 20, more particularly the Alaskan Yellow Cedar 22 veneered tight knot western red cedar 16 wood core 30 is sized via the planer or moulder to form an outdoor wood decking board 10, as shown in FIG. 5E and 5F including a configuration including the thickness (T¹) of about ½ inches, a width (W⁶) of about 7⅛ inches, and the length (L¹) of about 10.0 feet but not limited to.

In another embodiment of the disclosure, as shown in FIGS. 6A-6F, the outdoor wood decking board 10, for use in construction of an outdoor deck floor 100 includes a (5¼×6) wood core 30 formed from the first wood species WP1 including a tight knot western red cedar 16 species. The wood core 30, more particularly, the tight knot western red cedar 16 wood core 30 is configured including a thickness (T⁴) of about 1⅛ inches, the width (W¹) of about 5½ inches, and the length (L¹) of about 10.0 feet but not limited to. Subsequently, the wood core 30, more particularly, the tight knot western red cedar 16 wood core 30, as shown in FIG. 6B, is sized via the planer or moulder to a configuration including a thickness (T⁶) of about 1.0 inch, the width (W¹) of about 5½ inches, and a length (L¹) of about 10.00 feet. The tight knot western red cedar 16 wood core 30 is sized to accommodate for the thickness (T²) of the Alaskan Yellow Cedar 22 facing wood veneer 50 having a thickness of about ⅛ inch. The Alaskan Yellow Cedar 22 facing wood veneer 50 can be configured including a thickness (T²) including a range of about 1/16- 3/16 inch.

The facing wood veneer 50, as shown in FIG. 6C is formed from a superior grade, a clear grade, selected from the second wood species WP2 including the Alaskan Yellow Cedar 22. The facing wood veneer 50, more particularly, the Alaskan Yellow Cedar 22 facing wood veneer 50 is configured including the thickness (T²) of about ⅛ inch, the width (W¹) of about 5½ inches, and the length (L¹) of about 10.0 feet. The Alaskan Yellow Cedar 22 facing wood veneer 50 is seamlessly permanently attached to the tight knot western red cedar 16 wood core via the pressure sensitive liquid adhesive 120 through the adhesive spreading machine, and pressed through the automated hydraulic press under heat and pressure to form a facing wood veneered wood core 20, more particularly, an Alaskan Yellow Cedar 22 tight knot western red cedar 16 wood core 30.

In the exemplary embodiment, wood core 30 can be formed from a common grade or general purpose grade of reclaimed the tight knot western red cedar 16 of the facing wood veneer 50 can be formed from reclaimed Alaskan Yellow Cedar 22.

Thereby, the facing wood veneered wood core 20, more particularly, the Alaskan Yellow Cedar 22 veneered tight knot western red cedar 16 wood core 20, as shown in FIG. 6D is configured including the thickness (T⁴) of about 1⅛ inches, the width (W¹) of about 5½ inches, and the length (L¹) of about 10.00 feet.

Subsequently, as shown in FIG. 6E, the Alaskan Yellow Cedar 22 veneered tight knot western red cedar 16 wood core 20 of the embodiment is sized via the planer or moulder to form the outdoor wood decking board 10 as shown in FIG. 6E and 6F of the exemplary embodiment, which is sized to a configuration including the thickness (T⁴) of about 1⅛ inches, the width (W²) of about 5¼ inches, and the length (L¹) of about 10.00 feet, but not limited to.

As shown in FIG. 7A-7F, in another embodiment of the disclosure, the outdoor wood decking board 10 for use in construction of an outdoor deck floor 100 includes a wood core 30 of another configured dimensions. The wood core 30, as shown in FIG. 7A, is formed from the first wood species WP1 including a tight knot western red cedar 16. The wood core 30 can be formed of any one of the first wood species WP1 and not include a tight knot or knotty feature. The wood core 30, more particularly, is configured including a thickness (T⁴) of about 1⅛ inches, the width (W³) of about 3½ inches, and the length (L¹) of about 10.00 feet but not limited to.

Subsequently, the wood core 30, as shown in FIG. 7B, is sized via the planer or moulder to a configuration including a thickness (T⁶) of about 1.00 inch, the width (W³) of about 3½ inches, and the length (L¹) of about 10.00 feet to accommodate for the thickness (T²) of the facing wood veneer 50 having a thickness (T²) of about ⅛ inch. The wood core 30 is formed from the tight knot western red cedar selected from the first wood species WP1.

As shown, in FIG. 7C, the facing wood veneer 50 is configured including the thickness (T²) of about ⅛ inch, the width (W³) of about 3½ inches, and the length (L¹) of about 10.00 feet, but not limited to. The facing wood veneer 50 of Alaskan Yellow Cedar 22 is seamlessly permanently attached to the wood core 30 of tight knot western red cedar 16 via the pressure sensitive liquid adhesive 120 to form an Alaskan Yellow Cedar 22 veneered tight knot western red cedar 16 wood core 20, as shown in FIG. 7D. The Alaskan Yellow Cedar 22 veneered tight knot western red cedar 16 wood core 20 is configured including a thickness (T⁴) of about 1⅛ inches, a width (W³) of about 3½ inches, and the length (L¹) of about 10.00 feet but not limited to.

Subsequently, as shown in FIG. 7D and 7E, the Alaskan Yellow Cedar 22 veneered tight knot western red cedar 16 wood core 20 is sized via the planer or moulder to form the outdoor wood decking board 10 shown in FIG. 7E and 7F including the thickness (T⁴) of about 1⅛ inches, a width (W⁴) of about 3¼ inches, and the length (L¹) of about 8.00-20.00 feet inclusive and having an Alaskan Yellow Cedar 22 facing wood veneer 50 at 24.

The wood core 30 and the facing wood veneer 50 in implementation of the embodiment of the disclosure can be formed in a variety of lengths for use in the formation of the outdoor wood decking board 10 for use in the construction of the outdoor deck floor 100. In particular, the length (L¹) of the wood core 30 and the length (L¹) of the facing wood veneer 50 can be selected from the group comprising of 8.00 feet, 10.00 feet, 12.00 feet, 14.00 feet, 16.00 feet, 18.00 feet, and 20.00 feet.

In another embodiment, the outdoor wood decking board 10 in the implementation of the embodiment of the disclosure for use of the outdoor wood decking board 10 for use in construction of an outdoor deck floor 100 can include a wood core 30 and a facing wood veneer 50 formed in a variety of lengths. In particular, the length (L¹) of the wood core and the length (L¹) of the facing wood veneer can be selected from the group comprising including the length (L¹) of 9.00 feet, 11.00 feet, 13.00 feet, 15.00 feet, 17.00 feet, and 19.00 feet.

In another embodiment of the disclosure, to exemplify the variety of outdoor wood decking boards 10 embodied within the subject matter of the disclosure, FIGS. 8A-8E shows an outdoor wood decking board 10 including the wood core 30 is manufactured from a tight knot western red cedar 16 species, and the facing wood veneer 50 is manufactured from a wood species selected form the third wood species WP3, namely, an Ipe (Handroanthus species) 26.

In another embodiment, the facing wood veneer 50 can be formed from reclaimed Ipe 26.

FIG. 8A shows the wood core 30 manufactured with a tight knot western red cedar 16. The wood core 30 is formed from a first wood species WP1 as a three dimensional solid rigid wood body including a thickness (T¹), a width (W¹), and a length (L¹). The wood core 30, more particularly, the tight knot western red cedar 16 wood core 30 includes a first wood face 32, a second wood face 34 opposed to the first wood face 32, and dual opposite longitudinal wood side edges 36, the dual opposite longitudinal wood side edges 36 including interior longitudinal wood side edges 36¹ and exterior longitudinal wood side edges 36². The wood core 30 includes a longitudinal axis (LA). The wood core 30 is sized via a planar or a moulder to a configuration including a thickness of (T⁵) which is equal to (T¹)−⅛ inch).

As shown in FIG. 8C, the wood core 30 is sized to the thickness of (T⁵) to account for the thickness of the facing wood veneer 50 upon the permanent attachment of the facing wood veneer 50 to the wood core 30, wherein the facing wood veneer 50 includes a thickness (T²) of about ⅛ inch. As shown in FIG. 8C the wood core 30, more particularly, the tight knot western red cedar wood core 30 is sized configured including a thickness (T⁵) of about 1⅜ inches, a width (W¹) of about 5½ inches, and the length (L) of about 10.00 feet but not limited to.

Referring to FIG. 8B, the facing wood veneer 50, is formed from the second wood species WP2, the Ipe (Handroanthus species) 26, as a three dimensional solid rigid finishing layer including a thickness (T²), the thickness (T²) being less than the core thickness (T¹), the width (W¹), and the length (L¹). FIG. 8D, shows outdoor wood decking board 10 and the effectiveness of a facing wood veneer 50 manufactured from a superior quality grade wood species including the Ipe (Handroanthus species) 26, species. More particularly, FIG. 8B shows the Ipe 26 facing wood veneer 50 including a thickness (T¹) of about 1½ inches, a width (W¹) of about 5½ inches, and a length (L¹) of about 10.00 feet but not limited to.

Referring to FIG. 8B, the facing wood veneer 50, more particularly, the Ipe 26 facing wood veneer 50 includes a first wood finishing face 52, a second wood finishing face 54 opposed to the first wood finishing face 52, and dual opposing longitudinal facing wood veneer side edges 56, the dual opposing longitudinal facing wood veneer side edges 56 including interior longitudinal facing wood veneer side edges 56¹ and exterior longitudinal facing wood veneer side edges 56². The facing wood veneer 50 includes a longitudinal axis (LA²).

The facing wood veneer 50 is manufactured from the second wood species WP2, as mentioned, the Ipe (Handroanthus species) 26. The wood core 30 formed of the first wood species WP1 including the common quality grade of the first wood species WP1, the tight knot western red cedar 16, the tight knot western red cedar 16 wood core 30, thereby, as shown in FIG. 8C is layered with the Ipe 26 facing wood veneer 50. The Ipe 26 facing wood veneer 50 is seamlessly permanently attached to the wood core 30 via the pressure sensitive liquid adhesive 120 through the adhesive spreading machine, and pressed through the automated hydraulic press under heat and pressure to form a facing wood veneered wood core 20, more particularly, an Ipe 26 veneered tight knot western red cedar 16 wood core 20, as shown in FIG. 8C. Thereby, the Ipe 26 veneered tight knot western red cedar 16 wood core 20 is configured including the thickness (T¹) of about 1½ inches, a width (W¹) of about 5½ inches, and the length (L¹) of about 10.00 feet, but not limited to.

Subsequently, the Ipe 26 veneered tight knot western red cedar 16 wood core 20 is sized to form an outdoor wood decking board 10, as shown in FIGS. 8D and 8E configured to include a thickness (T¹) of about 1½ inches, the width (W²) of about 5¼ inches, and the length (L¹) of about 10.00 feet but not limited to.

In another embodiment of the disclosure, FIGS. 9A-9E, depicts an embodiment of an outdoor wood decking board 10 for use in the construction of an outdoor deck floor 100. The outdoor wood decking board 10 embodied for use in construction of the outdoor deck floor 100 comprises a first wood core 30, as shown in FIG. 9A, and a second wood core 30², as shown in FIG. 9B is seamlessly permanently attached to each other by means of a pressure sensitive liquid adhesive 120 to form a face-to-face wood core 40, as shown in FIG. 9C.

The first wood core 30 and the second wood core 30² each are formed from the first wood species WP1. The first wood species WP1 is preselected from any one of a North American Softwood species including, generally, a general purpose or common grade, including a knotty or quality knotty grades, or non-knotty grade, of western red cedar species. The North American Softwood species that are implemented in the exemplary embodiment of the disclosure includes the first wood species WP1 of the first wood core 30 and the second wood core 30² which is formed from any one of a common grade or general purpose grade of North American Softwood species selected from the group consisting of Western Red-Cedar (Thuja plicata), (Thuja occidentalis), Douglas Fir (Pseudotsuga menziesii), Western Larch (Larix occidentalis), Alpine Larch (Larix lyallii), Alaskan Yellow-Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

Referring again to FIGS. 9A-9E, the first wood core 30 and the second wood core 30² are each formed from a tight knot western red cedar 16, thereby forming a first tight knot western red cedar 16 first wood core 30, and a tight knot western red cedar 16 second wood core 30².

In another embodiment of the disclosure, the wood core 30 is formed from any one of the North American Softwood species that are of common grade or general purpose grade that do not include a distinct tight knot. In another embodiment of the disclosure, the wood core 30 is formed from any one of the first wood species WP1 of North American Softwood species that are common grade or general purpose grade of reclaimed wood selected from the North American Softwood species.

The first wood core 30, as shown in FIG. 9A, is formed from a first wood species WP1 , more particularly, a tight knot western red cedar 16, as a three dimensional solid rigid wood body configured including a thickness (T³) of about ¾ inch, a width (W¹) of about 5½ inches, and a length (L¹) of about 8.00 feet. The first wood core 30 includes a first wood face¹ 32, a second wood face¹ 34 opposed to the first wood face¹ 32, and dual opposite longitudinal wood side edges¹ 36.

The second wood core 30², as shown in FIG. 9B is formed from the tight knot western red cedar 16 species as a second three dimensional solid rigid wood body configured including the thickness (T³) of about ¾ inch, the width (W¹) of about 5½ inches, and the length (L¹) of about 8.00 feet. The second wood core 30² includes a first wood face² 32², a second wood face² 34² opposed to the first wood face² 32², and dual opposite longitudinal wood side edges² 36². The pressure sensitive liquid adhesive 120 is applied to the second wood face² 34² of the second wood core 30² and the second wood face¹ 34 of the first wood core 30 via an adhesive spreading machine enabling and operable for providing a seamless permanent attachment of the first wood core 30 to the second wood core 30² forming a face-to-face wood core 40, as shown in FIG. 9C. More particularly, a tight knot western red cedar 16 face-to-face wood core 40 is formed, as shown in FIG. 9C. The face-to-face wood core 40, more particularly, the tight knot western red cedar 16 face-to-face wood core 40, includes a thickness (T¹) of about 1½inches when the first wood core 30 and the second wood core 30² are pressed against each other in an automated hydraulic press under heat and pressure. The face-to-face wood core 40 includes a longitudinal axis (LA³).

Subsequently, the face-to-face wood core 40, more particularly, the tight knot western red cedar 16 face-to-face wood core 40, as shown in FIG. 9C is sized via a planer or moulder to a thickness of (T⁵) 1⅜ inches, such that (T⁵) is ⅛ inch less than (T¹), as shown in the face-to-face wood core 40 formed in FIG. 9D. The face-to-face wood core 40 is sized to the thickness (T⁵) to account for the thickness (T²) of the facing wood veneer 50 subsequent to the permanent attachment of the facing wood veneer 50 to the face-to-face wood core 40, wherein the facing wood veneer 50 includes the thickness of (T¹) of about ⅛ inch. Implementing this feature, provides consistency in providing a facing wood veneered face -to-face wood core 40 configured with a consistent thickness (T¹) of about 1½ inches.

As shown in FIG. 9D, the facing wood veneer 50 is formed from a second wood species WP2 as a three dimensional solid rigid wood finishing layer including a thickness (T²), the thickness (T²) being about ⅛ inch, the width (W¹), and the length (L¹), the facing wood veneer 50 including a first wood finishing face 52, a second wood finishing face 54 opposed to the first wood finishing face 52, and dual opposing longitudinal facing wood veneer side edges 56, wherein the second wood species WP2 is a superior grade of wood species. The second wood species WP2 is any one of a superior grade North American Softwood species. In the exemplary embodiment, the facing wood veneer 50 is formed from a clear vertical grain western red cedar 14 species.

In any of the many embodiments of the disclosure, the second wood species WP2 of the facing wood veneer 50 is formed from one of a superior grade North American Softwood species selected from the group consisting of clear grain Western Red-Cedar (Thuja plicate), (Thuja occidentalis), clear grain Douglas Fir (Pseudotsuga menziesii), clear grain Western Larch (Larix occidentalis), clear grain Alpine Larch (Lasix lyallii), clear grain Alaskan Yellow Cedar (Chamaecyparis nootkatensis), clear grain Hemlock (Tsuga heterophylla), clear grain Port of Oxford Cedar (Chamaecyparis lawsoniana), clear vertical grain Redwood (Sequoia sempervirens), and clear grain Pine/Spruce (Pinus species, Picea species).

In another embodiment of the disclosure, the facing wood veneer 50 is formed from any one of the North American Softwood species that are of superior grade or clear grain, or clear vertical grain, of the first wood species WP1 of North American Softwood species. In another embodiment of the disclosure, the facing wood veneer 50 is formed from any one of the first wood species WP1 of North American Softwood species that are superior grade or clear grain, or clear vertical grain, of reclaimed wood selected from the North American Softwood species.

As shown in FIG. 9D, a facing wood veneer 50 formed from a superior quality grade of a second wood species WP2, namely, a clear vertical grain western red cedar 14 is seamlessly permanently attached to a first face 32 of the first wood core 30 of the face-to-face wood core 40 by means of the pressure sensitive liquid adhesive 120 so that a first wood finishing face 52 of the facing wood veneer 50 is displayed to the viewer

The pressure sensitive liquid adhesive 120 is applied to the first wood face 32 of the first wood core 30 of the face-to-face wood core 40 via the adhesive spreading machine enabling and operable for providing a seamless permanent attachment of the second wood finishing face 54 of the facing wood veneer 50 against the first wood face 32 of the first wood core 30 of the face-to-face wood core 40 forming a facing wood veneered wood core 20, more particularly, a clear vertical grain western red cedar 14 veneered tight knot western red cedar 16 face-to-face wood core 40, as shown in FIG. 9D, such that the first wood finishing face 52 of the facing wood veneer 50 including the clear vertical grain western red cedar 14 is displayed to a viewer. The clear vertical grain western red cedar 14 veneered tight knot western red cedar 16 face-to-face wood core 40 includes a thickness (T¹) 1½ inches, a width (W′) of about 5½ inches, a length (L¹)of about 8.00 feet.

Subsequently, as shown in FIG. 9E, the clear vertical grain western red cedar 14 veneered tight knot western red cedar 16 face-to-face wood core 40 is sized via a planer or moulder to form an outdoor wood decking board 10, as shown in FIG. 9E having a thickness (T¹) of about 1½ inches, a width (W²) of about 5/14 inches, and the length (L¹) of about 8.00 feet, but not limited to.

In this manner, a plurality of outdoor wood decking boards 10 adapted to be arranged along interior longitudinal wood side edges 56¹ of each other form an assembled simulated non-cactile clear vertical grain western red cedar 14 outdoor deck floor 100 of pre-configured dimensions.

As mentioned above, the clear vertical grain western red cedar 14 veneered tight knot western red cedar 16 face-to-face wood core 40 is sized via the planer or moulder to a configuration including the thickness (T¹) of about 1½ inches, a width (W²) of about 5¼ inches wherein the width (W²) is ¼ inch less than width (W¹) of about 5½ inches, and the length (L¹) of about 8.00 feet. By means of sizing the clear vertical grain western red cedar 14 veneered tight knot western red cedar 16 face-to-face wood core 40 via the planer or moulder a consistency is established in the dimensions of the outdoor wood decking board 10 that is formed such that the outdoor wood decking board 10, as shown in FIG. 9E is sized to the consistent thickness (T¹) of about 1½ inches, a width (W²) of about 5¼ inches, and a length (L¹) of about 8.00 feet, but not limited to. The outdoor wood decking boards 10 can be configured including a length at a range of about 8.00-20.00 feet inclusive.

According to the exemplary embodiment of the outdoor wood decking board 10 including the first wood core 30 and the second wood 30² seamlessly permanently attached to each other via the pressure sensitive liquid adhesive 120 forming the face-to-face wood core 40 the first wood core 30 and the second wood core 30² can be embodied including a variety of configurations.

Referring again to FIG. 9E, in an embodiment of the outdoor wood decking board 10 including the face-to-face wood core 40, as shown in FIG. 9C, the face-to-face wood core 40 is configured forming a face-to-face wood core 40 including the first wood core 30, as shown in FIG. 9A and the second wood core 30², as shown in FIG. 9B. The first wood core 30 and the second wood core 30² is formed from the tight knot western red cedar 16. The first wood core 30 is configured including the thickness (T³) of about ¾ inch, the width (W¹) of about 5½ inches, and the length (L¹) of about 8.0-20.0 feet. Equally, the second wood core 30² is configured including the thickness (T³) of about ¾ inch, the width (W¹) of about 5½ inches, and the length (L¹) of about 8.00-20.00 feet. Consequentially, the face-to-face wood core 40 is configured including a thickness (T¹) of about 1½ inches, the width (W¹) of about 5½ inches, and the length (L¹) of about 8.00 feet, but not limited to.

Subsequently, the face-to-face wood core 40 is sized via the planer or moulder to the thickness of T⁵ of about 1⅜ inches thereby providing for an allotment of the facing wood veneer 50 which is configured including the thickness (T ²) of about ⅛ inch, and, correspondingly, the width (W ²) of about 5½ inches, and the length (L¹) of about 8.00 feet, but not limited to. The facing wood veneer 50 is formed from the clear vertical grain western red cedar 14. Thereby, the facing wood veneered face-to-face wood core 40, more particularly, the clear vertical grain western red cedar 14 veneered tight knot western red cedar 16 face-to-face wood core 40, a product of FIG. 9D, is configured with the thickness (T¹) of about 1½ inches, the width (W¹) of about 5½ inches, and the length (L¹) of about 8.00 feet, but not limited to.

Subsequently, the clear vertical grain western red cedar 14 veneered tight knot western red cedar 16 face-to-face wood core 40 is sized via the planer or moulder to form the outdoor wood deck board 10, as shown in FIG. 9E, including the thickness (T¹) of about 1½ inches, the width (W²) of about 5¼ inches, and the length (L¹) of about 8.0 feet, but not limited to.

In the exemplary embodiment, as shown in FIGS. 9A-9E, the first wood core 30 can be configured including the thickness (T³) of about ¾ inch, the width (W¹) of about 5½ inches, and the length (L¹) of about 8.00 feet, but not limited to. Equally, the second wood core 30² can be configured including the thickness (T³) of about ¾ inch, the width (W¹) of about 5½ inches, and the length (L¹) of about 8.00 feet. Subsequently, the face-to-face wood core 40 is sized via a planer or moulder to the thickness of T⁵ of about 1⅜ inches.

The facing wood veneer 50 is configured including the thickness (T²) of about ⅛ inch, the width (W²) of about 5½ inches, and the length (L¹) of about 8.00 feet, but not limited to, and thereby, the facing wood veneered face-to-face wood core 40 is configured with the thickness (T¹) of about 1½ inches, the width (W¹) of about 5½ inches, and the length (L¹) of about 8.00 feet but not limited to.

Subsequently, the facing wood veneered face-to-face wood core 40 is sized via the planer or moulder to the thickness (T¹) of about 1½ inches, the width (W²) of about 5¼ inches, and the length (L¹) of about 8.00 feet but not limited to.

In another embodiment of the outdoor wood decking board 10 including the face-to-face wood core 40, as described in detail above, as shown in FIGS. 10A-10F, the face-to-face wood core 40 is configured forming a face-to-face wood core 40, as shown in FIG. 10C, including the first wood core 30, as shown in FIG. 10A, and the second wood core 30², as shown in FIG. 10B. The first wood core 30 and the second wood core 30² are each formed from a tight knot western red cedar 16, selected from the first wood species WP1, as listed above. The first wood core 30 is configured including the thickness (T³) of about ¾ inch, a width (W⁵) of about 7¼ inches, and the length (L¹) of about 10.00 feet but not limited to. Equally, the second wood core 30², as shown in FIG. 10B, is configured including the thickness (T³) of about ¾ inch, the width (W⁵) of about 7¼ inches, and the length (L¹) of about 10.00 feet but not limited to. Consequentially, the face-to-face wood core 40 is configured including the thickness (T¹) of about 1½ inches, the width (W⁵) of about inches, and the length (L¹) of about 10.00 feet.

Subsequently, the face-to-face wood core 40 is sized via the planer or moulder to the thickness of T⁵ of about 1⅜ inches, as shown in FIG. 10E, thereby providing for an allotment of the facing wood veneer 50, as shown in FIG. 10D. The facing wood veneer 50 is formed from an exotic hardwood, an IPE 26 selected from the third wood species WP3 of exotic hardwood species, as listed above. The facing wood veneer 50 which is configured including the thickness (T²) of about ⅛ inch, and correspondingly, the width (W⁵) of about 7¼ inches, and the length (L¹) of about 10.00 feet, and thereby, the facing wood veneered face-to-face wood core 90, more particularly, an IPE 26 veneered tight knot western red cedar 16 face-to-face wood core 90, is configured with the thickness (T¹) of about 1½ inches, the width (W⁵) of about 7¼ inches, and the length (L¹) of about 10.00 feet but not limited to.

Subsequently, the facing wood veneered face-to-face wood core 90, more particularly, the Ipe 26 veneered tight knot western red cedar 26 face-to-face wood core 90, is sized via the planer or moulder to form the outdoor wood decking board 10, as shown in FIG. 10F, including the thickness (T¹) of about 1½ inches, a width (W⁶) of about 7⅛ inches, and the length (L¹) of about 10.00 feet but not limited to. In the exemplary embodiment the outdoor wood decking board 10 is shown with a length (L¹) of about 10.00 feet, but not limited to.

In an embodiment of the disclosure, the facing wood veneered face-to-face wood core 90, namely the IPE 26 veneered tight knot western red cedar 16 face-to-face wood core 90 is treated with one or more aqueous compositions comprising one or more agents, an agent of the one or more agents selected from the group consisting of biocides, wood strength enhancers, fungicides, bactericides, insecticides water repellants, UV blockers, fire retardants, and wood hardeners. In the exemplary embodiment, the Ipe 26 veneered tight knot western red cedar 16 face-to-face wood core 90 is treated with one or more of the aqueous compositions, selected from the group consisting of biocides, wood strength enhancers, fungicides, bactericides, insecticides water repellants, UV blockers, fire retardants, and wood hardeners.

In another embodiment of the outdoor wood decking board 10 including the face-to-face wood core 40, as shown in FIGS. 11A-11G, the face-to-face wood core 40, as shown more particularly in FIG. 11C-11D, is configured forming a face-to-face wood core 40. The face-to-face wood core 40 includes a first wood core 30 as shown in FIG. 11A, and a second wood core 30², as shown in FIG. 11B. In the exemplary embodiment, the first wood core 30 and the second wood core 30² are each formed from a wood species selected from first wood species WP1, particularly, the tight knot western red cedar 16 selected from the first wood species WP1.

In another embodiment of the disclosure the tight knot western red cedar 16 is reclaimed tight knot western red cedar.

The first wood core 30, as shown in FIG. 11A, is configured including the thickness (T³) of about ¾ inch, a width (W³) of about 3½ inches, and the length (L¹) of about 8.00 feet, but not limited to. Equally, the second wood core 30², as shown in FIG. 11B, is configured including the thickness (T³) of about ¾ inch, the width (W³) of about 3½ inches, and the length (L¹) of about 8.00 feet, but not limited to.

FIGS.11A-11G depicts an embodiment of an outdoor wood decking board 10 for use in the construction of an outdoor deck floor 100. The outdoor wood decking board 10, as shown in FIG. 11G, embodied for use in construction of the outdoor deck floor 100 comprises a first wood core 30, as shown in FIG.11A, and a second wood core 30², as shown in FIG.11B, is seamlessly permanently attached to each other by means of a pressure sensitive liquid adhesive 120 to form a face-to-face wood core 40. A facing wood veneer 50 formed from a superior grade of a second wood species WP2 is seamlessly permanently attached to a first wood face 32 of the first wood core 30 of the face-to-face wood core 40 by means of the pressure sensitive liquid adhesive 120 through the adhesive spreading machine, and pressed through the automated hydraulic press under heat and pressure. The first wood finishing face 52 of the facing wood veneer 50 is displayed to the viewer.

The first wood core 30 is formed from a first wood species WP1 as a three dimensional solid rigid wood body configured including a thickness (T³) of about ¾ inch, a width (W¹) of about 5½ inches, and a length (L¹) of about 8.00 feet but not limited to. The first wood core 30 includes a first wood face¹ 32, a second wood face¹ 34 opposed to the first wood face¹ 32, and dual opposite longitudinal wood side edges¹ 36. The first wood core 30 is formed from the first wood species WP1 which is a tight knot western red cedar 16 species.

The second wood core 30², as shown in FIG. 11B, is formed from the tight knot western red cedar 16 species as a second three dimensional solid rigid wood body configured including the thickness (T³) of about ¾ inch, the width (W¹) of about 5½ inches, and the length (L¹) of about 8.00 feet. The second wood core 30² includes a first wood face² 32², a second wood face ² 34² opposed to the first wood face² 32², and dual opposite longitudinal wood side edges² 36². The pressure sensitive liquid adhesive 120 is applied to the second wood face² 34² of the second wood core 30² and the second wood face¹ 34 of the first wood core 30 via an adhesive spreading machine enabling and operable for providing a seamless permanent attachment of the first wood core 30 to the second wood core 30² forming the face-to-face wood core 40, as shown in FIG. 11C. The face-to-face wood core 40 includes a thickness (T¹) of about 1½ inches when the first wood core 30 and the second wood core 30² are pressed against each other in an automated hydraulic press under heat and pressure. The face-to-face wood core 40 includes a longitudinal axis (LA³).

Subsequently, the face-to-face wood core 40, as shown in FIG. 11C is sized via a planer or moulder to a thickness of (T³) 1⅜ inches, such that (T⁵) is ⅛ inch less than (T¹), as shown in the face-to-face wood core 40 formed in FIG. 11C. The face-to-face wood core 40 is sized to the thickness (T⁵) to account for the thickness (T²) of the facing wood veneer 50 subsequent to the permanent attachment of the facing wood veneer 50 to the face-to-face wood core 40, wherein the facing wood veneer 50 includes the thickness of (T¹) of about ⅛ inch. Implementing this feature, provides consistency in providing a facing wood veneered face-to-face wood core 90 configured with a consistent thickness (T¹) of about 1½ inches.

The first wood core 30 and the second wood core 30² each are formed from the first wood species WP1 The first wood species WP1 is preselected from any one of a North American Softwood species including, generally, a general purpose or common grade, including a tight knot grade, or knotty grades, or non knot grades of western red cedar species. In the exemplary embodiment of the disclosure, a tight knot grade of the first wood species WP1 is implemented, as listed above. The North American Softwood species that are implemented in the exemplary embodiment of the disclosure includes the first wood species WP1 of the first wood core 30 and the second wood core 30² which is formed from any one of a common grade or general purpose grade of

North American Softwood species selected from the group comprising of Western Red-Cedar (Thuja plicata), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

FIGS. 11A-11D, 11F and 11G, shows the first wood core 30 and the second wood core 30² are each formed from a tight knot western red cedar 16.

As shown in FIG. 11E, the facing wood veneer 50 is formed from a superior grade second wood species WP2, as listed above, as a three dimensional solid rigid wood finishing layer including a thickness (T²), the thickness (T²) being about ⅛ inch, the width (W¹), and the length (L¹), the facing wood veneer 50 including a first wood finishing face 52, a second wood finishing face 54 opposed to the first wood finishing face 52, and dual opposing longitudinal facing wood veneer side edges 56, wherein the second wood species WP2 is a superior grade of wood species. The second wood species WP2 is any one of a superior grade North American Softwood species. In the exemplary embodiment, the facing wood veneer 50 is formed from a clear vertical grain western red cedar 14 species.

In any of the many embodiments of the disclosure, the second wood species WP2 of the facing wood veneer 50 is formed from one of a superior grade North American Softwood species selected from the group comprising of Western Red-Cedar (Thuja plicata), (Thuja occidentalis), Douglas Fir (Pseudotsuga menziesii), Western Larch (Larix occidentalis), Alpine Larch (Lasix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In another embodiment of the outdoor wood decking board 10 for use in construction of an outdoor deck floor 100, the facing wood veneer 50 is formed from a third wood species WP3 of an exotic hardwood species, the exotic hardwood species selected from the group comprising of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompson); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Militia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

The pressure sensitive liquid adhesive 120 is applied to the first wood face 32 of the first wood core 30 of the face-to-face wood core 40 via the adhesive spreading machine enabling and operable for providing a seamless permanent attachment of the second wood finishing face 54 of the facing wood veneer 50 against the first wood face 32 of the first wood core 30 of the face-to-face wood core 40 forming a clear vertical grain western red cedar 14 veneered tight knot western red cedar 16 face-to-face wood core 90, as shown in FIG. 11F, such that the first wood finishing face 52 of the facing wood veneer 50 including the clear vertical grain western red cedar 14 is displayed to a viewer.

The clear vertical grain western red cedar 14 veneered tight knot western red cedar 16 face-to-face wood core 90, as shown in FIG. 11F having a thickness (T¹) 1½ inches, a width (W¹) of about 3½ inches, a length (L¹) of about 8.0 feet, but not limited to. The clear vertical grain western red cedar 14 veneered tight knot western red cedar 16 face-to-face wood core 90 is sized via a planer or moulder to form the outdoor wood decking board 10, as shown in FIG. 11G having a thickness (T¹) of about 1½ inches, a width (W²) of about 5/14 inches, and the length (L¹) of about 8.0 feet, but not limited to.

In this manner, a plurality of outdoor wood decking boards 10 adapted to be arranged along interior longitudinal wood side edges 56¹ of each other form an assembled simulated non-cactile clear vertical grain western red-cedar species outdoor deck floor 100 of pre-configured dimensions.

In another embodiment, the thickness of the facing wood veneer 50 can be 1/16- 3/16 inch and thereby the wood core 30 is to be sized accordingly to accommodate the thickness of the facing wood veneer 50 so that the final thickness of the outdoor wood decking board 10 is 1½ inches thick.

In another embodiment of the outdoor wood decking board 10, the outdoor wood decking board 10 includes a first finishing wood veneer 50 and a second finishing wood veneer 50², as shown in FIGS. 12A-12D and FIGS.13A-13D. The outdoor wood decking board 10 includes a wood core 30, as shown in FIG. 12A and 13A formed from a first wood species WP1 as a three dimensional solid rigid wood body including a thickness (T¹) of about 1½ inch, a width (W¹) of about 5½ inches, and a length (L¹) of about 8.00-20.00 feet inclusive, but not limited to. The length (L¹) of the wood core 30 can be configured including the length (L¹) of about 8-20.0 feet inclusive. The wood core 30 includes a first wood face 32, and a second wood face 34, the second wood face 34 opposed to the first wood face 32, and dual opposite longitudinal wood side edges 36. The wood core includes a first end 38 and a second end 39.

In the exemplary embodiment, as shown in FIG. 12A, the wood core 30 is formed from a first wood species WP1 of common grade or general purpose grade of North American Softwood species selected from the group consisting of Western Red-Cedar (Thuja plicata), (Thuja occidentalis), Douglas Fir (Pseudotsuga menziesii), Western Larch (Larix occidentalis), Alpine Larch (Lasix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In the exemplary embodiment, the wood core 30, as shown in FIGS. 12A is a tight knot Douglas Fir 80. The wood core 30 is dried to a moisture content suitable for receiving an adhesive 106, more particularly, a pressure sensitive liquid adhesive 120, The wood core 30 can be formed from a Douglas Fir 80 species, as exemplified in FIG. 12A-12D and more clearly shown in FIG. 12A. In another embodiment, the wood core 30 can be formed from any one of a general purpose or common grade of North American Softwood species selected from the group consisting of Western Red Cedar (Thuja plicata), (Thuja occidentalis), Douglas Fir (Pseudotsuga menziesii), Western Larch (Lasix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

Subsequently, the wood core 30 is sized via a planer or a moulder to a thickness (T⁵) of about 1¼ inches, as shown in FIG. 12B, thereby providing for an allotment of each of the first facing wood veneer 50 and the second facing wood veneer, as shown in FIGS. 12A and 12B. The first facing wood veneer 50 which is configured including the thickness (T²) of about ⅛ inch, and correspondingly, width (W¹) of about 5½ inches, and a length (L¹) of about 8.00-20.00 feet, inclusive. The length of the facing wood veneer 50 can be configured including the length of about 8.00-20.00 feet corresponding to the length (L¹) of the wood core 30. Equally, the second facing wood veneer 50² is configured including the thickness (T²) of about ⅛ inch, and correspondingly, width (W¹) of about 5½ inches, and a length (L¹) of about 8.00-20.00 feet inclusive. The length of the second facing wood veneer 30² can be configured, equally at the range of 8.00-20.0 feet inclusive.

The first facing wood veneer 50 is formed from a third wood species WP3 as a three dimensional solid rigid finishing wood layer including a thickness (T²) of about ⅛ inch, the width (W¹) of about 5½ inches, and the length (L¹) of about 8.00-20.00 feet, The first facing wood veneer 50 includes a first wood finishing face¹ 52, and a second wood finishing face¹ 54, the second wood finishing face 54 opposed to the first wood finishing face¹ 52, and dual opposing longitudinal facing wood veneer side edges 56. The first facing wood veneer has a facing wood veneer first end 58 and a facing wood veneer second end 59. As shown in FIGS. 12A-12 C the first facing wood veneer and the second facing wood veneer are each formed from the exotic hardwood species, namely, Sapele (Entandrophragma cylindricum) 42.

The third wood species WP3 is an exotic hardwood species selected from the third wood species WP3, as listed above. In the exemplary embodiment, the first facing wood veneer 50 and the second facing wood veneer 50² are each formed from the same exotic hardwood species. The first facing wood veneer 50 and the second facing wood veneer 50² are selected from an exotic hardwood species selected from the group comprising of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

In the exemplary embodiment, as shown in FIGS. 13A-13D, the first facing wood veneer 50 and the second facing wood veneer 50² are each formed of the exotic hardwood species such that the first facing wood veneer 50 is not the same as the second facing wood veneer 50². In another embodiment, the first facing wood veneer 50 is formed of a first exotic hardwood species and the second facing wood veneer 50² is formed of a second exotic hardwood species, wherein the first exotic hardwood species is the same as the second exotic hardwood species.

In the exemplary embodiment, as shown in FIGS. 12A-12C, the first facing wood veneer 50 is the exotic hardwood Sapele (Entandrophragma cylindricum) 42, and the second facing wood veneer 50² is formed from the exotic hardwood Sapele (Entandrophragma cylindricum) 42. The second facing wood veneer 50², is formed from the exotic hardwood species, Sapele (Entandrophragma cylindricum) 42, as a three dimensional solid rigid wood finishing layer including the thickness (T²) of about ⅛ inch, the width (W¹) of about 5½ inches, and the length (L¹) of about 8.00-20.00 feet inclusive. The second facing wood veneer 50² includes a first wood finishing face² 52², second wood finishing face² 54² opposed to the first wood finishing face² 52², and dual opposing longitudinal facing wood veneer side edges² 56² The second facing wood veneer 50² includes a facing wood veneer first end 58² and a facing wood veneer second end 59².

A pressure sensitive liquid adhesive 120 is applied to the first wood face 30 of the wood core 30 via an adhesive spreading machine, and pressed through the automatic hydraulic press under heat and pressure, enabling and operable for providing a seamless permanent attachment of the second wood finishing face¹ 54 of the first facing wood veneer 50 against the first wood face 32 of the wood core 30 forming an upper veneered wood core 50¹, more particularly an upper exotic hardwood veneered wood core, namely, an upper Sapele 42 veneered Douglas Fir 80 wood core 30, such that the first wood finishing face¹ 52 of the first facing wood veneer 50 including the first exotic hardwood species, more particularly, Sapele 42, is displayed to the viewer, such that a plurality of outdoor wood decking boards 10 adapted to be arranged along interior longitudinal wood side edges 36¹ of each other form an upper assembled simulated non-cactile exotic hardwood deck floor 100, more particularly, an upper assembled simulate non-cactile Sapele 42, outdoor deck floor 100, formed of pre-configured dimensions.

Similarly, the pressure sensitive liquid adhesive 120 is applied via the adhesive spreading machine through the adhesive spreading machine, and pressed through the hydraulic press under heat and pressure to the second wood face 34 of the wood core 30 enabling and operable for providing a seamless permanent attachment of the second wood finishing face² 54² of the second facing wood veneer 50² against the second wood face 34 of the wood core 30, forming a lower veneered wood core 50², or an exotic hardwood veneered wood core, more particularly, a lower Sapele 42 veneered Douglas Fir 80 wood core 30, such that the first wood finishing face² 52² of the second facing wood veneer 50² including the second exotic hardwood species formed of Sapele 42 forms a lower assembled simulated non-cactile exotic hardwood outdoor deck floor 100², more particularly a lower assembled simulated non-cactile Sapele 42 outdoor deck floor 100² of preconfigured dimensions and being displayed to the viewer from below the upper assembled simulated non-cactile exotic hardwood species outdoor deck floor 100, more particularly, the upper assembled simulated non-cactile Sapele 42, outdoor deck floor 100, formed of pre-configured dimensions,

The wood core 30 including the dual veneered wood core 96 having the first facing wood veneer 50, and the second facing wood veneer 50² seamlessly permanently attached to the wood core 30, as described above, and shown in FIG. 12B and 12C, includes the thickness (T¹) of about 1½ inches, a width (W¹) of about 5½ inches, and the length (L¹) of about 8.00-20.00 feet inclusive. Subsequently, the dual veneered wood core 96 is sized and configured to form an outdoor wood decking board 10, as shown in FIG. 12C and 12D including the thickness (T¹) of about 1½ inches, a width (W²) of about 5½ inches, and the length (L¹) of about 8.00-20.00 feet.

Implementing this novel feature, the dual veneered wood core 96 allows a user to display a first facing wood veneer 50 formed of the exotic hardwood Sapele 42 of the outdoor deck floor 100 showcasing a first aesthetic appearance complimentary to the surrounding natural environment of the outdoor deck floor 100 and consubstantially allows the user to display a second facing wood veneer 50² formed of the exotic hardwood Sapele 42 of the outdoor deck floor 100 to a viewer below the outdoor deck floor 100 showcasing a second aesthetic appearance complimentary to the surrounding environment, for example, in an outside room created by the disposition of the outdoor deck floor 100 devised as a ceiling formed of Sapele 42 to the outside room.

Represented in the exemplary embodiment, the first facing wood veneer 50 and the second facing wood veneer 50² can each be formed from any one of a superior grade of North American Softwood species selected from the group comprising of Western Red Cedar (Thuja plicata), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In another embodiment, the first facing wood veneer 50 and the second facing wood veneer 50² can each be formed from the same genus species selected from the North American Softwood wood species. In the alternative, the first facing wood veneer 50 and the second facing wood veneer 50² can be formed from a different genus species selected from the North American Softwood wood species of the second wood species WP2, as listed above.

In another embodiment, the first facing wood veneer 50 and the second facing wood veneer 50² can each be formed from the same genus species selected from the exotic hardwood species. In the alternative, the first facing wood veneer 50 and the second facing wood veneer 50² can each be formed from a different genus species from each other selected from the exotic hardwood species of the third wood species WP3, as listed above.

With reference to FIGS. 13A-13D, a dual veneered wood core 96 is shown. In the exemplary embodiment, as shown in FIGS. 13A-13D, the first facing wood veneer 50 and the second facing wood veneer 50² are each formed of an exotic hardwood species of the third wood species WP3 that are not the same but different exotic hardwood species. In another embodiment, the first facing wood 50 veneer is formed of a first exotic hardwood species and the second facing wood veneer 50² is formed of a second exotic hardwood species, wherein the first exotic hardwood species is different from the second exotic hardwood species. In the exemplary embodiment, the first facing wood veneer 50 is Sapele 42, and the second facing wood veneer 50² is formed from Santos Mahogany 82.

As shown in FIG. 13A and 13B, the second facing wood veneer 50², is formed from the exotic hardwood species, Santos Mahogany 82 as a three dimensional solid rigid wood finishing layer including the thickness (T²) of about ⅛ inch, the width (W¹) of about 5½ inches, and the length (L¹) of about 8.00-20.00 feet. The second facing wood veneer 50² includes a first wood finishing face² 52², a second wood finishing face² 54² opposed to the first wood finishing face² 52², and dual opposing longitudinal facing wood veneer side edges² 56². The first facing wood veneer 50 has a facing wood veneer first end 58 and a facing wood veneer second end 59.

A pressure sensitive liquid adhesive 120 is applied to the first wood face 30 of the wood core 30 via an adhesive spreading machine, and pressed against the second wood finishing facing 54 of the first finishing veneer 50 through an automated hydraulic press under heat and pressure enabling and operable for providing a seamless permanent attachment of the second wood finishing face¹ 54 of the first facing wood veneer 50 against the first wood face 32 of the wood core 30 forming an upper veneered 50¹, wood core 30, more particularly an exotic hardwood veneered wood core 30, namely, an upper Sapele 42 veneered Douglas Fir 80 wood core 30, such that the first wood finishing face¹ 52 of the first facing wood veneer 50 including the first exotic hardwood species, more particularly, Sapele 42, is displayed to the viewer, such that a plurality of outdoor wood decking boards 10 adapted to be arranged along interior longitudinal wood side edges 36¹ of each other form an upper assembled simulated non-cactile exotic hardwood outdoor wood deck floor 100, more particularly, an upper assembled simulated non-cactile Sapele 42 outdoor deck floor 100, formed of pre-configured dimensions.

Similarly, the pressure sensitive liquid adhesive 120 is applied to the second wood face 34 of the wood core 30 via the adhesive spreading machine though the automated hydraulic press under heat and pressure enabling and operable for providing a seamless permanent attachment of the second wood finishing face² 54² of the second facing wood veneer 50² against the second wood face 34 of the wood core 30, forming a lower veneered 50² wood core 30 exotic hardwood veneered wood core 30, more particularly, a lower Santos Mahogany 82 veneered 50² Douglas Fir 80 wood core 30, such that the first wood finishing face² 52² of the second facing wood veneer 50² including the second exotic hardwood species formed of Santos Mahogany 82 forms a lower assembled simulated non-cactile exotic hardwood deck floor, more particularly a lower assembled simulated non-cactile Santos Mahogany 82 deck floor of preconfigured dimensions and being displayed to the viewer from below the upper assembled simulated non-cactile Sapele 42 outdoor deck floor 100.

The wood core 30 including the dual veneered wood core 96 having the first facing wood veneer 50, and the second facing wood veneer 50² seamlessly permanently attached to the wood core 30 as described above, and shown in FIG. 13B, includes the thickness (T¹) of about 1½ inches, a width (W¹) of about 5½ inches, and the length (L¹) of about 8.00-20.00 feet inclusive.

Subsequently, the dual veneered wood core 96 is sized and configured to form an outdoor wood decking board 10, as shown in FIG. 13C and 13D including the thickness (T¹) of about 1½ inches, a width (W²) of about 5½ inches, and the length (L¹) of about 8.00-20.00 feet inclusive.

Implementing this novel feature, the dual veneered wood core 96 allows a user to display a first facing wood veneer 50 of the outdoor deck floor 100 showcasing a first aesthetic appearance complimentary to the surrounding natural environment of the outdoor deck floor 100 and consubstantially allows the user to display a second facing wood veneer 80 of the outdoor deck floor 100 to a viewer below the outdoor deck floor 100 showcasing a second aesthetic appearance complimentary to the surrounding environment, for example, in an outside room created by the disposition of the outdoor deck floor 100 devised as a Santos Mahogany 82 ceiling to the outside room.

Represented in the exemplary embodiment, the first facing wood veneer 50 and the second facing wood veneer 50² can each be formed from any one of the superior grade of the second wood species WP2 of North American Softwood species selected from the group comprising of Western Red Cedar (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In another embodiment, the first facing wood veneer 50 and the second facing wood veneer 50² can each be formed from the same genus species selected from the second wood species WP2 of superior grade of North American Softwood wood species. In the alternative, the first facing wood veneer 50 and the second facing wood veneer 50² can each be formed from a different genus species from each other selected from the second wood species WP2 of North American Softwood wood species.

In another embodiment, the first facing wood veneer 50 and the second facing wood veneer 50² can each be formed from the same genus species selected from the third wood species WP3 of exotic hardwood species. In the alternative, the first facing wood veneer 50 and the second facing wood veneer 50² can each be formed from a different genus species from each other selected from the third wood species WP3 of exotic hardwood species.

In another embodiment of the disclosure, as shown in FIG. 14A-14D, the wood core 30, as shown in FIG. 14A, is formed from a first wood species WP1, as a three dimensional solid rigid wood body including a thickness (T¹) of about 1½ inches, a width (W¹) of about 5 12 inches, and a length (L¹) including a range of about 8.00-20.00 inches inclusive. The wood core 30 includes a first wood face 32, a second wood face 34 opposed to the first wood face 32, and dual opposite longitudinal wood side edges 36, the dual opposite longitudinal wood side edges 36 including interior longitudinal wood_side edges 36¹ and exterior longitudinal wood side edges 36². The wood core 30 includes a first end 38 and a second end 39. The wood core 30 includes a longitudinal axis (LA). The wood core 30 is sized via a planar or a moulder to a configuration including a thickness of (T⁵) which is equal to (T¹)−⅛ inch), as shown in FIG. 2B.

The wood core 30 is sized to the thickness of (T⁵) of about 1⅜ inches to account for the thickness of the facing wood veneer 50 upon the permanent attachment of the facing wood veneer 50 to the wood core 30, wherein the facing wood veneer includes a thickness (T²) of about ⅛ inch. The facing wood veneer 50 can include a thickness (T²) of the range of 1/16 inch- 3/16 inch.

Subsequently, as shown in FIG. 14B, the wood core 30 is sized via a planar or moulder to a configuration including a thickness (T⁵) of about 1⅜ inches, the width (W¹) of about 5½ inches, and the length (L¹) of about 8.00 feet-20.00 feet inclusive thereof. The wood core 30 is sized to accommodate for the thickness (T ²) of the facing wood veneer 50.

Implementing this feature, provides for consistency in providing a facing wood veneered wood core 20, as shown in FIG. 3D is configured with a consistent thickness (T¹) of about 1½ inches, and the outdoor wood decking board 10 post of being sized is configured consistently having a thickness (T¹) of about 1 Y2 inches, a width (W²) of about 5¼ inches, and a length (L¹) of about 8.00-20.00 feet inclusive.

In the exemplary embodiment, the wood core 30 is formed from any one of a common grade or general purpose grade of North American Softwood species selected from the group consisting of Western Red Cedar (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species). In the exemplary embodiment, as shown in FIG. 14A and 14B the wood core 30 is formed from a tight knot Douglas Fir (Pseudotsuga menziesii) 80.

As shown in FIG. 14B, the facing wood veneer 50 includes a first wood finishing face 52, a second wood finishing face 54 opposed to the first wood finishing face 52, and dual opposing longitudinal facing wood veneer side edges 56, the dual opposing longitudinal facing wood veneer side edges 56 including interior longitudinal facing wood veneer side edges 56¹ and exterior longitudinal facing wood veneer side edges 56². The facing wood veneer 50 includes a facing wood veneer first end 58 and a facing wood veneer second end 59. The facing wood veneer 50 includes a longitudinal axis (LA²).

The facing wood veneer 50 is configured including the thickness (T²) of about ⅛ inch, the width (W¹) of about 5½ inches, and the length (L¹) of about 8.00-20.00 feet inclusive thereof. The facing wood veneer 50 is formed from an exotic hardwood which can be selected from any one of the third wood species WP3 including the exotic hardwood species selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

In the exemplary embodiment, the facing wood veneer 50 is the Teak (Tectona grandis) 84, as shown in FIG. 14B.

In another embodiment, the thickness of the facing wood veneer 50 can be 1/16- 3/16 inch and thereby the wood core 30 shall be sized accordingly to accommodate the thickness of the facing wood veneer 50 so that the final thickness of the outdoor wood decking board 10 is 1½ inches thick.

FIG. 14C shows the facing wood veneer 50 seamlessly permanently attached to the wood core 30 via the pressure sensitive liquid adhesive. With reference to FIG. 14B and 14C, a pressure sensitive liquid adhesive 120 is applied to the first wood face 32 of the wood core 30 via an adhesive spreading machine enabling and operable for providing a seamless permanent attachment of the second wood finishing face¹ 54 of the first facing wood veneer 50 against the first wood face 32 of the wood core 30 when the facing wood veneer 50 and the wood core 30 are pressed against each other through a hydraulic press under heat and pressure forming a facing wood veneered wood core 40, namely, a Teak 84 veneered Douglas Fir 80 wood core 30, such that the first wood finishing face 52 of the facing wood veneer 50 including the first exotic hardwood species WP1, more particularly, Teak 84, is displayed to the viewer, such that a plurality of outdoor wood decking boards 10 adapted to be arranged along interior longitudinal wood side edges 36 of each other form an assembled simulated non-cactile exotic hardwood deck floor 100, more particularly, an assembled simulated non-cactile Teak 84 outdoor deck floor 100, formed of pre-configured dimensions.

FIG. 14C, more particularly, shows a Teak 84 veneered Douglas Fir 80 wood core 30, configured including the thickness (T¹) of about 1½ inches, the width (W¹) of about 5½ inches, and the length (L¹) of about 8.00 feet . Subsequently, the Teak 84 veneered Douglas Fir 80 wood core 30 is sized via the planer or moulder to form the outdoor wood decking board 10, as shown in FIG. 14D, including the thickness (T¹) of about 1½ inches, a width (W²) of about 5¼ inches, and the length (L¹) of about 8.00-20.00 feet inclusive thereof.

In another embodiment, an outdoor wood decking board 10 for use in the construction of an outdoor deck floor 100 comprises a complex wood core assembly 60, as shown in FIGS. 15A-15F. The complex wood core assembly 60, comprises a series of wood cores 62 and a protract wood core 64. Each of the wood cores 62 including the protract wood core 64 of the series of wood cores 62 is embodied in a separate individual three dimensional solid rigid wood body formed from a first wood species WP1. The first wood species WP1 can include any one of a wood species selected from the first wood species WP1 is any one of a common grade or general purpose grade of North American Softwood species elected from the group consisting of western red cedar (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species);

As shown in FIG. 15C, each of the complex wood core assemblies 60 includes a thickness (T¹) of about 1½ inches, a width (W¹) of about 5½ inches, and a length (L¹ of about 8.00-20.00 feet inclusive. Each complex wood core assembly 60 includes a first complex wood face 66, a second complex wood face 68 opposed to the first complex wood face 66, and dual opposite longitudinal wood side edges 76, a first end 72 and a second end 74. In the exemplary embodiment, the wood species of each of the wood cores 62 including the protract wood core 64 is a tight knot western red cedar 16 species selected from the first wood species WP1 of the group comprising any one of the North American Softwood species, as listed above, thereby forming a tight knot western red cedar 16 complex wood core assembly 60.

The complex wood core assembly 60 includes a series of wood cores 62 one of which is the protract wood core 64 seamlessly permanently attached to each other via the pressure sensitive liquid adhesive forming the complex wood core assembly 60. In preparation in the formation of the complex wood core assembly 60, each of the complex wood core assemblies 60 is cut from a complex wood core assembly block 78 to a thickness (T¹) of about 1½ inches, a width (W²) of about 5¼ inches, and a length in the range of 8.00-20.00 feet inclusive, as shown in FIG. 15A.

Within the complex wood core assembly block 78, as shown in FIG. 15A, is the series of the wood cores 62 including the protract wood core 64 to form the complex wood core assembly block 78. Each of the wood cores 62 of the series of wood cores 62 of the complex wood core assembly block 78 including the protractor wood core 64 is manufactured from a wood species selected from the first wood species WP1 of common grade or general purpose grade of North American Softwood species as listed above.

In this exemplary embodiment of the complex wood core assembly block 78 is formed from a tight knot western red cedar wood 16 species. In particular, in the exemplary embodiment, each of the wood cores 62 and the protract wood core 64 is formed from a tight knot western red cedar wood 16 species.

The complex wood core assembly 60, includes each wood core 62 of the series of wood cores 62 of the complex wood core assembly 60 is embodied in a separate individual three dimensional solid rigid wood body formed from a first wood species WP1, including a thickness (T³) of about ¾ inch, a width (W′) of about 5½ inches, and a length (L¹) of about 8.00 feet-20.00 feet inclusive. Each of the wood cores 62 of the complex wood core assembly 60 includes a first wood face¹ 65, a second wood face¹ 69 opposed to the first wood face¹ 65, and dual opposite longitudinal wood side edges¹ 71. The protract wood core 64 is centrally positioned within the series of wood cores 62. The protract wood core 64 includes the thickness (T⁸) of about ½ inch, a width (W¹) of about 5½ inches, and the length (L¹) of about 8.00-20.00 feet inclusive, as shown in FIG. 15A.

In addition, the protract wood core 64 is embodied in a separate individual three dimensional solid rigid wood body¹ formed from the first wood species FW1, the first wood species WP1 selected from the first wood species WP1 as listed above. In the exemplary embodiment, the protract wood core 64 is the tight knot western red cedar 16, thereby providing a tight knot western red cedar 16 protract wood core 64 configured including the thickness (T⁸) of about ½ inch, a width (W′) of about 5½ inches, and a length (L¹) of about 8.00-20.00 feet. The tight knot western red cedar protract wood core 64 includes a first wood face¹ 65², a second wood face¹ 69² opposed to the first wood face¹ 65, and dual opposite longitudinal wood side edges¹ 71.

The protract wood core 64 provides an additional ½ inch to the thickness of the complex wood core assembly block 78 which enables for the provision of additional dimension to the width of the complex wood core assembly 60 to be configured to the width (W¹) of about 5½ inches when a newly cut complex wood core assembly is sized via the planer or the moulder, as shown in FIG. 15C. The protract wood core 64 is embodied in a separate individual three dimensional solid rigid wood body formed from the first wood species FW1, the tight knot western red cedar 16, the protract wood core 64 configured including the thickness (T⁸) of about ½ inch, a width (W¹) of about 5½ inches, and a length (L¹) of about 8.00-20.00 feet, wherein the protract wood core 64 includes a first wood face¹ 65, a second wood face¹ 69 opposed to the first wood face¹ 65, and dual opposite longitudinal wood side edges¹ 71. The protract wood core 64 is centrally positioned within the series of wood cores 62.

To form a complex wood core assembly 60, accordingly, each of the wood cores 62 of the series of wood cores 62 including the protract wood core 64 is permanently attached together along interior faces via a pressure sensitive adhesive. The pressure sensitive liquid adhesive 120 is applied to interior faces of the each of the wood cores 60 including the protract wood core 64 via an adhesive spreading machine enabling and operable for providing a seamless permanent attachment of each of the wood cores 60 to each other including the protract wood core 64 forming the complex wood core assembly block 78, as shown in FIG. 15A, when the wood cores 62 and the protract wood core 64 are pressed against each other in a press under heat and pressure. Each of the wood cores 62 including the protract wood core 64 is seamlessly permanently attached face-to-face to form the complex wood core assembly block 78.

The complex wood core assembly block 78, as shown in FIG. 15A, simulating a single three dimensional solid rigid wood body is configured including the thickness (T⁷) of about 5¾ inches, a width (W¹) of about 5½ inches, and the length (L¹) of about 8.00-20.00 feet inclusive. In the exemplary embodiment, the complex wood core assembly block 78 is a tight knot western red cedar complex wood core assembly block 78.

Each of the complex wood core assemblies 60, as shown in FIG. 15B, is cut via a cutting machine from the complex wood core assembly block 78, as shown in FIG. 15A. In the exemplary embodiment, each of the complex wood core assemblies 60 is cut from the tight knot western red cedar complex wood block 78 into a plurality of complex wood core assemblies 60. Each complex wood core assembly 60 of the plurality of complex wood core assemblies 60, as shown in FIG. 15B is configured with a thickness (T¹) of about 1½ inches, a width (W⁹) of about 5¾ inches, and a length (L¹) of about 8.0-20 feet inclusive. Each complex wood core assembly 60, more particularly, each tight knot western red cedar complex wood core assembly 60 includes a first complex wood face 66, and a second complex wood face 68 opposite to the first complex wood face 66, and complex opposite longitudinal wood side edges 76, a first end 72 and a second end 74.

The complex wood core assembly 60 is sized via a planer or moulder to a thickness (T⁵) of about 1⅜ inches, the width (W¹) of about 5½ inches, and the length (L¹) of about 8.00-20.00 feet inclusive, as shown in FIG. 15C. Thereby providing a tight knot western red cedar 16 complex wood core assembly 60 including a thickness (T⁵) of about 1⅜ inches, to accommodate for the thickness of a facing wood veneer 50, the width (W¹) of about 5½ inches, and the length (L¹) of about 8.00-20.00 feet inclusive.

The outdoor wood decking board 10 including the complex wood core assembly 60 includes the facing wood veneer 50, as shown in FIG. 15D. The facing wood veneer 50, as shown in FIG. 15D includes a first wood finishing face 52, a second wood finishing face 54 opposed to the first wood finishing face 52, and dual opposing longitudinal facing wood veneer side edges 56, the dual opposing longitudinal facing wood veneer side edges 56 including interior longitudinal facing wood veneer side edges 56¹ and exterior longitudinal facing wood veneer side edges 56². The facing wood veneer 50 includes a facing wood veneer first end 58 and a facing wood veneer second end 59. The facing wood veneer 50 includes a longitudinal axis (LA²).

The facing wood veneer 50 is manufactured from a wood species selected from the second wood species WP2. As shown in FIG. 15D the facing wood veneer is formed from Bulletwood, Massaranduba (Manilkara bidentata) 18.

In the exemplary embodiment, the facing wood veneer 50, as shown in FIG. 15D can be formed from a third wood species WP3 of exotic hardwood species, selected from anyone of exotic hardwood species the exotic hardwood species selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

In another embodiment, the facing wood veneer 50 can be formed from a second wood species WP2, as a three dimensional solid rigid finishing layer including a thickness (T²) of about ⅛ inch, the width (W¹) of about 5½ inches, and the length (L¹) of about 8.00-20.00 feet inclusive; wherein the second wood species WP2 is a superior grade of North American Softwood species selected from the group consisting of western red cedar (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In the exemplary embodiment, as shown in FIG. 15D, the facing wood veneer 50 is formed from the wood species Bulletwood, Massaranduba (Manilkara bidentata) (“Massaranduba”) 18 facing wood veneer 50.

The facing wood veneer 50 is seamlessly permanently attached to the complex wood core assembly 60 via the pressure sensitive liquid adhesive 120 whereby the second finishing face 54 of the facing wood veneer 50 is overlaid against the first complex wood face 66 of the complex wood core assembly 60, as shown in FIG. 15E.

The facing wood veneer 50 is laminated against the first complex wood face 66 of the complex wood core assembly 60 through an automated hydraulic press under heat and pressure enabling and operable for providing a visually seamless permanent attachment of the facing wood veneer 50 against the complex wood core assembly 60 to form a facing wood veneered complex wood core assembly 70, as shown in FIG. 15E, more particularly, a Massaranduba 18 veneered complex wood core assembly 60. The complex wood core assembly 60, more particularly, the Massaranduba 18 veneered tight knot western red cedar 16 complex wood core assembly 60 is configured including the thickness (T¹) of about 1½ inches; the width (W¹) of about 5½ inches, and a length (L¹) of about 8.00-20.00 feet, as shown in FIG. 15E.

The facing wood veneered complex wood core assembly 70, more particularly, the Massaranduba 18 veneered complex wood core assembly 60 is sized to form the outdoor wood decking board 10, as shown in FIG.15F via the planer or moulder to a configuration including the thickness (T¹) of about 1½ inches, a width (W²) of about 5¼ inches, and the length (L¹) of about 8.00-20.00 feet inclusive.

The facing wood veneered complex wood core assembly 70, more particularly, the Massaranduba 18 veneered complex wood core assembly 60, includes the first finishing face 52 of the facing wood veneer 20 displayed to the viewer. More particularly, the Massanranduba 18 veneered tight knot western red cedar complex wood core assembly 70 includes the first wood finishing face 52 of the Massanranduba 18 facing wood veneer 50 displayed to a viewer, thereby, a plurality of outdoor wood decking boards 10 including the Massanranduba 18 veneered tight knot western red cedar complex wood core assembly 60 adapted to be arranged along the interior longitudinal wood side edges of each other form an assembled simulated non-cactile Massanranduba 18 outdoor deck floor 100 of pre-configured dimensions.

In another embodiment of the disclosure, the facing wood veneer 50 can be a clear vertical grain western red cedar 14 species thereby forming a clear vertical grain western red cedar veneered tight knot western red cedar complex wood core assembly 60.

The pressure sensitive liquid adhesive in the exemplary embodiment of the disclosure of the outdoor wood decking board 10 including the complex wood core assembly 60 is a polyvinylacetate. In another embodiment, the pressure sensitive liquid adhesive is a melamine resin adhesive including a liquid hardener. In another embodiment of the outdoor wood decking board 10, wherein the outdoor wood decking board 10 includes a complex wood core assembly 60, the pressure sensitive liquid adhesive 120 is a crosslinking vinyl acetate, wherein the crosslinking vinyl acetate has a solid content of about 52% and a ph of about 5.5-6.0. In yet another embodiment, the crosslinking vinyl acetate has a solid content of about 46% and a ph of about 4.5-5.5.

In another embodiment, the pressure sensitive liquid adhesive is a polymerized polyurethane reactive adhesive. The pressure sensitive liquid adhesive 120 is a polyurethane reactive adhesive, or polymerized polyurethane reactive adhesives. The polyurethane reactive adhesives have been known to be used in construction. They have been utilized in outdoors, boasting effective weatherproofing qualities and high impact bonding strength.

In another embodiment of the disclosure, the pressure sensitive liquid adhesive 120 can be a polyurethane resin adhesives can even withstand exposure to salt water. Polyurethane resin adhesives boast excellent resistance to high temperatures, UV and weather conditions to provide a tough, hard wearing bond.

In an embodiment of the disclosure, an outdoor wood decking board 10 for use in construction of an outdoor deck floor 100, as shown in FIG. 16A-16E, includes a core 30 including a facing wood veneer 50 permanently seamlessly attached to the core 30.

In an embodiment of the disclosure, the core 30 can be formed from a wood plastic composite 130, as shown in FIGS. 16A 16E. A supplier of wood plastic composites are Hardy Smith Wood Plastic Composite at http://hardysmith.orq/about-us.html.

The core 30, as shown in FIG. 16A is formed from a wood plastic composite 130, as a three dimensional solid rigid wood body including a thickness (T¹), a width (W¹), and a length (L¹). The core 30 includes a first face 32, and a second face 34 opposed to the first face 32, and dual opposite longitudinal side edges 36, a first end 38 and a second end 39.

In the exemplary embodiment, the core 30 is formed from a wood plastic composite 130. The wood plastic composite 130 comprises a mixture of raw materials of natural fibers of agricultural waste, wood waste products, and plastic polymers. The raw materials can include natural fibers of wood waste, saw mill waste, wood powder, wood flour, wood chips, bagasse, bamboo, coir fibers, rice husk, cotton stalks. The wood plastic composites are commercially through Hardy Smith company at http://hardysmith.org/about-us.html.

The plastic polymers include polyethylene or polythene (International Union of Pure and Applied Chemistry (IUPAC) name, polyvinyl chloride, and polypropylene. The plastic polymers can, further, include virgin polyethylene, virgin polyvinyl chloride, and virgin polypropylene. The plastic polymers can, further, include recycled polyethylene, recycled polyvinyl chloride, recycled polypropylene.

Polyvinyl chloride, (“PVC”), is a thermoplastic polymer. It is a vinyl polymer constructed of repeating vinyl groups having one hydrogen replaced by chloride. Polyvinyl chloride is the third most widely produced plastic, after polyethylene and polypropylene. PVC is widely used in construction because it is cheap, durable, and easy to assemble. PVC production is expected to exceed 40 million tons by 2016. Polyethylene or polythene is the most widely used plastic, with an annual production of approximately 80 million metric tons. Its primary use is within packaging (plastic bag, plastic films, and the like).

Polyethylene (“PE”) is a thermoplastic polymer consisting of long chains produced by combing the ingredient monomer ethylene (IUPAC name ethene), the name comes from the ingredient and not the actual chemical resulting. The ethene molecule (known almost universally by its common name ethylene) C2H4 is CH2═CH2. Two CH2 groups connected by a double bond, thus: Polyethylene contains the chemical elements carbon and hydrogen.

Polyethylene is created through polymerization of ethene. It can be produced through radical polymerization, anionic addition polymerization, ion coordination polymerization or cationic addition polymerization. This is because ethene does not have any substituent groups that influence the stability of the propagation head of the polymer. Each of these methods results in a different type of polyethylene. Polyethylene is classified into several different categories based mostly on its density and branching. The mechanical properties of PE depend significantly on variables such as the extent and type of branching, the crystal structure and the molecular weight. With regard to sold volumes, the most important polyethylene grades are HDPE, LLDPE and LDPE.

Polypropylene (“PP”), also known as polypropene, is a thermoplastic polymer used in a wide variety of applications including packaging, textiles (e.g., ropes, thermal underwear and carpets), stationery, plastic parts and reusable containers of various types, laboratory equipment, loudspeakers, automotive components, and polymer banknotes. An addition polymer made from the monomer propylene, it is rugged and unusually resistant to many chemical solvents, bases and acids.

The melting of polypropylene occurs as a range, so a melting point is determined by finding the highest temperature of a differential scanning calorimetry chart. Perfectly isotactic PP has a melting point of 171° C. (340° F.), Commercial isotactic PP has a melting point that ranges from 160 to 166° C. (320 to 331° F.), depending on atactic material and crystallinity. Syndiotactic PP with a crystallinity of 30% has a melting point of 130° C. (266° F.).

The melt flow rate (MFR) or melt flow index (MFI) is a measure of molecular weight of polypropylene. The measure helps to determine how easily the molten raw material will flow during processing. Polypropylene with higher MFR will fill the plastic mould more easily during the injection or blow-moulding production process. As the melt flow increases, however, some physical properties, like impact strength, will decrease.

There are three general types of polypropylene: homopolymer, random copolymer, and block copolymer. The comonomer is typically used with ethylene. Ethylene-propylene rubber or EPDM added to polypropylene homopolymer increases its low temperature impact strength. Randomly polymerized ethylene monomer added to polypropylene homopolymer decreases the polymer crystallinity and makes the polymer more transparent.

The wood waste includes any natural wood and wood wastes can be used for making wood plastic composites. Wood will be converted into powder form for mixing and final material preparation. Wood waste coming out as a part of plywood mills, saw mills, particle board units, board units, veneer units and other furniture units can be utilized as an effective raw material for producing wood plastic composites. These wastes are converted into fine powder through wood powder milling machine.

The agriculture wastes like bagasse, bamboo or bamboo wastes, cotton stalks, rice straws, wheat straws, coir fiber, coconut shells, etc. can be used as a good quality raw material option for natural fibers. These natural fibers are fitting best to get polymerized with polymers like PVC, PE & PP.

As shown in FIG. 16E, the outdoor wood decking board 10 includes a core 10 formed from a wood plastic composite 130 including a facing wood veneer 50 permanently seamlessly attached to the core 30.

Referring to FIG. 16A, depicts an embodiment of an outdoor wood decking board 10, according to the embodiment of the disclosure. The outdoor wood decking board 10 embodied for use in construction of an outdoor deck floor 100 comprises a core 30, a facing wood veneer 50, a pressure sensitive liquid adhesive 120. The facing wood veneer 50 is seamlessly permanently attached to a first face 32 of the core 30 by means of the pressure sensitive liquid adhesive 120.

Referring to FIGS. 16A-16B, the core 30 is formed from a wood plastic composite 130, as a three dimensional solid rigid body including a thickness (T¹), a width (W¹), and a length (L¹). The core 30 includes a first face 32, a second face 34 opposed to the first face 32, and dual opposite longitudinal side edges 36, the dual opposite longitudinal side edges 36 including interior longitudinal side edges 36¹ and exterior longitudinal side edges 36². The core 30 includes a first end 38 and a second end 39. The core 30 includes a longitudinal axis (LA). The core 30 is sized via a planar or a moulder to a configuration including a thickness of (T⁵) which is equal to (T¹)−⅛ inch), as shown in FIG. 16B.

The core 30 is sized to the thickness of (T⁵) to account for the thickness of the facing wood veneer 50 upon the permanent attachment of the facing wood veneer 50 to the core 30, wherein the facing wood veneer includes a thickness (T²) of about ⅛ inch. Implementing this feature, provides for consistency in providing a facing wood veneered core 20, as shown in FIG. 16D is configured with a consistent thickness (T¹) of about 1½ inches, and the outdoor wood decking board 10 post being sized is configured consistently having a thickness (T¹) of about 1½ inches, a width (W²) of about 5¼ inches, and a length (L¹) of about 8.00-20.00 feet inclusive.

The facing wood veneer 50, as shown in FIG. 16C, in an embodiment of the disclosure, is formed from a second wood species WP2, as a three dimensional solid rigid wood finishing layer including a thickness (T²) where (T ²) is equal to ⅛ inch, the width (W¹), and the length (L¹). The facing wood veneer 50 includes a first wood finishing face 52, a second wood finishing face 54 opposed to the first wood finishing face 52, and dual opposing longitudinal facing wood veneer side edges 56. The facing wood veneer 50 is configured including the thickness (T²) of about ⅛ inch, the width (W¹) of about 5½ inches, and the length (L¹) of about 8.00-20.00 feet inclusive thereof.

The second wood species WP2 can be a superior grade of North American Softwood species selected from the group comprising of western red cedar, (Thuja plicata), (Thuja occidentalis), Douglas Fir (Pseudotsuga menziesii), clear grain Western Larch (Larix occidentalis), clear grain Alpine Larch (Larix lyallii), clear grain Alaskan Yellow Cedar (Chamaecyparis nootkatensis), clear grain Hemlock (Tsuga heterophylla), clear grain, Port of Oxford Cedar (Chamaecyparis lawsoniana), clear grain Redwood (Sequoia sempervirens), and clear grain Pine/Spruce (Pinus species, Picea species).

In another embodiment, the facing wood veneer 50 can be formed from a third wood species WP3 selected from exotic hardwood species elected from the group comprising of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia) Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

A pressure sensitive liquid adhesive 120 is applied to the first face 32 of the core 30 by means of an adhesive spreading machine, and pressed through an automated hydraulic press under heat and pressure enabling and operable for providing a seamless permanent attachment of the second wood finishing face 54 of the facing wood veneer 50 against the first face 32 of the core 30 forming a facing wood veneered core 20, as shown in FIG. 16D, wherein the facing wood veneered core 20 includes the first wood finishing face 52 of the facing wood veneer 50 displayed to a viewer. In the exemplary embodiment, the facing wood veneer 50, is selected from the second wood species WP2. The facing wood core 50 is a clear vertical grain western red cedar 16 species. Thereby, a plurality of outdoor wood decking boards 10 adapted to be arranged along interior longitudinal side edges 36 of each other form an assembled simulated non-cactile clear vertical grain western red cedar outdoor deck floor 100 of pre-configured dimensions.

Thereby, the facing wood veneered core 20, more particularly, the clear vertical grain western red cedar 16 veneered wood plastic composite 130 core 30, as shown in FIG. 6D is configured including the thickness (T⁴) of about 1⅛ inches, the width (W¹) of about 5½ inches, and the length 1¹) of about 8.00-20.00 feet.

Subsequently, as shown in FIG. 16E, the clear vertical grain western red cedar 16 veneered wood plastic composite 130 core 30, is sized via the planer or moulder to form the outdoor wood decking board 10 as shown in FIG. 16E which is sized to a configuration including the thickness (T⁴) of about 1⅛ inches, the width (W²) of about 5¼ inches, and the length (L¹) of about 10.00 feet, but not limited to.

As mentioned above, the core 30, can be formed from a cement board 132. The cement board 132 is a tile underlayment for wet areas It is resistant to moisture and mold. The cement board 132 is available commercially through Hardie Baker Cement Boards.

With reference to FIGS. 16A-16E, in the exemplary embodiment, of the outdoor wood decking board 10 for use in construction of an outdoor deck floor 100 the core 30 can be configured including the thickness (T¹) of about 1½ inches, a width (W³) of about 3½ inches, and the length (L¹) of about 8.00-20.00 feet inclusive. Subsequently, the core 30 is sized via the planer or moulder to a configuration including the thickness (T⁵) of about 1⅜ inches, a width (W³) of about 3½ inches, and the length (L¹) of about 8.00-20.00 feet inclusive.

The facing wood veneer 50, is configured including the thickness (T²) of about ⅛ inch, the width (W¹) of about 5½ inches, and the length (L¹) of about 8.00-20.00 feet. The facing wood veneered core 20 is sized to form the outdoor wood decking board 10 via the planer or moulder to a configuration including the thickness (T¹) of about 1½ inches, a width (W⁴) of about 3¼ inches, and the length (L¹) of about 8.00-20.00 feet inclusive.

In another embodiment, of the outdoor wood decking board 10 for use in construction of an outdoor deck floor 100, the core 30 can be configured including a thickness (T⁴) of about 1⅛ inches, the width (W¹) of about 5½ inches, and the length (L¹) of about 8.00-20.00 feet inclusive.

Subsequently, the core 30 is sized via the planer or moulder to a configuration including a thickness (T⁶) of about 1.00 inch, the width (W¹) of about 5½ inches, and a length (L¹) of about 8.00-20.00 feet inclusive. The facing wood veneer 50 is configured including the thickness (T²) of about ⅛ inch, the width (W¹) of about 5½ inches, and the length (L¹) of about 8.00-20.00 feet inclusive.

Subsequently, the facing wood veneered core 20 is sized to form the outdoor wood decking board 10 via the planer or moulder to a configuration including the thickness (T⁴) of about 1⅛ inches, the width (W ²) of about 5¼ inches, and the length (L¹) of about 8.00-20.00 feet inclusive.

In the exemplary embodiment, the outdoor wood decking board 10 for use in construction of an outdoor deck floor 100, the core 30 can be configured including a thickness (T⁴) of about 1⅛ inches, a width (W) of about 3½ inches, and the length (L¹) of about 8.00-20.00 feet inclusive. Subsequently, the core 30 is sized via the planer or moulder to a configuration including a thickness (T⁶) of about 1.00 inch, the width (W³) of about 3½ inches, and the length (L¹) of about 8.00-20.00 feet inclusive.

The facing wood veneer 50 is configured including the thickness (T²) of about ⅛ inch, the width (W³) of about 3½ inches, and the length (L¹) of about 8.00-20.00 feet inclusive. Subsequently, and the facing wood veneered core 20 is sized via the planer or moulder to a configuration including the thickness (T⁴) of about 1⅛ inches, the width (W⁴) of about 3¼ inches, and the length (L¹) of about 8.00-20.00 feet inclusive.

In the exemplary embodiment, the outdoor wood decking board 10 for use in construction of an outdoor deck floor 100, the core 30 can be embodied configured including the thickness (T¹) of about 1½ inches, a width (W⁵) of about 7¼ inches, and the length (L¹) of about 8.00-20.00 feet inclusive. Subsequently, the core 30 is sized via the planer or moulder to a configuration including the thickness (T⁵) of about 1⅜ inches, the width (W⁵) of about 7¼ inches, and the length (L¹) of about 8.00-20.00 feet inclusive to accommodate for the thickness (T²) of the facing wood veneer 50.

The facing wood veneer 50 is configured including the thickness (T²) of about ⅛ inch, the width (W⁵) of about 7¼ inches, and the length (L¹) of about 8.00-20.00 feet inclusive. Subsequently, the facing wood veneered core 20 is sized to form the outdoor wood decking board 10 via the planer or moulder to a configuration including the thickness (T¹) of about 1½ inches, a width (W⁶) of about 7⅛ inches, and the length (L¹) of about 8.00-20.00 feet inclusive.

In another embodiment the core 30 can be formed from a wood fiber cement board 132. A cement board supplier is Hardie Backer Cement Boards at http://www.jameshardie.com/Products/HardieBacker-Cement-Board.

The cement board is a tile underlayment made for wet areas. It is resistant to moisture and mold. The cement board is a combination of cement and reinforcing fibers formed into sheets having a thickness, width, and length that are typically used as a tile backing board. Cement board adds impact resistance and strength to surfaces.

Cement boards are mainly cement bonded particle boards and cement fiber. Cement bonded particle boards have treated wood flakes as reinforcement, whereas in cement fiber boards have cellulose fiber, which is a plant extract as reinforcement. Cement acts as binder in both the cases. The fire resistance properties of cement bonded blue particle boards and cement fiber boards are the same. In terms of load-bearing capacity, cement-bonded particle boards have higher capacity than cement fiber boards. Cement particle boards can be manufactured from 6 mm to 40 mm thickness making it ideally suitable for high load bearing applications. These boards are made of a homogeneous mixture and hence are formed as single layer for any thickness. Cement fiber boards are more used in decorative applications and can be manufactured from 3.00 mm to 20.00 mm thickness. Many manufacturers use additives like mica, aluminium stearate and cenospheres in order to achieve certain board qualities. Typical cement fiber board is made of approximately 40-60% of cement, 20-30% of fillers, 8-10% of cellulose, 10-15% of mica. Other additives, like above mentioned, aluminium stearate and PVA are normally used in quantities less than 1%. Cenospheres are used only in low density boards with quantities between 10-15%. A cement board is a combination of cement and reinforcing fibers formed into sheets having a thickness, width, and length that are typically used as a tile backing board.

In another embodiment of the disclosure, a method 200 of manufacturing an outdoor wood decking board 10 for use in the construction of an outdoor deck floor 100, is disclosed. The embodiment of the method 200 is disclosed with reference to FIGS. 1-17, with a more particular attention to FIGS. 1-3E and 17. The method 200 of manufacturing the outdoor wood decking board 10 for use in the construction of an outdoor deck floor 100 comprises, a first step 201 providing a wood core 30 formed from a first wood species WP1. The wood core 30 is shown in FIGS. 1, 2A, 2B, and 3A. The first wood species WP1 is any one of a common grade or general purpose grade of the North American Softwood species, formed as a three dimensional solid rigid wood body. In the exemplary embodiment, the wood core 30 is formed from a tight knot western red cedar 16 species, thereby providing a tight knot western red cedar 16 wood core 30.

The North American Softwood species the first wood species WP1 of the wood core 30 is formed from any one of a common grade of North American Softwood species selected from the group consisting of tight knot Western Red Cedar (Thuja plicata), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

The second step 202 includes configuring the tight knot western red cedar 16 wood core 30 is configured having a thickness (T¹) of about 1½ inches, a width (W¹) of about 5½ inches, and a length (L¹) of about 8.00-20.00 feet inclusive. The tight knot western red cedar 16 wood core 30 includes a first wood face 32, a second wood face 34 opposed to the first wood face 32, and dual opposite longitudinal wood side edges 36. The wood core 30 can be configured at 8.00-20.00 feet inclusive depending upon the preconfigured dimensions for the outdoor wood decking boards 10 configured for the manufacture of the outdoor deck floor 100.

A third step 203 includes drying the tight knot western red cedar 16 wood core 30 to a moisture content suitable for receiving an adhesive 120, the adhesive 120 being a pressure sensitive liquid adhesive 120. In an exemplary embodiment, the pressure sensitive liquid adhesive 120 is a polyvinylacete. In this embodiment, the polyvinyl acetate is a crosslinking vinyl acetate, wherein the crosslinking vinyl acetate has a solid content of about 52%. In another embodiment, the pressure sensitive liquid adhesive 120 is a melamine resin adhesive including a liquid harder. In another embodiment, the pressure sensitive liquid adhesive 120 is a crosslinking vinyl acetate, wherein the crosslinking vinyl acetate has a solid content of about 46%. In another embodiment, the pressure sensitive liquid adhesive 120 is a polymerized polyurethane reactive adhesive.

In another embodiment, the pressure sensitive liquid adhesive 120 is a polyurethane reactive adhesive, or polymerized polyurethane reactive adhesives, and a polyurethane resin adhesive. The polyurethane reactive adhesives have been known to be used in construction. They have been utilized in outdoors, boasting effective weatherproofing qualities and high impact bonding strength. Polyurethane resin adhesives can even withstand exposure to salt water. Polyurethane resin adhesives boast excellent resistance to high temperatures, UV and weather conditions to provide a tough, hard wearing bond.

Next, the method 200 includes a fourth step 204 of sizing the wood core 30, more particularly, the tight knot western red cedar 16 wood core 30 through a planer or a moulder to a thickness (T³) of about 1⅜ inches, the width (W¹) of 5½ inches, and the length (L¹) of 8.00-20.00 feet inclusive to accommodate for the thickness of a facing wood veneer 50, as shown in FIG. 3B

A fifth step 205, as shown in FIG. 3C, is providing the facing wood veneer 50 formed from a second wood species WP2, wherein the second wood species WP2 is selected from any one of a superior quality grade of a North American Softwood species. The North American Softwood species selected from the group consisting of Western Red Cedar (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In the exemplary method 200, a clear vertical grain western red cedar 14; is selected to form the facing wood veneer 50. The facing wood veneer 50, more particularly, the clear vertical grain western red cedar 14 facing wood veneer 50 is formed as a three dimensional solid rigid layer providing a clear vertical grain western red cedar 16 facing wood veneer 50. A sixth step 206 includes configuring the clear vertical grain western red cedar 14 facing wood veneer 50 having a thickness (T²) of about ⅛ inch, the width (W¹) of about 5½ inches, and the length (L¹) of about 8.00-20.00 feet inclusive. The facing wood veneer 50, more particularly, the clear vertical grain western red cedar 14 facing wood veneer 50 includes a first wood finishing face 52, a second wood finishing face 54 opposed to the first wood finishing face 52, and dual opposing longitudinal facing wood veneer side edges 56. The facing wood veneer 50 can be configured at about 8.00-20.00 feet inclusive to correspond to the configuration of the wood core 30.

A seventh step 207 includes providing a pressure sensitive liquid adhesive.

An eighth step 208 includes spreading the pressure sensitive liquid adhesive 120 through an adhesive spreading machine such that the pressure sensitive liquid adhesive 120 covers the entire first wood face 32 of the tight knot western red cedar 16 wood core 32. A ninth step 209 includes overlaying the second wood finishing face 54 of the clear vertical grain western red cedar 14 facing wood veneer 50 against the first wood face 32 of the tight knot western red cedar 16 wood core 30, as shown in FIG. 3D,

An tenth step 210 includes laminating the facing wood veneer 50 against the wood core 30, more particularly the clear vertical grain western red cedar 14 facing wood veneer 50 against the first wood face of the tight knot western red cedar 16 wood core 30 through an automated hydraulic press under heat and pressure for providing a visually seamless permanent attachment of the clear vertical grain western red cedar 14 wood veneer 50 against the first wood face of the tight knot western red cedar 16 wood core 30 forming a facing wood veneered wood core including a clear vertical grain western red cedar veneered tight knot western red cedar 16 wood core 30, as shown in FIG. 3D. The clear vertical grain western red cedar 14 veneered tight knot western red cedar 14 wood core 20 includes a thickness (T¹) of about 1½ inches, a width (W¹) of about 5½ inches, and a length (L¹) of about 8.00-20.00 inches inclusive. Noticeably, the first wood finishing face 52 of the clear vertical grain western red cedar 14 facing wood veneer 50 is displayed to a viewer. Thereby, a plurality of outdoor wood decking boards 10 adapted to be arranged along interior longitudinal wood side edges 36 of each other form an assembled simulated non-cactile clear vertical grain western red cedar 14 outdoor deck floor 100, as shown in FIG. 17.

An eleventh step 211 includes removing the clear vertical grain western red cedar 14 veneered tight knot western red cedar 16 wood core 30 from the automated hydraulic press. The twelfth step 212 includes cooling the clear vertical grain western red cedar 14 veneered tight knot western red cedar 14 wood core 30 at 90 at ambient temperature. A thirteenth step 213 includes sizing the clear vertical grain western red cedar 14 veneered tight knot western red cedar 16 wood core 30 through the planer or moulder to form the outdoor wood decking board 10 the thickness (T¹) of about 1½ inches, a width (W²) of about 5¼ inches, and the length (L¹) of about 8.00-20.00 feet, as shown in FIG. 3E.

In the exemplary method 200, the first wood species WP1 of the wood core 30, as listed above, is formed from a common grade or general purpose grade of North American Softwood species, including tight knot grade, selected from the group consisting of Western Red Cedar (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In the exemplary method 200, the second wood species WP2 of the facing wood veneer 50, can be selected from the group consisting of superior grade: western red cedar, (Thuja plicate), (Thuja occidentalis), Douglas Fir (Pseudotsuga menziesii). Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), Pine/Spruce (Pinus species, Picea species).

In the exemplary method 200, the facing wood veneer 50 can be formed from the second wood species WP2, wherein the second wood species WP2 is an exotic hardwood species, the exotic hardwood species selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

The exemplary method 200, can further comprise a fourteenth step 214 including sanding the clear vertical grain western red cedar 14 veneered tight knot western red cedar 16 wood core 30 in preparation of staining the clear vertical grain western red cedar 14 veneered tight knot western red cedar wood core 30.

In addition, the exemplary method 200 can further comprise a fifthteenth step 215 including immersing a colorless wood conditioner flood coat via a coating process to the clear vertical grain western red cedar 14 veneered tight knot western red cedar 16 wood core 30 wherein the colorless wood conditioner comprises one or more agents, wherein an agent of the one or more agents is selected from the group comprising, fungicides, biocides, insecticides, water repellants, UV blockers, fire retardants, wood hardeners, and strength enhances.

In an embodiment of the exemplary method 200, the length (L¹) of the wood core 30 can be configured to a length (L) selected from the group of lengths (L¹) comprising, 8.00 , 10.00 feet, 12.00 feet, 14.00 feet, 16.00 feet, 18.00 feet, and 20.00 feet. In addition, in an embodiment of the exemplary method 200, the length (L¹) of the facing wood veneer 50 can be configured to a length (L¹) selected from the group of lengths (L¹) comprising, 8.00 feet, 10.00 feet, 12.00 feet, 14.00 feet, 16.00 feet, 18.00 feet, and 20.00 feet.

In another embodiment of the exemplary method 200 of manufacturing an outdoor wood decking board 10 for use in the construction of an outdoor deck floor 100, the length (L¹) of the wood core 30 can be pre-configured to a length (L¹) selected from the group of lengths comprising, 9.00 feet, 11.00 feet, 13.00 feet, 15.00 feet, 17.00 feet, 19.00 feet, and 21.00 feet; and the length (L¹) of the facing wood veneer 50 can be pre-configured to a length selected from the group of lengths comprising, 9.00 feet, 11.00 feet, 13.00 feet, 15.00 feet, 17.00 feet, 19.00 feet, and 21.00 feet.

In the another embodiment of the exemplary method 200 of manufacturing an outdoor wood decking board 10 for use in the construction of an outdoor deck floor 100, the wood core 30, is configured, with reference to FIGS. 4A-4E including the thickness (T¹) of about 1½ inches, a width (W³) of about 3½ inches, and the length (L¹) of about 8.0 feet, and can be configured at about 8.00 feet-20.00 feet inclusive. Subsequently, the wood core 30, as shown in FIG. 4B, is sized via the planer or moulder to a configuration including the thickness (T⁵) of about 1⅜ inches, a width (W³) of about 3½ inches, and the length (L¹) of about 8.0 feet, and can be configure at about 8.00-20.00 feet inclusive, for accommodating the thickness (T²) of the facing wood veneer 50.

Further, the facing wood veneer 50, as shown in FIG. 4C, is configured including the thickness (T²) of about ⅛ inch, the width (W¹) of about 5½ inches, and the length (L¹) of about 8.00 feet, and can be configured at 8.00 feet to 20.00 feet inclusive. As shown in FIG. 4D, the clear vertical grain western red cedar 14 veneered tight knot western red cedar 16 wood core 30 includes a thickness (T¹) of about 1½ inches, a width of about 3½ inches, and a length of about 8.00-20.00 feet. The clear vertical grain western red cedar 14 veneered tight knot western red cedar 16 wood core 20 is sized via the planer or moulder to form the outdoor wood decking board 10 which is configured including the thickness (T¹) of about 1½ inches, a width (W⁴) of about 3¼ inches, and the length (L¹) of about 8.00-20.00 feet inclusive. The wood core 30 can be configured at 8.00-20.00 feet inclusive depending upon the preconfigured dimensions for the outdoor wood decking boards 10 configured for the manufacture of the outdoor deck floor 100.

In another embodiment of the exemplary method 200 of manufacturing an outdoor wood decking board 10 for use in the construction of an outdoor deck floor 100, the wood core 30 is configured including a thickness (T⁴) of about 1⅛ inches, the width (W¹) of about 5½ inches, and the length (L¹) of about 8.00-20.00 feet inclusive.

Subsequently, the wood core 30 is sized via the planer or moulder to a configuration including a thickness (T⁶) of about 1.00 inch, the width (W¹) of about 5½ inches, and a length (L¹) of about 8.00-20.00 feet inclusive to accommodate for the thickness (T²) of the facing wood veneer 50.

The facing wood veneer 50, is configured including the thickness (T²) of about ⅛ inch, the width (W¹) of about 5½ inches, and the length (L¹) of about 8.00-20.00 feet inclusive. Thereby, the clear vertical grain western red cedar 14 veneered tight knot western red cedar 16 wood core 20 is configured including the thickness (T⁴) of about 1⅛ inches, the width (W¹) of about 5 1.2 inches, and the length (L¹) of about 8.00-20.00 feet inclusive.

Subsequently, the clear vertical grain western red cedar 14 veneered tight knot western red cedar 16 wood core 30, is sized via the planer or moulder to form the outdoor wood decking board 10 so configured including the thickness (T⁴) of about 1⅛ inches, the width (W²) of about 5¼ inches, and the length (L¹) of about 8.00-20.00 feet inclusive.

In yet another embodiment of the exemplary method 200 of manufacturing an outdoor wood decking board 10 for use in the construction of an outdoor deck floor 100, the wood core 30 is configured including a thickness (T⁴) of about 1⅛ inches, a width (W³) of about 3½ inches, and the length (L¹) of about 8.00-20.00 feet inclusive.

Subsequently, the wood core 30 is sized via the planer or moulder to a configuration including a thickness (T⁶) of about 1.0 inch, the width (W³) of about 3½ inches, and the length (L¹) of about 8.00-20.00 feet inclusive for accommodating the thickness (T²) of the facing wood veneer 50.

The facing wood veneer 50 is configured including the thickness (T²) of about ⅛ inch, the width (W³) of about 3½ inches, and the length (L¹) of about 8.00-20.00 feet. Subsequently, the clear grade vertical grain western red cedar 14 veneered tight knot western red cedar 16 wood core 30 is sized to form the outdoor wood decking board 10 via the planer or moulder to a configuration including the thickness (T⁴) of about 1⅛ inches, the width (W⁴) of about 3¼ inches, and the length (L¹) of about 8.00-20.00 feet inclusive.

In yet another embodiment of the exemplary method 200 of manufacturing an outdoor wood decking board 10 for use in the construction of an outdoor deck floor 100, the wood core 30 is configured including the thickness (T¹) of about 1½ inches, a width (W⁵) of about 7¼ inches, and the length (L¹) of about 8.00-20.00 feet inclusive.

Subsequently, the wood core 30 is sized via the planer or moulder to a configuration including the thickness (T⁵) of about 1⅜ inches, the width (W⁵) of about 7¼ inches, and the length (L¹) of about 8.00-20.00 feet inclusive to accommodate for the thickness (T²) of the facing wood veneer 50.

The facing wood veneer 50 is configured including the thickness (T²) of about ⅛ inch, the width (W⁵) of about 7¼ inches, and the length (L¹) of about 8.00-20.00 feet inclusive. Thereby the clear vertical grain western red cedar 14 veneered tight knot western red cedar 16 wood core 30 is configured including the thickness (T¹) of about 1½ inches, a width (W⁵) of about 7¼ inches, and a length (L′¹) of about 8.00-20.00 feet inclusive.

The clear vertical grain western red cedar 14 veneered tight knot western red cedar 16 wood core 30 is sized to form the outdoor wood decking board 10 via the planer or moulder to a configuration including the thickness (T¹) of about 1½ inches, a width (W⁶) of about 7⅛ inches, and the length (L¹) of about 8.00-20.00 feet inclusive.

In the exemplary method 200 of manufacturing the outdoor wood decking board 10 for use in the construction of an outdoor deck floor 100 the pressure sensitive liquid adhesive 120 can be a melamine resin adhesive including a liquid hardener.

In another embodiment of the exemplary method 200 of manufacturing the outdoor wood decking board 10 for use in the construction of an outdoor deck floor 100 the pressure sensitive liquid adhesive 120 is polyvinylacetate. Further, the pressure sensitive liquid adhesive 120 is a crosslinking vinyl acetate, wherein the crosslinking vinyl acetate has a solid content of about 52%.

In another embodiment of the exemplary method 200 of manufacturing an outdoor wood decking board 10 for use in the construction of an outdoor deck floor 100 the pressure sensitive liquid adhesive 120 is a crosslinking vinyl acetate, wherein the crosslinking vinyl acetate has a solid content of about 46%.

In another embodiment, the pressure sensitive liquid adhesive 120 is a polyurethane reactive adhesive, or polymerized polyurethane reactive adhesives, and a polyurethane resin adhesive. The polyurethane reactive adhesives have been known to be used in construction. They have been utilized in outdoors, boasting effective weatherproofing qualities and high impact bonding strength. Polyurethane resin adhesives can even withstand exposure to salt water, Polyurethane resin adhesives boast excellent resistance to high temperatures, UV and weather conditions to provide a tough, hard wearing bond.

In another embodiment of the disclosure a second method 300 of manufacturing an outdoor wood decking board 10 for use in the construction of an outdoor deck floor 100 is disclosed including a first wood core 30 and a second wood core 30², with reference to FIGS. 9A-9B in the understanding of the second method 300 embodied in the disclosure.

The second method 300, comprises a first step 301 including providing a first wood core 30, as shown in FIG. 9A, formed from a first wood species WP1 as a three dimensional solid rigid wood body¹ including a thickness (T³) of about ¾ inch, a width (W¹) of 5½ inches, and a length (L¹) of about 8.00, but not limited to. The first wood core 30 includes a first wood face¹ 32, a second wood face¹ 34 opposed to the first wood face¹ 30, and dual opposite longitudinal wood side edges 36, wherein the first wood species WP1 is a tight knot western red cedar 16 species thereby forming a first tight knot western red cedar wood core 30.

The second step 302 of the second method 300 of manufacturing the outdoor wood decking board 10 for use in the construction of an outdoor deck floor 100 includes providing a second wood core 30², as shown in FIG. 9B, formed from the tight knot western red cedar 16 species as a three dimensional solid rigid wood body configured as a second tight knot western red cedar wood core 30² including the thickness (T³) of about ¾ inch, the width (W¹) of 5½ inches, and the length (L¹) of about 8.00 feet, but not limited to, thereby providing a second tight knot western red cedar 16 wood core 30² including a first wood face² 32, a second wood face² 34 opposed to the first wood face¹ 32, and dual opposite longitudinal wood side edges² 37. A third step 303 of the second method 300 includes drying the first wood core 30, the first tight knot western red cedar wood core 30, and the second wood core, 30², the second tight knot western red cedar wood core 30² to a moisture content suitable for receiving a pressure sensitive liquid adhesive 120.

A fourth step 304 of the second method 300 of manufacturing the outdoor wood decking board 10 for use in the construction of an outdoor deck floor 100 includes providing a pressure sensitive liquid adhesive 120.

A fifth step 305 of the second method 300 includes spreading the pressure sensitive liquid adhesive 120 applied to the second wood face² 34² of the second tight knot western red cedar 16 wood core 30² and to the second wood face¹ 34 of the first tight knot western red cedar wood core 30 through an adhesive spreading machine such that the pressure sensitive liquid adhesive 120 covers the entire second wood face² 34² of the second tight knot western red cedar 16 wood core 30² and the entire second wood face¹ 34 of the first tight knot western red cedar 16 wood core 30.

A sixth step 306 of the second method 300 of manufacturing an outdoor wood decking board 10 for use in the construction of the outdoor deck floor 100 includes overlaying the second wood face² 34² of the second tight knot western red cedar 16 wood core 30² against the second wood face¹ 34 of the first tight knot western red cedar 16 wood core 30 through an automated hydraulic press under heat and pressure enabling and operable for providing a visually seamless permanent attachment of the second wood face¹ 34 of the first tight knot western red cedar 16 wood core 30 against the second wood face² 34² of the second tight knot western red cedar 16 wood core 30² forming a face-to-face wood core 40, as shown in FIG. 9C, more particularly, a tight knot western red cedar 16 face-to-face wood core 40, simulating a single three dimensional solid rigid wood body having a thickness (T¹) of about 1½ inches, the width (W²) of about 5½ inches, and the length of about 8.00 inches, but not limited to, wherein the first wood face¹ 32 of the first tight knot western red cedar 16 wood core 30 is opposed to the first wood face² 34² of the second tight knot western red cedar wood core 30².

A seventh step 307 of the second method 300 of manufacturing the outdoor wood decking board 10 for use in the construction of an outdoor deck floor 100 includes removing the tight knot western red cedar 16 face-to-face wood core 40 from the automated hydraulic press. An eighth step 308 of the second method 300 includes cooling the tight knot western red cedar 16 face-to-face wood core 40 at ambient temperature.

An ninth step 309 of the second method 300 of manufacturing the outdoor wood decking board 10 for use in the construction of an outdoor deck floor 100 includes sizing the tight knot western red cedar 16 face-to-face wood core 40 via a planer or a moulder to a thickness (T⁵) of about 1⅜ inch, the width (W²) of about 5½ inches, and the length of about 8.00 inches, but not limited to.

A tenth step 310 of the second method 310 of manufacturing an outdoor wood decking board 10 for use in the construction of an outdoor deck floor 100 includes providing a facing wood veneer 50, as shown in FIG. 9D, formed from a second wood species WP2 as a three dimensional solid rigid finishing layer including a thickness (T²) of about ⅛ inch, the width (W¹) of about 5½ inches, and the length (L¹) of about 8.00 feet, but not limited to.

The facing wood veneer 50 includes a first wood finishing face 52, a second wood finishing face 54 opposed to the first wood finishing face 52, and dual opposing longitudinal facing wood veneer side edges 56. The second wood species WP2 is a clear vertical grain western red cedar 14 species, thereby providing a clear vertical grain western red cedar facing wood veneer 50.

An eleventh step 311 of the second method 300 includes providing a pressure sensitive liquid adhesive. The twelfth step 312 of manufacturing the outdoor wood decking board 10 for use in the construction of an outdoor deck floor 100 includes spreading the pressure sensitive liquid adhesive 120 through the adhesive spreading machine such that the pressure sensitive liquid adhesive 120 covers the entire first wood face¹ 32 of the first tight knot western red cedar wood core 30 of the tight knot western red cedar 16 face-to-face wood core 40.

An thirteenth step 313 of the second method 300 of manufacturing the outdoor wood decking board 10 for use in the construction of an outdoor deck floor 100 includes overlaying the second wood finishing face 54 of the clear vertical grain western red cedar 14 facing wood veneer 50, as shown in FIG. 9D, against the first wood face¹ 32 of the first tight knot western red cedar 16 wood core 30 of the tight knot western red cedar 16 face-to-face wood core 40.

A fourteenth step 314 of the second method 300 of manufacturing the outdoor wood decking board 10 for use in the construction of an outdoor deck floor 100 includes laminating the clear vertical grain western red cedar 14 facing wood veneer 50 against the tight knot western red cedar 16 face-to-face wood core 40 through the automated hydraulic press under heat and pressure enabling and operable for providing a seamless permanent attachment of the second wood finishing face 54 of the clear vertical grain western red cedar 14 facing wood veneer 50 against the first wood face¹ 32 of the first tight knot western red cedar 16 wood core 30 of the tight knot western red cedar 16 face-to-face wood core 40 forming a facing wood veneered face-to-face wood core 90, with reference to FIG. 10B, namely, a clear vertical grain western red cedar 14 veneered tight knot western red cedar 16 face-to-face wood core 40. The facing wood veneered face-to-face wood core 90, is configured including the thickness (T¹) of about 1½ inches, the width (W¹) of about 5½ inches, and the length (L¹) of about 8.00 feet, but not limited to.

The first wood finishing face 52 of the clear vertical grain western red cedar 14 facing wood veneer 50 is displayed to a viewer, thereby a plurality of outdoor wood decking boards 10 adapted to be arranged along interior longitudinal wood side edges 36 of each other thereby form an assembled simulated non-cactile clear vertical grain western red cedar outdoor deck floor 100 formed of pre-configured dimensions.

A fifteenth step 315 of the second method 300 of manufacturing the outdoor wood decking board 10 for use in the construction of an outdoor deck floor 100 includes sizing the facing wood veneered face-to-face wood core 90, namely, the clear vertical grain western red cedar 14 veneered tight knot western red cedar 16 face-to-face wood core 40 to form the outdoor wood decking board 10 via a planer or moulder configured to the thickness (T¹) of about 1½ inches, a width (W²) of about 5¼ inches, and the length (L) of about 8.00 feet, but not limited to, as shown in FIG. 9E.

In the second method 300 of manufacturing the outdoor wood decking board 10 for use in the construction of the outdoor deck floor 100, the pressure sensitive liquid adhesive is a polyvinylacetate.

In another embodiment of the second method 300 of manufacturing the outdoor wood decking board 10 for use in the construction of an outdoor deck floor the pressure sensitive liquid adhesive 120 is a melamine resin adhesive including a liquid hardener.

In another embodiment of the second method 300 of manufacturing the outdoor wood decking board 10 for use in the construction of an outdoor deck floor 100 the pressure sensitive liquid adhesive 120 is a crosslinking vinyl acetate, wherein the crosslinking vinyl acetate has a solid content of about 52%.

In another embodiment of the second method 300 of manufacturing the outdoor wood decking board 10 for use in the construction of an outdoor deck floor 100 the pressure sensitive liquid adhesive 120 is a crosslinking vinyl acetate, wherein the crosslinking vinyl acetate has a solid content of about 46%.

In another embodiment, of the second method 300, the pressure sensitive liquid adhesive 120 is a polyurethane reactive adhesive, or polymerized polyurethane reactive adhesives, and a polyurethane resin adhesive. The polyurethane reactive adhesives have been known to be used in construction. They have been utilized in outdoors, boasting effective weatherproofing qualities and high impact bonding strength. Polyurethane resin adhesives can even withstand exposure to salt water. Polyurethane resin adhesives boast excellent resistance to high temperatures, UV and weather conditions to provide a tough, hard wearing bond.

In another embodiment of the second method 300 of manufacturing the outdoor wood decking board 10 for use in the construction of an outdoor deck floor 100, the second method 300 further comprises providing a colorless wood conditioner coat via a coating process to the facing wood veneered face-to-face wood core 90, more particularly, the clear vertical grain western red cedar 14 veneered tight knot western red cedar 16 face -to-face wood core 40 at 90 wherein the colorless wood conditioner comprises one or more agents, wherein an agent of the one or ore agents is selected from the group comprising, fungicides, biocides, insecticides, water repellants, UV blockers, fire retardants, wood hardeners, and strength enhances.

In the exemplary embodiment of the second method 300 of manufacturing the outdoor wood decking board 10 for use in the construction of an outdoor deck floor 100, the second method 300 embodies the first wood core 30 and the second wood core 30² to each be formed from any one of the first wood species WP1 of common quality grade, or general purpose grade of the first wood species WP1, where the first wood species WP1 is any one of North American Softwood species selected from the group consisting of western red cedar (Thuja plicata), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In the exemplary embodiment of the second method 300 of manufacturing the outdoor wood decking board 10 for use in the construction of the outdoor deck floor 100, the facing wood veneer 50 is formed from any one of the second wood species WP2. The second wood species WP2 is selected from a superior quality grade of North American Softwood species, selected from the group consisting of clear vertical grain western red cedar, (Thuja plicata), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

In the exemplary embodiment of the second method 300 of manufacturing the outdoor wood decking board 10 for use in the construction of an outdoor deck floor 100, the facing wood veneer 50 can be formed from any one of the third wood species WP3 selected from a group of exotic hardwood species. The exotic hardwood wood species, is selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectoria grandis); Ebony Blackbead (Ebenopsis ebano); African Blackwood (Dalbergia melanoxylon); and Bismarck Black Myzomela (Myzomela pammelaena).

Another embodiment of the second method 300 is shown in FIG. 10A-10F which shows an outdoor wood decking board 10 including the face-to-face wood core 40. In the exemplary embodiment, the first wood core 30 and the second wood core 30² are each formed form a tight knot western red cedar 16 and the facing wood veneer 50 is formed from Ipe 26.

In the exemplary embodiment of the second method 300 of manufacturing the outdoor wood decking board 10 for use in the construction of an outdoor deck floor 100, the first wood core 30, as shown in FIG. 10A can be configured including the thickness (T³) of about ¾ inch, a width (W⁵) of about 7¼ inches, and the length (L¹) of about 8.00-20.0 feet inclusive. Similarly, the second wood core 30², as shown in FIG. 10B is configured including the thickness (T³) of about ¾ inch, the width (W⁵) of about 7¼ inches, and the length (L) of about 8.00-20.00 feet inclusive.

Further, in the exemplary embodiment, the face-to-face wood core 40, as shown in FIG. 10C, is sized via the planer or moulder to the thickness of T⁵ of about 1⅜ inches, as shown in FIG. 10E. The facing wood veneer 50, as shown in FIG. 10D, is formed from the third wood species WP3, particularly, Ipe 26.

The facing wood veneer 50 is configured including the thickness (T²) of about ⅛ inch, the width (W⁵) of about 7¼ inches, and the length (L¹) of about 8.00-20.00 feet, and thereby, the facing wood veneered face-to-face wood core 90, particularly, the Ipe 26 veneered tight knot western red cedar 16 face-to-face wood core 40 at 90 is configured with the thickness (T¹) of about 1½ inches, the width (W⁵) of about 7¼ inches, and the length (L¹) of about 8.00-20.00 feet inclusive.

Subsequently, the Ipe 26 veneered tight knot western red cedar 16 face-to-face wood core 40 is sized to form the wood decking board 10, as shown in FIG. 10F, via the planer or moulder to the thickness (T¹) of about 1½ inches, a width (W⁶) of about 7⅛ inches, and the length (L¹) of about 8.00 feet-20.00 feet inclusive.

In the exemplary embodiment of the second method 300 of manufacturing an outdoor wood decking board 10 for use in the construction of an outdoor deck floor 100, the first wood core 30, as shown in FIG. 11A, is formed from the tight knot western red cedar 16 and is configured including the thickness (T³) of about ¾ inch, a width (W³) of about 3½ inches, and the length (L¹) of about 8.00 feet-20.00 feet inclusive. Similarly, the second wood core 30², as shown in FIG. 11B, is formed from the tight knot western red cedar and is configured including the thickness (T³) of about ¾ inch, the width (W³) of about 3½ inches, and the length (L¹) of about 8.0 feet-20 feet inclusive.

The face-to-face wood core 40 is configured including the thickness (T¹) of about 1½ inches, the width (W³) of about 3½ inches, and the length (L¹) of about 8.0 feet, but not limited to. The face-to-face wood core 40 is sized via the planer or moulder to the thickness of T⁵ of about 1⅜ inches to accommodate for the thickness (T³) of the facing wood veneer 50.

The facing wood veneer 50, as shown in FIG. 11E is formed from the clear vertical grain western red cedar 14 configured including the thickness (T²) of about ⅛ inch, the width (W³) of about 3½ inches, and the length (L¹) of about 8.00 feet but not limited to, and thereby, the facing wood veneered face-to-face wood core 40, particularly, the clear vertical grain western red cedar 14 veneered tight knot western red cedar 16 wood core 40 at 90 is configured with the thickness (T¹) of about 1½ inches, the width (W³) of about 3½ inches, and the length (L¹) of about 8.00 feet but not limited to.

Consequentially, the clear vertical grain western red cedar 14 veneered tight knot western red cedar 16 face -to-face wood core 40 at 90 is sized via the planer or moulder to form the outdoor wood decking board 10 including the thickness (T¹) of about 1½ inches, a width (W⁴) of about 3¼ inches, and the length (L¹) of about 8.00 feet but not limited to.

In another embodiment of the disclosure, a third method 400 of manufacturing an outdoor wood decking board 10 for use in the construction of an outdoor deck floor 100. The third method 400 will be disclosed with reference to FIGS. 15A-15F. The third method 400, of manufacturing the outdoor wood decking board 10, as shown in FIG. 15F, comprises a complex wood core assembly 60, as shown in FIG. 15C.

The third method 400, includes a first step 401 which includes providing a series of wood cores 62 including a protract wood core 64 to form a complex wood core assembly block 78, as shown in FIG. 15A. The complex wood core assembly block 78 is formed from the series of wood cores 62 including the protractor wood core 64 to form the complex wood core assembly block 78. The second step of the third method, therefore, is providing the protract wood core 64.

Each of the wood cores 62 of the series of wood cores 62 of the complex wood core assembly block 78 including the protractor wood core 64 is manufactured from a first wood species WP1. In this exemplary embodiment of the third method 400 each of the wood cores 62 and the protractor wood core 64 of the series of wood cores 62 is formed from a wood species of the first wood species WP1.

The first wood species WP1 is any one of a common grade or general purpose grade of North American Softwood species selected from the group consisting of western red cedar (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species). In the exemplary embodiment, each of the wood cores 62 of the complex wood core assembly block 78 including the protract wood core 64 is formed from a tight knot western red cedar 16.

Each wood core 62 of the series of wood cores 62 of the complex wood core assembly 60 is embodied in a separate individual three dimensional solid rigid wood body formed from the first wood species WP1, particularly, the tight knot western red cedar 16, configured including a thickness (T³) of about ¾ inch, a width (W¹) of about 5½ inches, and a length (L¹) of about 8.00 feet-20.00 feet inclusive. Each of the wood core 62 of the series of wood cores 62 includes a first wood face, a second wood face opposed to the first wood face, and dual opposite longitudinal wood side edges, wherein the wood species is a tight knot western red cedar 16 species, thereby providing a series of tight knot western red cedar 16 wood cores 62.

In addition, the protract wood core 64 is embodied in a separate individual three dimensional solid rigid wood body¹ formed from the first wood species, the tight knot western red cedar 16, thereby providing a tight knot western red cedar protract wood core 64 configured including a thickness (T⁸) of about ½ inch, a width (W¹) of about 5½ inches, and a length (L¹) of about 8.00-20.00 feet. The tight knot western red cedar protract wood core 64 includes a first wood face¹ 65, a second wood face¹ 69 opposed to the first wood face¹ 65, and dual opposite longitudinal wood side edges¹71.

The third step 403 of the third method 400 of manufacturing an outdoor wood decking board 100 for use in the construction of an outdoor deck floor 100 includes drying each of the tight knot western red cedar wood cores 62 including the protract wood core 64 to a moisture content suitable to receive a pressure sensitive liquid adhesive.

The fourth step 404 of the third method 300 of manufacturing an outdoor wood decking board 10 for use in the construction of an outdoor deck floor 100 includes positioning the protract wood core 64 centrally among the series of wood cores 62. The protractor wood core 64 is positioned centrally among the wood cores 62 within the complex wood core assembly block 78, as shown in FIG. 15A. Each of the wood cores 62 includes a thickness (T³) of ¾ inch, a width (W¹) of about 5½ inches, and a length of about 8.00-20.00 feet inclusive. The protractor wood core 64 includes a thickness (T⁸) of ½ inch, the width (W¹) of about 5½ inches, and the length of about 8.00-20.00 feet inclusive.

The fourth step 404 of the third method 400 includes positioning the protract wood core 64 centrally within the series of wood cores 62.

The fifth step 405 of the third method 400, includes providing a pressure sensitive liquid adhesive. The sixth step 406 includes spreading a pressure sensitive liquid adhesive 120 on each of interior wood faces 65 of each of the wood cores 62 of the series of wood cores 62 including the protractor wood core 64 via an adhesive spreading machine such that the pressure sensitive liquid adhesive 120 covers the entire interior faces of each of the tight knot western red cedar 16 wood cores 62 of the series of wood cores 62 including the entire interior faces of the protract wood core 64.

The seventh step 407 includes overlaying the interior wood faces of each of the tight knot western red cedar 16 wood cores 62 of the series of wood cores including the protractor wood core 64 interior face-to-interior face. The eighth step 408 includes pressing the overlaid tight knot western red cedar wood cores 62 including the protractor wood core 64 through an automated hydraulic press under heat and pressure enabling and operable for providing a visually seamless permanent attachment of each of the wood cores 62 including the protract wood core 64 to each other enabling and operable for providing a visually seamless permanent attachment of the tight knot western red cedar wood cores 62 including the protractor wood core 64 forming a complex wood core assembly block 78, more particularly, a tight knot western red cedar 16 complex wood core assembly block 78 simulating a single three dimensional solid rigid wood body, as shown in FIG. 15A, configured including the thickness (T⁷) of about 5¾ inches, a width (W¹) of about 5¾ inches, and the length (L¹) of about 8.00-20.00 feet inclusive, thereby forming a tight knot western red cedar complex wood core assembly block 78, as shown in FIG. 15A,

The ninth step 409 of the third method 400 includes cutting the complex wood core assembly block 78 into a plurality of complex wood core assemblies 60. More particularly, cutting the tight knot western red cedar complex assembly block 78 through one or more frontal planes via a cutting machine to form one or more tight knot western red cedar complex wood cores 60. Each complex wood core assembly 60, as shown in FIG. 15B, of the plurality of complex wood core assemblies 60 is configured with a thickness (T¹) of about 1½ inches, a width (W⁹) of about 5¾ inches, and a length (L¹) of about 8.00-20.00 feet inclusive. Each wood core assembly 60, more particularly, each tight knot western red cedar 16 complex wood core assembly 60 includes a first complex wood face 66, and a second complex second wood face 68 opposite to the first complex wood face 66, and complex wood core opposite longitudinal wood side edges 76. With reference to FIG. 15A, the complex wood core opposite longitudinal wood side edges 76 are formed from a portion of the first wood face 65 and the second wood face 69 of the complex wood core assembly block 78.

The tenth step 410 includes providing the complex wood core assembly 60 including the thickness (T¹) of about 1½ inches, the width (W⁹) of about 5¾ inches, and the length (L¹) of about 8.00-20.00 feet inclusive.

The eleventh step 411 of the third method 400 of manufacturing an outdoor wood decking board 10 for use in the construction of an outdoor deck floor 100 includes sizing the complex wood core assembly 60, particularly, the tight knot western red cedar complex wood core assembly 60, via a planer or moulder to a thickness (T⁵) of about 1⅜ inches, the width (W¹) of about 5½ inches, and the length (L¹) of about 8.00-20.00 feet inclusive, as shown in FIG. 15C.

The twelfth step 412 of the third method 400 includes providing a facing wood veneer 50, as shown in FIG. 15D, formed from second wood species WP2, as a three dimensional solid rigid finishing layer including a first wood finishing face 52, a second wood finishing face 54 opposed to the first wood finishing face 52, and opposing longitudinal facing wood veneer side edges 56 and having a facing wood veneer first end 58 and a facing wood veneer second end 59. The facing wood veneer 50 is configured including a thickness (T²) of about ⅛ inch, the width (W¹) of about 5½ inches, and the length (L¹) of about 8.00-20.00 feet inclusive.

In the embodiment of the disclosure, the facing wood veneer 50 can be a clear vertical grain western red cedar 14 species selected from the superior grade of the second wood species WP2 as listed above, and not recited, here, in the interest of brevity.

By way of disclosing the embodiment, of the third method 400, the facing wood veneer 50 can, also, be selected from any one of a third species WP3 of an exotic wood species, as listed above, and not recited, here, in the interest of brevity.

In the exemplary embodiment, the facing wood veneer 50 is formed from the Massanranduba (Manilkara bidentata) 18.

The thirteenth step 413 of the third method 400 includes spreading the pressure sensitive liquid adhesive 120 applied to the first complex wood face 66 of the complex wood core assembly 60, particularly, the tight knot western red cedar 16 complex wood core assembly 60 via the adhesive spreading machine such that the pressure sensitive liquid adhesive covers the entire first complex wood face 66 of the tight knot western red cedar complex wood core assembly 60.

The fourteenth step 414 of the third method 400 includes overalying the second wood finishing face 54 of the facing wood veneer 50, more particularly, the Massanranduba 18 finishing wood veneer 50, as shown in FIG. 15E, against the first complex wood face 66 of the tight complex wood core assembly 60, more particularly, the tight knot western red cedar 16 complex wood core assembly 60.

The fifteenth step 415 of the third method 400 includes laminating the facing wood veneer 50, particularly, the Massanranduba 18 facing wood veneer 50, against the first complex wood face 66 of the complex wood core assembly 60, particularly, the tight knot western red cedar complex wood core assembly 60 through an automated hydraulic press under heat and pressure enabling and operable for providing a visually seamless permanent attachment of the Massanranduba facing wood veneer 50 against the tight knot western red cedar 16 complex wood core assembly 60 to form a facing wood veneered complex wood core assembly 70, particularly, a Massanranduba veneered complex wood core assembly 70 configured including the thickness (T¹) of about 1½ inches; the width (W¹) of about 5½ inches, and a length (L¹) of about 8.00-20.00 feet.

The sixteenth step 416 of the third method 400 includes removing the facing wood veneered complex wood core assembly 70, particularly, the Massanranduba 18 veneered complex wood core assembly 70 from the automated hydraulic press. The seventeenth step 417 of the third method 400 includes sizing the facing wood veneered complex wood core assembly 70, particularly, the Massanranduba 18 veneered complex wood core assembly 70 to form an outdoor wood decking board 10, as shown in FIG. 15F via the planer or moulder to a configuration including the thickness (T¹) of about 1½ inches, a width (W²) of about 5¼ inches, and the length (L¹) of about 8.00-20.00 feet inclusive.

The outdoor wood decking board 10 includes the first wood finishing face 52 of the facing wood veneer 50 displayed to a viewer. More particularly, the outdoor wood decking board 10 includes the first wood finishing face 52 of the Massanranduba outdoor wood decking board 10 displayed to a viewer.

Thereby, a plurality of outdoor wood decking boards 10 adapted to be arranged along the interior longitudinal wood side edges of each other form an assembled simulated non-cactile Massanranduba outdoor deck floor of pre-configured dimensions.

The pressure sensitive liquid adhesive 120 of the third method 400 of manufacturing can be a polyvinylacetate. In another embodiment of the third method 400 the pressure sensitive liquid adhesive 120 is a melamine resin adhesive including a liquid hardener.

In another embodiment of the third method 400 of manufacturing an outdoor wood the pressure sensitive liquid adhesive 120 is a crosslinking vinyl acetate, wherein the crosslinking vinyl acetate has a solid content of about 52%.

In another embodiment of the third method 400 the pressure sensitive liquid adhesive is a crosslinking vinyl acetate, wherein the crosslinking vinyl acetate has a solid content of about 46%.

In another embodiment of the third method 400, the pressure sensitive liquid adhesive is a polymerized polyurethane reactive adhesive.

In another embodiment of the third method 400, the pressure sensitive liquid adhesive is a polyurethane resin adhesive.

In the embodiment of the third method 400 the first wood species WP1 is any one of a common grade or general purpose grade of North American Softwood species, wherein the North American Softwood species is selected from the group consisting of (Thuja plicata), (Thuja occidentalis), Douglas Fir (Pseudotsuga menziesii), Western Larch (Larix occidentalis), Alpine Larch (Larix lyallii), Alaskan Yellow Ceda (Chamaecyparis nootkatensis), Hemlock (Tsuga heterophylla), Port of Oxford Cedar (Chamaecyparis lawsoniana), Redwood (Sequoia sempervirens), Pine/Spruce (Pinus species, Picea species).

Further, in the embodiment of the third method 400 the second wood species WP2 is any one of a superior grade North American Softwood species, wherein the North American Softwood species is selected from the group consisting of (Thuja plicata), (Thuja occidentalis), Douglas Fir (Pseudotsuga menziesii), Western Larch (Larix occidentalis), Alpine Larch (Larix lyallii), Alaskan Yellow Ceda (Chamaecyparis nootkatensis), Hemlock (Tsuga heterophylla), Port of Oxford Cedar (Chamaecyparis lawsoniana), Redwood (Sequoia sempervirens), Pine/Spruce (Pinus species, Picea species).

Further, in the embodiment of the third method 400 the third wood species of the facing wood veneer 50 is formed from a third wood species WP3, the third wood species including an exotic hardwood wood species, wherein the exotic hardwood species is selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp,); River Red Gum (Eucalyptus camaldulensis), Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

In yet another embodiment, of the disclosure, a fourth method 500 of Manufacturing an outdoor wood decking board 10 for use in the construction of an outdoor deck floor 100, is embodied. Reference is made to FIGS. 16A-16E. The fourth method 500 includes a first step 501 including providing a core 30 formed from a rigid solid substrate as a three dimensional solid rigid body, wherein the rigid solid substrate is a wood plastic composite 130 enabling and operable to form a wood plastic composite core 30, as shown in FIG. 16A.

The second step 502 includes configuring the wood plastic composite core 30 having a thickness (T¹) of about 1½ inches, a width (W¹) of about 5½ inches, and a length (L¹) of about 8.00-20.00 feet inclusive, the wood plastic composite core 30 including a first face 32, a second face 34 opposed to the first face 32, a first end 38, a second end 39, and opposite longitudinal side edges 36.

The third step 503 includes sizing the wood plastic composite core 30 through a planer or a moulder to a thickness (T³) of about 1⅜ inches, the width (W¹) of 5½ inches, and the length (L¹) of 8.00-20.00 feet inclusive, as shown in FIG. 16B.

The fourth step 504 includes providing a facing wood veneer 50, as shown in FIG. 16C, formed from a second wood species WP2 of superior grade clear grain North American Softwood species as a three dimensional solid rigid finishing layer, wherein the superior grade clear grain North American Softwood species is a clear grain western red cedar 14 enabling and operable to provide a clear grain western red cedar 14 facing wood veneer 50.

The fifth step 504 of the fourth method includes configuring the clear grain western red cedar facing wood veneer having a thickness (T²) of about ⅛ inch, the width (W¹) of about 5½ inches, and the length (L¹) of about 8.00-20.00 feet inclusive. The clear grain western red cedar 14 facing wood veneer 50 includes a first wood finishing face 52, a second wood finishing face 54 opposed to the first wood finishing face 52, a first finishing end 58, a second finishing end 59, and opposing longitudinal facing wood veneer side edges 56.

The sixth step 506 of the fourth method includes providing a pressure sensitive liquid adhesive 120.

The seventh step 507 of the fourth method 500 includes spreading the pressure sensitive liquid adhesive 120 through an adhesive spreading machine such that the pressure sensitive liquid adhesive covers the entire first face 32 of the wood plastic composite core 30.

The eighth step 508 of the fourth method 500 includes overlaying the second finishing face 54 of the clear grain western red cedar 14 facing wood veneer 50 against the first face 32 of the wood plastic composite core 30. The ninth step 509 includes laminating the clear grain western red cedar 14 facing wood veneer 50 against the wood plastic composite 30 through an automated hydraulic press under heat and pressure for providing a visually seamless permanent attachment of the clear grain western red cedar wood 14 facing wood veneer 50 against the wood plastic composite core 30 forming a clear grain western red cedar 14 veneered wood plastic composite core 30 such that the first wood finishing face 52 of the clear grain western red cedar 14 facing wood veneer 50 is displayed to a viewer, thereby, a plurality of wood decking boards 10 adapted to be arranged along interior longitudinal side edges 36 of each other form an assembled simulated non-cactile clear grain western red cedar 14 outdoor deck floor 100 of pre-configured dimensions wherein the clear grain western red cedar 14 veneered wood plastic composite core 30 is configured including the thickness (T¹) of about 1½ inches, the width (W¹) of about 5½ inches; and the length (L¹) of about 8.00 feet-20.00 feet inclusive.

The tenth step 510 of the fourth method 500 includes removing the clear grain western red cedar 14 veneered wood plastic composite core 30 from the automated hydraulic press.

The eleventh step 511 includes cooling the clear grain western red cedar 14 veneered wood plastic composite core 30 at ambient temperature. The twelfth step 512 includes sizing the clear grain western red cedar 14 veneered plastic wood core 30 through the planer or moulder to form the outdoor wood decking board 10, as shown in FIG. 16E configured including the thickness (T¹) of about 1½ inches, a width (W²) of about 5¼ inches, and the length (L¹) of about 8.00-20.00 feet.

In an embodiment of the disclosure, of the fourth method 500 the pressure sensitive liquid adhesive 120 is a polyvinyacetate.

In another embodiment, of the fourth method 500 the pressure sensitive liquid adhesive 120 is a melamine resin adhesive including a liquid hardener.

In another embodiment of the fourth method 500 the pressure sensitive liquid adhesive 120 is a crosslinking vinyl acetate, wherein the crosslinking vinyl acetate has a solid content of about 52%.

In another embodiment, of the fourth method 500 the pressure sensitive liquid adhesive 500 is a crosslinking vinyl acetate, wherein the crosslinking vinyl acetate has a solid content of about 46%.

In another embodiment, of the fourth method 500 the pressure sensitive liquid adhesive 500 is a polymerized polyurethane reactive adhesive.

In another embodiment, of the fourth method 500, the pressure sensitive liquid adhesive 120 is a polyurethane resin adhesive.

In an embodiment of the fourth method 500, the second wood species of which the facing wood veneer 50 is formed is any one of a superior grade North American

Softwood species, wherein the North American Softwood species is selected from the group consisting of (Thuja plicata), (Thuja occidentalis), Douglas Fir (Pseudotsuga menziesii), Western Larch (Larix occidentalis), Alpine Larch (Larix lyallii), Alaskan Yellow Ceda (Chamaecyparis nootkatensis), Hemlock (Tsuga heterophylla), Port of Oxford Cedar (Chamaecyparis lawsoniana), Redwood (Sequoia sempervirens), Pine/Spruce (Pinus species, Picea species).

In another embodiment, of the fourth method 500 of manufacturing an outdoor wood decking board 10 for use in the construction of the outdoor deck floor 100, the facing wood veneer 50 is formed from a third wood species, the third wood species including an exotic hardwood wood species, wherein the exotic hardwood species is selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp,); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

While various embodiments have been described above, it should be understood that they have been presented by way of example only, and not limitation. Where schematics and/or embodiments described above indicate certain components arranged in certain orientation or positions, the arrangement of components may be modified. While the embodiments have been particularly shown and described, it will be understood that various changes in form and details may be made. Although various embodiments have been described as having particular features and/or combinations of components, other embodiments are possible having a combination of any features and/or components from any of embodiments as discussed above. Furthermore, any portion of the apparatus and/or methods described herein may be combined in any combination, except mutually exclusive combinations. While certain embodiments have been described in detail above, it should be understood that various embodiments can share common features and such description applies equally to such features between embodiments. The embodiments, described herein can include various combination and/or sub-combinations or the functions, components, and/or features of the different embodiments described. The Drawings disclosed herein are not drawn to scale.

Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially, as described above.

What is claimed is:

1. An outdoor wood decking board for use in construction of an outdoor deck floor, the outdoor wood decking board, comprising:
a wood core, formed from a first wood species, as a three dimensional solid rigid wood body including a thickness (T¹), a width (W¹), and a length (L¹), the wood core including a first wood face, a second wood face opposed to the first wood face, and dual opposite longitudinal wood side edges, wherein the first wood species is preselected from any one of a common grade North American Softwood species to form a common grade North American Softwood wood core;
wherein the wood core is sized via a planer or a moulder to a configuration including a thickness of (T⁵) which is equal to (T¹)−⅛ inch);
wherein the wood core is dried to a moisture content suitable for receiving a pressure sensitive liquid adhesive;
a facing wood veneer, formed from a second wood species, as a three dimensional solid rigid wood finishing layer including a thickness (T²) where (T²) is equal to ⅛ inch, the width (W¹), and the length (L¹), the facing wood veneer including a first wood finishing face, a second wood finishing face opposed to the first wood finishing face, and dual opposing longitudinal facing wood veneer side edges, wherein the second wood species is preselected from any one of a superior grade clear grain of North American Softwood species free from growth characteristics that affect appearance or performance to form a superior grade clear grain North American Softwood facing wood veneer; and
the pressure sensitive liquid adhesive applied to the first wood face of the wood core via an adhesive spreading machine enabling and operable for providing a seamless permanent attachment of the second wood finishing face of the facing wood veneer against the first wood face of the wood core forming a facing wood veneered wood core including a superior grade clear grain North American Softwood facing wood veneered common grade North American Softwood wood core, wherein the facing wood veneered wood core includes the first wood finishing face of the facing wood veneer displayed to a viewer, thereby, a plurality of wood decking boards adapted to be arranged along interior longitudinal wood side edges of each other form an assembled simulated non-cactile superior grade clear grain North American Softwood outdoor deck floor of pre-configured dimensions.

2. The outdoor wood decking board for use in construction of the outdoor deck floor, according to claim 1, wherein the first wood species is any one of the common grade North American Softwood species, wherein the common grade North American Softwood species is selected from the group consisting of tight knot Western Red Cedar (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

3. The outdoor wood decking board for use in construction of the outdoor deck floor, according to claim 1, wherein the facing wood veneer is formed from any one of the superior grade clear grain North American Softwood species, wherein the superior grade clear grain North American Softwood species is selected from the group consisting of Western Red Cedar (Thuja plicata), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

4. The outdoor wood decking board for use in construction of the outdoor deck floor, according to claim 1, wherein the facing wood veneer is formed from any one of an exotic hardwood species, wherein the exotic hardwood species selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

5. The outdoor wood decking board for use in construction of the outdoor deck floor, according to claim 1, wherein the wood core is formed from a wood plastic composite.

6. The outdoor wood decking board for use in construction of the outdoor deck floor, according to claim 1, wherein the wood core is formed from a cement board.

7. The outdoor wood decking board for use in construction of the outdoor deck floor, according to claim 1, further comprising: the wood core is formed from a tight knot western red cedar wood species; and
the facing wood veneer is formed from a clear vertical grain western red cedar species.

8. The outdoor wood decking board for use in construction of the outdoor deck floor, according to claim 1, further comprising: a second facing wood veneer permanently seamlessly attached to the second wood face of the wood core via the pressure sensitive liquid adhesive enabling and operable to form a dual facing wood veneered wood core.

9. The outdoor wood decking board for use in the construction of the outdoor deck floor, according to claim 1, wherein the thickness (T²) of the facing wood veneer can be configured including the thickness (T²) selected from the group comprising, 1/16, ⅛, 3/16.

10. The outdoor wood decking board for use in construction of the outdoor deck floor, according to claim 1, wherein the pressure sensitive liquid adhesive is a polyvinylacetate.

11. The outdoor wood decking board for use in construction of the outdoor deck floor, according to claim 1, wherein the pressure sensitive liquid adhesive is a melamine resin adhesive including a liquid hardener.

12. The outdoor wood decking board for use in construction of the outdoor deck floor, according to claim 1, wherein the pressure sensitive liquid adhesive is a crosslinking vinyl acetate, wherein the crosslinking vinyl acetate has a solid content of about 52% and a ph about 5.5-6.0.

13. The outdoor wood decking board for use in construction of the outdoor deck floor, according to claim 1, wherein the pressure sensitive liquid adhesive is a crosslinking vinyl acetate, wherein the crosslinking vinyl acetate has a solid content of about 46% and a ph about 4.5-5.5.

14. The outdoor wood decking board for use in construction of the outdoor deck floor, according to claim 1, wherein the pressure sensitive liquid adhesive is a polymerized polyurethane reactive adhesive.

15. The outdoor wood decking board for use in construction of the outdoor deck floor, according to claim 1, wherein the pressure sensitive liquid adhesive is a polyurethane resin adhesive.

16. The outdoor wood decking board use in construction of the outdoor deck floor, according to claim 1, wherein the facing wood veneer is a clear cedar including a quarter sawn vertical grain wood species,

17. The outdoor wood decking board for use in construction of the outdoor deck floor, according to claim 1, wherein:
the common grade North American Softwood wood core is configured including the thickness (T¹) of about 1½ inches, the width (W¹) of about 5½ inches, and the length (L) of about 8.00-20.00 feet inclusive thereof;
the common grade North American Softwood wood core is sized via the planer or moulder to a configuration including the thickness (T⁵) of about 1⅜ inches, the width (W¹) of about 5½ inches, and the length (L) of about 8.00-20.00 feet inclusive thereof;
the superior grade clear grain North American Softwood facing wood veneer is configured including the thickness (T²) of about ⅛ inch, the width (W¹) of about 5½ inches, and the length (L¹) of about 8.00-20.00 feet inclusive thereof;
the superior grade clear grain North American Softwood facing wood veneered common grade North American Softwood core is configured including the thickness (T¹) of about 1½ inches, the width (W) of about 5½ inches, and the length (L¹) of about 8.00-20.00 feet inclusive thereof; and
the superior grade clear grain North American Softwood facing wood veneered common grade North American Softwood core is sized to form the outdoor wood decking board via the planer or moulder to the thickness (T¹) of about 1½ inches, the width (W²) of about 5¼ inches, and the length (L¹) of about 8.00-20.00 feet inclusive.

18. The outdoor wood decking board for use in construction of the outdoor deck floor, according to claim 1, wherein:
the common grade North American Softwood wood core is configured including the thickness (T¹) of about 1½ inches, a width (W³) of about 3½ inches, and the length (L¹) of about 8.00-20.00 feet inclusive;
the common grade North American Softwood wood core is sized via a planer or moulder to a configuration including the thickness (T⁵) of about 1⅜ inches, the width (W³) of about 3½ inches, and the length (L¹) of about 8.00-20.00 feet inclusive;
the superior grade clear grain North American Softwood facing wood veneer is configured including the thickness (T²) of about ⅛ inch, the width (W³) of about 3½ inches, and the length (L¹) of about 8.00-20.00 feet inclusive;
the superior grade clear grain North American Softwood facing wood veneered common grade North American Softwood core is configured including the thickness (T¹) of about 1½ inches, the width (W³) of about 3½ inches, and the length (L¹) of about 8.00-20.00 feet inclusive thereof; and
the superior grade clear grain North American Softwood facing wood veneered common grade North American Softwood wood core is sized to form the outdoor wood decking board via the planer or moulder to a configuration including the thickness (T¹) of about 1½ inches, a width (W ⁴) of about 3¼ inches, and the length (L¹) of about 8.00-20.00 feet inclusive.

19. The outdoor wood decking board for use in construction of the outdoor deck floor, according to claim 1, wherein:
the common grade North American Softwood wood core is configured including a thickness (T⁴) of about 1⅛ inches, the width (W¹) of about 5½ inches, and the length (L¹) of about 8.00-20.00 feet inclusive;
the common grade North American Softwood wood core is sized via the planer or moulder to a configuration including a thickness (T⁶) of about 1.0 inch, the width (W¹) of about 5½ inches, and a length (L.¹) of about 8.00-20.00 feet inclusive;
the superior grade clear grain North American Softwood facing wood veneer is configured including the thickness (T²) of about ⅛ inch, the width (W¹) of about 5½ inches, and the length (L¹) of about 8.00-20.00 feet inclusive;
the superior grade clear grain North American Softwood facing wood veneered common grade North American Softwood core is configured including the thickness (T¹) of about 1½ inches, the width (W) of about 5½ inches, and the length (L¹) of about 8.00-20.00 feet inclusive thereof; and
the superior grade clear grain North American Softwood facing wood veneered common grade North American Softwood wood core is sized to form the outdoor wood decking board via the planer or moulder to a configuration including the thickness (T¹) of about 1½ inches, the width (W²) of about 5¼ inches, and the length (L¹) of about 8.00-20.00 feet inclusive thereof.

20. The outdoor wood decking board for use in construction of the outdoor deck floor, according to claim 1, wherein:
the common grade North American Softwood wood core is configured including a thickness (T⁴) of about 1⅛ inches, a width (W³) of about 3½ inches, and the length (L¹) of about 8.00-20.0 feet inclusive;
the common grade North American Softwood wood core is sized via the planer or moulder to a configuration including a thickness (T⁶) of about 1.00 inch, the width (W³) of about 3½ inches, and the length (L¹) of about 8.00-20.00 feet inclusive;
wherein the superior grade clear grain North American Softwood facing wood veneered common grade North American Softwood wood core is configured including the thickness (T²) of about ⅛ inch, the width (W³) of about 3½ inches, and the length (L¹) of about 8.00-20.00 feet inclusive; and
wherein the superior grade clear grain North American Softwood facing wood veneered common grade North American Softwood wood core is configured including thickness (T⁴) of about 1⅛ inches, a width (W³) of about 3½ inches, and the length (L¹) of about 8.00-20.0 feet inclusive; and
wherein the superior grade clear grain North American Softwood facing wood veneered common grade North American Softwood wood core is sized to form the outdoor wood decking board via the planer or moulder to a configuration including the thickness (T⁴) of about 1⅛ inches, a width (W⁴) of about 3¼ inches, and the length (L¹) of about 8.00-20.0 feet inclusive.

21. The outdoor wood decking board for use in construction of the outdoor deck floor, according to claim 1, wherein:
the common grade North American Softwood wood core is configured including the thickness (T¹) of about 1½ inches, a width (W⁵) of about 7¼ inches, and the length (L¹) of about 8.00-20.00 feet inclusive;
wherein the common grade North American Softwood wood core is sized via the planer or moulder to a configuration including the thickness (T⁵) of about 1⅜ inches, the width (W⁵) of about 7¼ inches, and the length (L¹) of about 8.00-20.00 feet inclusive;
wherein the superior grade clear grain North American Softwood facing wood veneer is configured including the thickness (T²) of about ⅛ inch, the width (W⁵) of about 7¼ inches, and the length (L¹) of about 8.00-20.00 feet inclusive;
wherein the superior grade clear grain North American Softwood facing wood veneered common grade North American Softwood wood core is configured including the thickness (T¹) of about 1½ inches, the width (W⁵) of about 7¼ inches, and the length (L¹) of about 8.00-20.00 feet inclusive; and
wherein the superior grade clear grain North American Softwood facing wood veneered common grade North American Softwood wood core is sized to form the outdoor wood decking board via the planer or moulder to a configuration including the thickness (T¹) of about 1½ inches, a width (W⁶) of about 7⅛ inches, and the length (L¹) of about 8.00-20.00 feet inclusive.

22. The outdoor wood decking board for use in the construction of the outdoor deck floor, according to claim 1, wherein:
the length (L¹) of the common grade North American Softwood wood core is selected from the group comprising the lengths (L¹) of 8.00 feet, 10.00 feet, 12.00 feet, 14.00 feet, 16.00 feet, 18.00 feet, and 20.00 feet; and
the length (L¹) of the superior grade clear grain North American Softwood facing wood veneer is selected from the group comprising the lengths (L¹) of 8.00 feet, 10.00 feet, 2.00 feet, 14.00 feet, 16.00 feet, 18.00 feet, and 20.00 feet;

23. The outdoor wood decking board for use in the construction of the outdoor deck floor, according to claim 1, wherein:
the length (L¹) of the common grade North American Softwood wood is selected from the group comprising the lengths (L¹) of 9.00 feet, 11.00 feet, 13.00 feet, 15.00 feet, 17.00 feet, and 19.00 feet; and
the length (L¹) of the superior grade clear grain North American Softwood facing wood veneer is selected from the group comprising the lengths (L¹) of 9.00 feet, 11.00 feet, 13.00 feet, 15.00 feet, 17.00 feet, and 19.00 feet.

24. An outdoor wood decking board for use in the construction of an outdoor deck floor, the outdoor wood decking board, comprising:
a first wood core formed from a first wood species as a three dimensional solid rigid wood body configured including a thickness (T³), a width (W¹), and a length (L¹), the first wood core including a first wood face¹, a second wood face¹ opposed to the first wood face¹, and dual opposite longitudinal wood side edges¹, wherein the first wood species is a tight knot western red cedar species to form a first tight knot western red cedar wood core;
a second wood core formed as a second three dimensional solid rigid wood body configured including the thickness (T³), the width (W¹), and the length (L¹), the second wood core including a first wood face², a second wood face²opposed to the first wood face², and dual opposite longitudinal wood side edges², wherein the second wood core is formed from the tight knot western red cedar species to form a second tight knot western red cedar wood core;
wherein the first wood core and the second wood core are each dried to a moisture content suitable for receiving a pressure sensitive liquid adhesive;
the pressure sensitive liquid adhesive applied to the second wood face² of the second wood core and the second wood face¹ of the first wood core via an adhesive spreading machine enabling and operable for providing a seamless permanent attachment of the first wood core to the second wood core forming a face-to-face wood core including a tight knot western red cedar face-to-face wood core having a thickness (T¹) when the first wood core and the second wood core are pressed against each other in an automated hydraulic press under heat and pressure;
wherein the tight knot western red cedar face-to-face wood core is sized via a planer or moulder to a thickness of (T⁵), such that (T⁵) is ⅛ inch less than (T¹);
a facing wood veneer formed from a second wood species as a three dimensional solid rigid wood finishing layer including a thickness (T²), the thickness (T²) being about ⅛ inch, the width (W¹), and the length (L¹), the facing wood veneer including a first wood finishing face, a second wood finishing face opposed to the first wood finishing face, and dual opposing longitudinal facing wood veneer side edges, wherein the second wood species is a clear vertical grain western red cedar to form a clear vertical grain western red cedar facing wood veneer;
the pressure sensitive liquid adhesive applied to the first wood face²of the first wood core of the face-to-face wood core via the adhesive spreading machine enabling and operable for providing a seamless permanent attachment of the second wood finishing face of the facing wood veneer against the first wood face of the first wood core of the face-to-face wood core forming a clear vertical grain western red cedar veneered tight knot western red cedar face-to-face wood core such that the first finishing face of the facing wood veneer including the clear vertical grain western red cedar is displayed to a viewer, thereby, a plurality of outdoor wood decking boards adapted to be arranged along interior longitudinal wood side edges of each other form an assembled simulated non-cactile clear vertical grain western red cedar species outdoor deck floor of pre-configured dimensions; and
wherein the clear vertical grain western red cedar veneered tight knot western red cedar face-to-face wood core is sized to form the outdoor wood decking board via the planer or moulder to a configuration including the thickness (T¹), a width (W²) wherein the width (W²) is inch less than width (W¹), and the length (L¹).

25. The outdoor wood decking board for use in construction of the outdoor deck floor, according to claim 24, wherein the pressure sensitive liquid adhesive is a polyvinylacetate.

26. The outdoor wood decking board for use in construction of the outdoor deck floor, according to claim 24, wherein the pressure sensitive liquid adhesive is a melamine resin adhesive including a liquid hardener.

27. The outdoor wood decking board for use in construction of the outdoor deck floor, according to claim 24, wherein the pressure sensitive liquid adhesive is a crosslinking vinyl acetate, wherein the crosslinking vinyl acetate has a solid content of about 52% and a ph about 5.5-6.0.

28. The outdoor wood decking board for use in construction of the outdoor deck floor, according to claim 24, wherein the pressure sensitive liquid adhesive is a crosslinking vinyl acetate, wherein the crosslinking vinyl acetate has a solid content of about 46% and a ph of about 4.5-5.5.

29. The outdoor wood decking board for use in construction of the outdoor deck floor, according to claim 24, wherein the pressure sensitive liquid adhesive is a polymerized polyurethane reactive adhesive.

30. The outdoor wood decking board for use in construction of the outdoor deck floor, according to claim 24, wherein the pressure sensitive liquid adhesive is a polyurethane resin adhesives.

31. The outdoor wood decking board for use in construction of the outdoor deck floor, according to claim 24, wherein the first wood core and the second wood core are each formed from any one of a common grade North American Softwood species, wherein the common grade North American Softwood species is selected from the group comprising of a Western Red Cedar (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

32. The outdoor wood decking board for use in construction of the outdoor deck floor, according to claim 24, wherein the facing wood veneer is formed from any one of a superior grade clear grain North American Softwood species, wherein the superior grade clear grain North American Softwood species is selected from the group comprising of Western Red Cedar (Thuja plicate), (Thuja occidentalis), Douglas Fir (Pseudotsuga menziesii), Western Larch (Larix occidentalis), Alpine Larch (Lasix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

33. The outdoor wood decking board for use in construction of the outdoor deck floor, according to claim 24, wherein the facing wood veneer is formed from any one of an exotic hardwood species, wherein the exotic hardwood species is selected from the group comprising of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia) Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandraphragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

34. The outdoor wood decking board for use in the construction of the outdoor deck floor, according to claim 24, wherein:
the first wood core is configured including the thickness (T³) of about ¾ inch, the width (W¹) of about 5½ inches, and the length (L¹) of about 8.00-20.00 feet;
the second wood core is configured including the thickness (T³) of about ¾ inch, the width (W¹) of about 5½ inches, and the length (L¹) of about 8.00-20.00 feet inclusive;
the tight knot western red cedar face-to-face wood core is configured including the thickness (T¹) of about 1½ inches, the width (W¹) of about 5½ inches, and the length (L¹) of about 8.00-20.00 feet inclusive;
the tight knot western red cedar face-to-face wood core is sized via the planer or moulder to the thickness of (T⁵) of about 1⅜ inches, the width (W¹) of about 5½ inches, and the length (L¹) of about 8.00-20.00 feet inclusive;
the clear vertical grain western red cedar facing wood veneer is configured including the thickness (T ²) of about ⅛ inch, the width (W ²) of about 5½ inches, and the length (L¹) of about 8.00-20.0 feet inclusive;
the clear vertical grain western red cedar veneered tight knot western red cedar face-to-face wood core is configured with the thickness (T¹) of about 1½ inches, the width (W¹) of about 5½ inches, and the length (L¹) of about 8.00-20.00 feet inclusive; and
the clear vertical grain western red cedar veneered tight knot western red cedar face-to-face wood core is sized via the planer or moulder to form the outdoor wood decking board to the thickness (T¹) of about 1½ inches, the width (W²) of about 5¼ inches, and the length (L¹) of about 8.00-20.00 feet inclusive.

35. The outdoor wood decking board for use in the construction of the outdoor deck floor, according to claim 24 wherein:
the first wood core is configured including the thickness (T³) of about ½ inch, a width (W³) of about 3½ inches, and the length (L¹) of about 8.00-20.00 feet inclusive;
the second wood core is configured including the thickness (T³) of about ¾ inch, the width (W³) of about 3½ inches, and the length (L¹) of about 8.00 feet-20.00 feet inclusive;
the face-to-face wood core is configured including the thickness (T¹) of about 1½ inches, the width (W³) of about 3½ inches, and the length (L¹) of about 8.00-20.00 feet inclusive;
the tight knot western red cedar face-to-face wood core is sized via the planer or moulder to a thickness (T⁵) of about 1⅜ inches, the width (W³) of about 3½ inches, and the length (L¹) of about 8.00-20.0 feet inclusive;
the clear vertical grain western red cedar facing wood veneer is configured including the thickness (T ²) of about ⅛ inch, the width (W³) of about 3½ inches, and the length (L¹) of about 8.00-20.00 feet inclusive;
the clear vertical grain western red cedar veneered tight knot western red cedar face-to-face wood core is configured with the thickness (T¹) of about 1½ inches, the width (W³) of about 3½ inches, and the length (L¹) of about 8.00-20.00 feet; and
the clear vertical grain western red cedar veneered tight knot western red cedar face-to-face wood core is sized via the planer or moulder to form the outdoor wood decking boar to the thickness (T¹) of about 1½ inches, a width (W⁴) of about 3¼ inches, and the length (L¹) of about 8.00-20.00 feet inclusive.

36. The outdoor wood decking board for use in the construction of the outdoor deck floor, according to claim 24 wherein:
the first wood core is configured including the thickness (T³) of about ¾ inch, a width (W⁵) of about 7 ¹/4 inches, and the length (L ¹) of about 8.00-20.0 feet inclusive;
the second wood core is configured including the thickness (T³) of about ¾ inch, the width (W⁵) of about 7¼ inches, and the length (L¹) of about 8.00-20.00 feet inclusive;
the tight knot western red cedar face-to-face wood core is configured including the thickness (T¹) of about 1½ inches; the width (W⁵) of about 7¼ inches, and the length (L¹) of about 8.00-20.00 feet inclusive;
the tight knot western red cedar face-to-face wood core is sized via the planer or moulder to the thickness of (T⁵) of about 1⅜ inches, the width (W⁵) of about 7¼ inches, and the length (L¹) of about 8.00-20.00 feet inclusive;
the clear vertical grain western red cedar facing wood veneer is configured including the thickness (T²) of about ⅛ inch, the width (W⁵) of about 7¼ inches, and the length (L¹) of about 8.00-20.00 feet inclusive;
the clear vertical grain western red cedar veneered tight knot western red cedar face-to-face wood core is configured with the thickness (T¹) of about 1½ inches, the width (W⁵) of about 7¼ inches, and the length (L¹) of about 8.00-20.00 feet inclusive; and
the clear vertical grain western red cedar veneered tight knot western red cedar face-to-face wood core is sized to form the outdoor wood decking board via the planer or moulder to the thickness (T¹) of about 1½ inches, a width (W⁶) of about 7⅛ inches, and the length (L¹) of about 8.00-20.00 feet inclusive.

37. The outdoor wood decking board for use in the construction of the outdoor deck floor, according to claim 24, wherein the clear vertical grain western red cedar veneered tight knot western red cedar face-to-face wood core is treated with one or more aqueous compositions comprising one or more agents, wherein an agent of the one or more agents is selected from the group consisting of biocides, wood strength enhancers, fungicides, bactericides, insecticides water repellants, UV blockers, fire retardants, and wood hardeners.

38. An outdoor wood decking board for use in the construction of an outdoor deck floor, the wood decking board, comprising:
a wood core formed from a first wood species as a three dimensional solid rigid wood body including a thickness (T¹) of about 1½ inch, a width (W¹) of about 5½ inches, and a length (L¹) of about 8.00-20.00 feet inclusive, the wood core including a first wood face, a second wood face opposed to the first wood face, and dual opposite longitudinal wood side edges, wherein the first wood core is a tight knot western red cedar wood core;
wherein the tight knot western red cedar wood core is sized via a planer or a moulder to a thickness (T⁵) of about 1⅜ inches, the width (W¹) of about 5½ inches, and the length (L¹) of about 8.00-20.00 feet inclusive;
wherein the tight knot western red cedar wood core is dried to a moisture content suitable for receiving a pressure sensitive liquid adhesive;
a first facing wood veneer formed from a second wood species as a three dimensional solid rigid finishing wood layer including a thickness (T²) of about ⅛ inch, the width (W¹) of about 5½ inches, and the length (L¹) of about 8.00-20.00 feet inclusive, the first facing wood veneer including a first wood finishing face¹, a second wood finishing face¹ opposed to the first wood finishing face¹, and dual opposing longitudinal facing wood veneer side edges¹, wherein the second wood species includes a first exotic hardwood species selected to form an exotic hardwood facing wood veneer;
a second facing wood veneer, formed from a second exotic hardwood species of the second wood species selected to form an exotic hardwood facing wood veneer as a three dimensional solid rigid wood finishing layer including the thickness (T²) of about ⅛ inch, the width (W¹) of about 5½ inches, and the length (L¹) of about 8.00-20.00 feet inclusive, the second facing wood veneer including a first wood finishing face², a second wood finishing face² opposed to the first wood finishing face², and dual opposing longitudinal facing wood veneer side edges², wherein second exotic hardwood species is not the same as the first exotic hardwood species of the first facing wood veneer;
the pressure sensitive liquid adhesive applied to the first wood face of the wood core via an adhesive spreading machine enabling and operable for providing a seamless permanent attachment of the second wood finishing face¹ of the first facing wood veneer against the first wood face of the wood core forming an upper exotic hardwood veneered tight knot western red cedar wood core such that the first wood finishing face¹ of the first facing wood veneer including the first exotic hardwood species is displayed to the viewer, such that a plurality of wood decking boards adapted to be arranged along interior longitudinal wood side edges of each other form an upper assembled simulated non-cactile exotic hardwood deck floor formed of pre-configured dimensions; and
the pressure sensitive liquid adhesive applied via the adhesive spreading machine to the second wood face of the wood core enabling and operable for providing a seamless permanent attachment of the second wood finishing face² of the second facing wood veneer against the second wood face of the wood core forming a lower exotic hardwood veneered tight knot western red cedar wood core such that the first wood finishing face² of the second facing wood veneer including the second exotic hardwood species forms a lower assembled simulated non-cactile exotic hardwood species deck floor of preconfigured dimensions and being displayed to the viewer from below the upper assembled simulated non-cactile exotic hardwood species deck floor of preconfigured dimensions enabling and operable to provide a simulated outdoor wood ceiling; and
wherein a dual veneered wood core including the upper exotic hardwood veneered tight knot western red cedar wood core and the lower exotic hardwood veneered tight knot western red cedar wood core includes the thickness (T¹) of about 1½ inches, a width (W¹) of about 5½ inches, and the length (L¹) of about 8.00-20.00 feet inclusive; and
wherein the dual veneered wood core including the upper exotic hardwood veneered tight knot western red cedar wood core and the lower exotic hardwood veneered tight knot western red cedar wood core veneer is sized via the planer or moulder to form the outdoor wood decking board configured to include the thickness (T¹) of about 1½ inches, a width (W²) of about 5¼ inches, and the length (L¹) of about 8.00-20.00 feet inclusive.

39. The outdoor wood decking board for use in construction of the outdoor deck floor, according to claim 38, wherein the pressure sensitive liquid adhesive is a polyvinylacetate.

40. The outdoor wood decking board for use in construction of the outdoor deck floor, according to claim 38, wherein the pressure sensitive liquid adhesive is a melamine resin adhesive including a liquid hardener.

41. The outdoor wood decking board for use in construction of the outdoor deck floor, according to claim 38, wherein the pressure sensitive liquid adhesive is a crosslinking vinyl acetate, wherein the crosslinking vinyl acetate has a solid content of about 52% and a ph about 5.5-6.0.

42. The outdoor wood decking board for use in construction of the outdoor deck floor, according to claim 38, wherein the pressure sensitive liquid adhesive is a crosslinking vinyl acetate, wherein the crosslinking vinyl acetate has a solid content of about 46% and a ph of about 4.5-5.5.

43. The outdoor wood decking board for use in construction of the outdoor deck floor, according to claim 38, wherein the pressure sensitive liquid adhesive is a polymerized polyurethane reactive adhesive.

44. The outdoor wood decking board for use in construction of the outdoor deck floor, according to claim 38, wherein the pressure sensitive liquid adhesive is a polyurethane resin adhesives.

45. The wood decking board for use in the construction of the outdoor deck floor, according to claim 38, wherein the first facing wood veneer and the second facing wood veneer are each formed from an exotic hardwood species, wherein the exotic hardwood species selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

46. The wood decking board for use in the construction of the outdoor deck floor, according to claim 38 claim 45, wherein the first facing wood veneer and the second facing wood veneer are each formed from the same exotic hard wood species.

47. The wood decking board for use in the construction of the outdoor deck floor, according to claim 38, wherein:
the wood core can be formed from any one of a common grade or a general purpose grade North American Softwood species selected from the group consisting of Western Red Cedar (Thuja plicata), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species); and
the first facing wood veneer and the second facing wood veneer each can be formed from any one of a superior clear grade North American Softwood species, wherein the superior grade North American Softwood species is selected from the group consisting of Western Red Cedar (Thuja plicate), (Thuja occidentalis), Douglas Fir (Pseudotsuga menziesii), Western Larch (Larix occidentalis), Alpine Larch (Larix lyallii), clear vertical grain Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species)

48. A wood decking board for use in the construction of an outdoor deck floor, the wood decking board, comprising:
a complex wood core assembly, the complex wood core assembly, comprising:
a series of wood cores, each wood core of the series of wood cores is embodied in a separate individual three dimensional solid rigid wood body formed from a first wood species, each wood core including a thickness (T³) of about ¾ inch, a width (W¹) of about 5½ inches, and a length (L¹) of about 8.00-20.00 feet inclusive, wherein each wood core includes a first wood face, a second wood face opposed to the first wood face, a first end, a second end, and dual opposite longitudinal wood side edges;
wherein the first wood species is a tight knot western red cedar wood species enabling and operable to form a series of tight knot western red cedar wood cores;
a protract wood core, wherein the protract wood core is embodied in a separate individual three dimensional solid rigid wood body configured including a thickness (T⁸) of about ½ inch, the width (W¹) of about 5½ inches, and the length (L¹) of about 8.00-20.00 feet inclusive, wherein the protract wood core includes a first wood face¹, a second wood face¹ opposed to the first wood face¹, and dual opposite longitudinal wood side edges¹;
wherein the protract wood core is formed from the first wood species to form a tight knot western red cedar protract wood core;
wherein the protract wood core is centrally positioned within the series of wood cores;
wherein each of the wood cores including the protract wood core is dried to a moisture content for receiving a pressure sensitive liquid adhesive;
wherein each of the wood cores of the series of wood cores including the protract wood core is seamlessly permanently attached together against interior wood faces arranged horizontally adjacent to each other via a pressure sensitive liquid adhesive to form a complex wood core assembly block;
the complex wood core assembly block formed as a single three dimensional solid rigid wood body including a first complex wood face and a second complex wood face opposite to the first complex wood face, a first end, a second end, and complex opposite longitudinal wood side edges including a thickness (T⁷) of about 5¾ inches, the width (W¹) of about 5½ inches, and the length (L¹) of about 8.00-20.00 feet;
wherein the complex wood core assembly block is cut via a cutting machine to form a plurality of complex wood core assemblies each of the complex wood core assemblies of the plurality of the complex wood core assemblies having the first complex wood face and the second complex wood face opposite the first complex wood face and the complex opposite longitudinal wood side edges;
wherein each of a complex wood core assembly of the plurality of complex wood core assemblies is configured including a thickness (T¹) of about 1½ inches, a width (W⁹) of about 5¾ inches, and the length (L¹) of about 8.00-20.00 feet inclusive;
wherein each of the complex wood core assembly of the plurality of complex wood core assemblies is sized via a planer or moulder to a thickness (T⁵) of about 1⅜ inches, the width (W¹) of 5½ inches, and the length (L¹) of about 8.00-20.00 feet inclusive;
a facing wood veneer, formed from a third wood species, as a three dimensional solid rigid finishing layer including a first wood finishing face, a second wood finishing face opposed to the first wood finishing face, and dual opposing longitudinal facing wood veneer side edges including a thickness (T²) of about ⅛ inch, the width (W¹) of about 5½ inches, and the length (L¹) of about 8.00-20.00 feet inclusive:
wherein the third wood species is an exotic hardwood wood species including a Massaranduba (Manilkara bidentate) thereby forming a Massaranduba facing wood veneer;
a pressure sensitive liquid adhesive applied to the first complex wood face enabling and operable for providing a seamless permanent attachment of the second wood finishing face of the facing wood veneer against the first complex wood face to form a Massaranduba veneered tight knot western red cedar complex wood core assembly configured including the thickness (T¹) of about 1½ inches; the width (W¹) of about 5½ inches, and a length (L¹) of about 8.00-20.00 feet inclusive;
wherein the Massaranduba veneered tight knot western red cedar complex wood core assembly is sized via the planer or moulder to form the outdoor wood decking board configured including the thickness (T¹) of about 1½ inches, a width (W²) of about 5¼ inches, and the length (L¹) of about 8.00-20.00 feet inclusive; and
wherein the Massaranduba veneered tight knot western red cedar complex wood core assembly includes the first wood finishing face of the facing wood veneer displayed to a viewer, thereby, a plurality of outdoor wood decking boards adapted to be arranged along interior longitudinal wood side edges of each other form an assembled simulated non-cactile Massaranduba outdoor deck floor of pre-configured dimensions.

49. The wood decking board for use in the construction of the outdoor deck floor, according to claim 48, wherein:
the first wood species is any one of a common grade or general purpose grade North American Softwood species, wherein the common grade or general purpose grade North American Softwood species is selected from the group consisting of western red cedar, (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species); and
the facing wood veneer is formed from a second wood species, the second wood species is any one of a superior grade clear grain North American Softwood species, wherein the superior grade clear grain North American Softwood species is selected from the group consisting of (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

50. The outdoor wood decking board for use in construction of the outdoor deck, according to claim 48, wherein the third wood species of the facing wood veneer is formed from an exotic hardwood wood species, wherein the exotic hardwood species is selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentate); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

51. The outdoor wood decking board for use in construction of the outdoor deck, according to claim 48, wherein the pressure sensitive liquid adhesive is a polyvinylacetate.

52. The outdoor wood decking board for use in construction of the outdoor deck floor, according to claim 48, wherein the pressure sensitive liquid adhesive is a melamine resin adhesive including a liquid hardener.

53. The outdoor wood decking board for use in construction of the outdoor deck floor, according to claim 48, wherein the pressure sensitive liquid adhesive is a crosslinking vinyl acetate, wherein the crosslinking vinyl acetate has a solid content of about 52% and a ph about 5.5-6.0.

54. The outdoor wood decking board for use in construction of the outdoor deck floor, according to claim 48, wherein the pressure sensitive liquid adhesive is a crosslinking vinyl acetate, wherein the crosslinking vinyl acetate has a solid content of about 46% and a ph of about 4.5-5.5

55. The outdoor wood decking board for use in construction of the outdoor deck floor, according to claim 48, wherein the pressure sensitive liquid adhesive is a polymerized polyurethane reactive adhesive.

56. The outdoor wood decking board for use in construction of the outdoor deck floor, according to claim 48, wherein the pressure sensitive liquid adhesive is a polyurethane resin adhesives.

57. An outdoor wood decking board for use in construction of an outdoor deck floor, the outdoor wood decking board, comprising:
a core, formed from a rigid solid substrate, as a three dimensional solid rigid body including a thickness (T¹), a width (W¹), and a length (L¹), the core including a first face, a second face opposed to the first face, a first end and a second end, and dual opposite longitudinal wood side edges;
wherein the rigid solid substrate is a wood plastic composite enabling and operable to form a wood plastic composite core;
wherein the wood plastic composite core is sized via a planer or a moulder to a configuration including a thickness of (T⁵) which is equal to ((T¹)−⅛ inch);
a facing wood veneer, formed from a superior grade wood species, as a three dimensional solid rigid wood finishing layer including a thickness (T²) where (T²) is equal to ⅛ inch, the width (W¹), and the length (L¹), the facing wood veneer including a first wood finishing face, a second wood finishing face opposed to the first wood finishing face, a first finishing end, a second finishing end, and dual opposing longitudinal facing wood veneer side edges;
wherein the superior grade wood species is a superior grade clear grain North American Softwood species, wherein the superior grade clear grain North American Softwood species is selected from the group comprising of Western red cedar, (Thuja plicate), (Thuja occidentalis), Douglas Fir (Pseudotsuga menziesii), Western Larch (Larix occidentalis), Alpine Larch (Larix lyallii), Alaskan Yellow Cedar(Chamaecyparis nootkatensis), clear grain Hemlock (Tsuga heterophylla), Port of Oxford Cedar (Chamaecyparis lawsoniana), Redwood (Sequoia sempervirens), and Pine/Spruce (Pinus species, Picea species);
a pressure sensitive liquid adhesive applied to the first face of the wood plastic composite core enabling and operable for providing a seamless permanent attachment of the second wood finishing face of the facing wood veneer against the first face of the wood plastic composite core forming a facing wood veneered wood plastic composite core, wherein the facing wood veneered wood plastic composite core includes the first wood finishing face of the facing wood veneer displayed to a viewer, thereby, a plurality of wood decking boards adapted to be arranged along interior longitudinal side edges of each other form an assembled simulated non-cactile superior grade clear grain North American Softwood veneered outdoor deck floor of pre-configured dimensions; and
wherein the facing wood veneered wood plastic composite core is sized via a planer or moulder to form the wood decking board configured including the thickness of (T¹), a width of (W²) which is about ¼ inch less than the width (W¹), and the length (L¹).

58. The outdoor wood decking board for use in the construction of the outdoor deck floor, according to claim 57, wherein the rigid solid substrate is a cement board.

59. The outdoor wood decking board for use in construction of the outdoor deck floor, according to claim 57, wherein the facing wood veneer can be formed from an exotic hardwood wood species, wherein the exotic hardwood species is selected from the group comprising of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

60. The outdoor wood decking board for use in construction of the outdoor deck floor, according to claim 57, wherein:
the wood plastic composite core is configured including the thickness (T¹) of about 1½ inches, the width (W¹) of about 5½ inches, and the length (L¹) of about 8.00-20.00 feet inclusive thereof;
the wood plastic composite core is sized via the planer or moulder to a configuration including a thickness (T⁵) of about 1⅜ inches, the width (W¹) of about 5½ inches, and the length (L¹) of about 8.00-20.00 feet inclusive thereof;
the facing wood veneer is configured including the thickness (T²) of about ⅛ inch, the width (W¹) of about 5½ inches, and the length (L¹) of about 8.00-20.00 feet inclusive thereof;
the facing wood veneered wood plastic composite core is configured including the thickness (T¹) of about 1½ inches, the width (W¹) of about 5½ inches, and the length (L¹) of about 8.00-20.00 feet inclusive thereof; and
the facing wood veneered wood plastic composite is sized to form the wood decking board via the planer or moulder to the thickness (T¹) of about 1½ inches, the width (W²) of about 5¼ inches, and the length (L¹) of about 8.00-20.00 feet inclusive thereof.

61. The outdoor wood decking board for use in construction of the outdoor deck floor, according to claim 57, wherein:
the wood plastic composite core is configured including the thickness (T¹) of about 1½ inches, a width (W³) of about 3½ inches, and the length (L¹) of about 8.00-20.00 feet inclusive;
the wood plastic composite core is sized via the planer or moulder to a configuration including the thickness (T⁵) of about 1⅜ inches, a width (W³) of about 3½ inches, and the length (L¹) of about 8.00-20.00 feet inclusive;
the facing wood veneer is configured including the thickness (T²) of about ⅛ inch, the width (W³) of about 3½ inches, and the length (L¹) of about 8.00-20.00 feet;
the facing wood veneered wood plastic composite core is configured including the thickness (T¹) of about 1½ inches, a width (W³) of about 3½ inches, and the length (L¹) of about 8.00-20.00 feet inclusive; and
the facing wood veneered wood plastic composite core is sized to form the outdoor wood decking board via the planer or moulder to a configuration including the thickness (T¹) of about 1½ inches, a width (W⁴) of about 3¼ inches, and the length (L¹) of about 8.00-20.00 feet inclusive.

62. The outdoor wood decking board for use in construction of the outdoor deck floor, according to claim 57, wherein:
the core is configured including a thickness (T⁴) of about 1⅛ inches, the width (W¹) of about 5½ inches, and the length (L¹) of about 8.00-20.00 feet inclusive;
the wood plastic composite core is sized via the planer or moulder to a configuration including a thickness (T⁶) of about 1.0 inch, the width (W¹) of about 5½ inches, and a length (L¹) of about 8.00-20.00 feet inclusive;
the facing wood veneer is configured including the thickness (T²) of about ⅛ inch, the width (W¹) of about 5½ inches, and the length (L¹) of about 8.00-20.00 feet inclusive;
the facing wood veneered wood plastic composite core is configured including the thickness (T⁴) of about 1⅛ inches, the width (W¹) of about 5½ inches, and the length (L¹) of about 8.00-20.00 feet inclusive; and
the facing wood veneered wood plastic composite core is sized to form the outdoor wood decking board via the planer or moulder to a configuration including the thickness (T⁴) of about 1⅛ inches, the width (W²) of about 5¼ inches, and the length (L¹) of about 8.00-20.00 feet inclusive,

63. The outdoor wood decking board for use in construction of the outdoor deck floor, according to claim 57, wherein:
the wood plastic composite core is configured including a thickness (T⁴) of about 1⅛ inches, a width (W³) of about 3½ inches, and the length (L¹) of about 8.00-20.00 feet inclusive;
the wood plastic composite core is sized via the planer or moulder to a configuration including a thickness (T⁶) of about 1.0 inch, the width (W³) of about 3½ inches, and the length (L¹) of about 8.00-20.00 feet inclusive;
the facing wood veneer is configured including the thickness (T²) of about ⅛ inch, the width (W³) of about 3½ inches, and the length (L¹) of about 8.00-20.00 feet inclusive;
the facing wood veneered wood plastic composite configured including the thickness (T⁴) of about 1⅛ inches, the width (W³) of about 3½ inches, and the length (L¹) of about 8.00-20.00 feet inclusive; and
the facing wood veneered wood plastic composited core is sized to form the outdoor wood decking board via the planer or moulder to a configuration including the thickness (T⁴) of about 1⅛ inches, the width (W ⁴) of about 3¼ inches, and the length (L¹) of about 8.00-20.00 feet inclusive.

64. The outdoor wood decking board for use in construction of the outdoor deck floor, according to claim 57, wherein:
the wood plastic composite core is configured including the thickness (T¹) of about 1½ inches, a width (W⁵) of about 7¼ inches, and the length (L¹) of about 8.00-20.00 feet inclusive;
the wood plastic composite core is sized via the planer or moulder to a configuration including the thickness (T⁵) of about 1⅜ inches, the width (W⁵) of about 7¼ inches, and the length (L¹) of about 8.00-20.00 feet inclusive;
wherein the facing wood veneer is configured including the thickness (T²) of about ⅛ inch, the width (W⁵) of about 7¼ inches, and the length (L¹) of about 8.00-20.00 feet inclusive;
the facing wood veneered wood plastic composite core is configured including the thickness (T¹) of about 1½ inches, a width (W⁵) of about 7¼ inches, and the length (L¹) of about 8.00-20.00 feet inclusive; and
the facing wood veneered wood plastic composite core is sized to form the outdoor wood decking board via the planer or moulder to a configuration including the thickness (T¹) of about 1½ inches, a width (W⁶) of about 7⅛ inches, and the length (L¹) of about 8.00-20.00 feet inclusive.

65. An outdoor wood decking board for use in the construction of an outdoor deck floor, the outdoor wood decking board, comprising:
a first wood core formed from a first wood species as a three dimensional solid rigid wood body configured having a thickness (T³), a width (W¹), and a length (L¹), the first wood core including a first face¹, a second face¹ opposed to the first face¹, and dual opposite longitudinal wood side edges¹:
a second wood core formed from the first wood species as a second three dimensional solid rigid wood body configured having the thickness (T³), the width (W¹), and the length (L¹), the second wood core including a first face², a second face² opposed to the first face², and dual opposite longitudinal wood side edges²:
wherein the first wood species is any one of a common grade or general purpose grade North American Softwood species, wherein the North American Softwood species is selected from the group consisting of Western Red Cedar (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species);
a pressure sensitive liquid adhesive applied to the first face² of the second wood core and the second face¹ of the first wood core via an adhesive spreading machine enabling and operable for providing a seamless permanent attachment of the first wood core to the second wood core forming a face-to-face wood core having a thickness (T¹) when the first wood core and the second wood core are pressed against each other in an automated hydraulic press under heat and pressure;
wherein the face-to-face wood core is sized via a planer or moulder to a thickness of (T⁵), such that (T⁵) is ⅛ inch less than (T¹);
a facing wood veneer formed from a second wood species as a three dimensional solid rigid wood finishing layer including a thickness (T²), the thickness (T²) being about ⅛ inch, the width (W), and the length (L¹), the facing wood veneer including a first wood finishing face, a second wood finishing face opposed to the first wood finishing face, and dual opposing longitudinal facing wood veneer side edges;
wherein the second wood species is any one of a superior grade clear grain North American Softwood species, the North American Softwood species is selected from the group consisting of Western Red Cedar (Thuja plicata), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species);
the pressure sensitive liquid adhesive applied to the first face^{t} of the first wood core of the face-to-face wood core via an adhesive spreading machine enabling and operable for providing a seamless permanent attachment of the second wood finishing face of the facing wood veneer against the first face of the first wood core of the face-to-face wood core forming a facing wood veneered face-to-face wood core including a superior grade clear grain North American Softwood facing wood veneered common grade North American Softwood face-to-face wood core such that the first finishing face of the facing wood veneer including the superior grade clear grain facing wood is displayed to a viewer, thereby, a plurality of wood decking boards adapted to be arranged along interior longitudinal wood side edges of each other form an assembled simulated non-cactile superior grade clear grain North American Softwood outdoor deck floor of pre-configured dimensions;
wherein the superior grade clear grain North American Softwood veneered common grade North American Softwood face-to-face wood core includes the thickness (T³), a width (W¹), and a length (L¹); and
wherein the superior grade clear grain North American Softwood veneered common grade North American Softwood face-to-face wood core is sized via the planer or moulder to form the outdoor wood decking board a configuration including the thickness (T¹), a width (W²) wherein the width (W²) is ¼ inch less than width (W¹), and the length (L¹).

66. The outdoor wood decking board for use in construction of the outdoor deck floor, according to claim 65, wherein the facing wood veneered face-to-face wood core includes one or more aqueous compositions comprising one or more agents, wherein the one or more agents is selected from the group consisting of biocides, wood strength enhancers, fungicides, bactericides, insecticides water repellants, UV blockers, fire retardants, and wood hardeners.

67. The outdoor wood decking board for use in construction of the outdoor deck floor, according to claim 65, wherein the first wood core and the second wood core is each formed from a wood plastic composite.

68. The outdoor wood decking board for use in construction of the outdoor deck floor, according to claim 65, wherein the first wood core and the second wood core is each formed from a cement board.

69. The outdoor wood decking board for use in construction of the outdoor deck floor, according to claim 65, wherein the facing wood veneer is formed from an exotic hardwood species, wherein the exotic hardwood species is selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Militia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

70. The outdoor wood decking board for use in the construction of the outdoor deck floor, according to claim 65, wherein:
the first wood core is configured including the thickness (T³) of about ¾ inch, the width (W¹) of about 5½ inches, and the length (L¹) of about 8.00-20.00 feet inclusive;
the second wood core is configured including the thickness (T³) of about ¾ inch, the width (W¹) of about 5½ inches, and the length (L¹) of about 8.00-20.00 feet inclusive;
the face-to-face wood core is sized via a planer or moulder to the thickness of (T⁵) of about 1⅜ inches;
the facing wood veneer is configured including the thickness (T²) of about ⅛ inch, the width (W²) of about 5½ inches, and the length (L¹) of about 8.0-20.0 feet inclusive, and thereby, the facing wood veneered face-to-face wood core is configured with the thickness (T¹) of about 1½ inches, the width (W¹) of about 5½ inches, and the length (L¹) of about 8.0 feet-20.0 feet inclusive; and
the facing wood veneered face-to-face wood core is sized via the planer or moulder to the thickness (T¹) of about 1½ inches, the width (W²) of about 5¼ inches, and the length (L¹) of about 8.00-20.00 feet inclusive.

71. The outdoor wood decking board for use in the construction of the outdoor deck floor, according to claim 65 wherein:
the first wood core is configured including the thickness (T³) of about ¾ inch, a width (W³) of about 3½ inches, and the length (L¹) of about 8.00 feet-20.00 feet inclusive;
the second wood core is configured including the thickness (T³) of about ¾ inch, the width (W³) of about 3½ inches, and the length (L¹) of about 8.00-20.00 feet inclusive;
the face-to-face wood core is sized via the planer or moulder to the thickness of (T⁵) of about 1⅜ inches;
the facing wood veneer is configured including the thickness (T ²) of about ⅛ inch, the width (W³) of about 5½ inches, and the length (L¹) of about 8.0 feet-20.0 feet, and thereby, the facing wood veneered face-to-face wood core is configured with the thickness (T¹) of about 1½ inches, the width (W³) of about 3½ inches, and the length (L¹) of about 8.00-20.0 feet inclusive; and
wherein the facing wood veneered face-to-face wood core is sized to form the outdoor wood decking board via the planer or moulder to the thickness (T¹) of about 1½ inches, a width (W⁴) of about 3¼ inches, and the length (L¹) of about 8.00-20.00 feet inclusive.

72. The outdoor wood decking board for use in the construction of the outdoor deck floor, according to claim 65 wherein:
the first wood core is configured including the thickness (T³) of about ¾ inch, a width (W⁵) of about 7¼ inches, and the length (L¹) of about 8.00-20.00 feet inclusive;
the second wood core is configured including the thickness (T³) of about ¾ inch, the width (W⁵) of about 7¼ inches, and the length (L¹) of about 8.00-20.00 feet inclusive;
the face-to-face wood core is sized via the planer or moulder to the thickness of (T⁵) of about 1⅜ inches;
the facing wood veneer is configured including the thickness (T²) of about ⅛ inch, the width (W⁵) of about 7¼ inches, and the length (L¹) of about 8.00-20.00 feet, and thereby, the facing wood veneered face-to-face wood core is configured with the thickness (T¹) of about 1½ inches, the width (W⁵) of about 7¼ inches, and the length (L¹) of about 8.00-20.0 feet inclusive; and
the facing wood veneered face-to-face wood core is sized to form the outdoor wood decking board via the planer or moulder to the thickness (T¹) of about 1½ inches, a width (W⁶) of about 7⅛ inches, and the length (L¹) of about 8.00-20.00 feet inclusive.

73. The outdoor wood decking board for use in construction of the outdoor deck, according to claim 65, wherein the pressure sensitive liquid adhesive is a polyvinylacetate.

74. The outdoor wood decking board for use in construction of the outdoor deck floor, according to claim 65, wherein the pressure sensitive liquid adhesive is a melamine resin adhesive including a liquid hardener,

75. The outdoor wood decking board for use in construction of the outdoor deck floor, according to claim 65, wherein the pressure sensitive liquid adhesive is a crosslinking vinyl acetate, wherein the crosslinking vinyl acetate has a solid content of about 52% and a ph about 5.5-6.0.

76. The outdoor wood decking board for use in construction of the outdoor deck floor, according to claim 65, wherein the pressure sensitive liquid adhesive is a crosslinking vinyl acetate, wherein the crosslinking vinyl acetate has a solid content of about 46% and a ph of about 4.5-5.5.

77. The outdoor wood decking board for use in construction of the outdoor deck floor, according to claim 65, wherein the pressure sensitive liquid adhesive is a polymerized polyurethane reactive adhesive.

78. The outdoor wood decking board for use in construction of the outdoor deck floor, according to claim 65, wherein the pressure sensitive liquid adhesive is a polyurethane resin adhesives.

79. A method of manufacturing an outdoor wood decking board for use in the construction of an outdoor deck floor, the method, comprising:
providing a wood core formed from a first wood species, wherein the first wood species is a tight knot western red cedar of a North American Softwood species, formed as a three dimensional solid rigid wood body providing a tight knot western red cedar wood core;
configuring the tight knot western red cedar wood core having a thickness (T¹) of about 1½ inches, a width (W¹) of about 5½ inches, and a length (L¹) of about 8.00-20.00 feet inclusive, the tight knot western red cedar wood core including a first wood face, a second wood face opposed to the first wood face, and dual opposite longitudinal wood side edges;
drying the tight knot western red cedar wood core to a moisture content suitable for receiving a pressure sensitive liquid adhesive, wherein the pressure sensitive liquid adhesive is a melamine resin adhesive;
sizing the tight knot western red cedar wood core through a planer or a moulder to a thickness (T³) of about 1⅜ inches, the width (W¹) of 5½ inches, and the length (L¹) of 8.00-20.00 feet inclusive;
providing a facing wood veneer formed from a second wood species, wherein the second wood species is a superior grade clear vertical grain western red cedar, formed as a three dimensional solid rigid layer providing a clear vertical grain western red cedar facing wood veneer;
configuring the clear vertical grain western red cedar facing wood veneer having a thickness (T²) of about ⅛ inch, the width (W¹) of about 5½ inches, and the length (L¹) of about 8.00-20.00 feet inclusive, the clear vertical grain western red cedar facing wood veneer including a first wood finishing face, a second wood finishing face opposed to the first wood finishing face, and dual opposing longitudinal facing wood veneer side edges;
providing a pressure sensitive liquid adhesive;
spreading the pressure sensitive liquid adhesive through an adhesive spreading machine such that the pressure sensitive liquid adhesive covers the entire first wood face of the tight knot western red cedar wood core;
overlaying the second wood finishing face of the clear vertical grain western red cedar facing wood veneer against the first wood face of the tight knot western red cedar wood core;
laminating the clear vertical grain western red cedar facing wood veneer against the first wood face of the tight knot western red cedar wood core through an automated hydraulic press under heat and pressure for providing a visually seamless permanent attachment of the clear vertical grain western red cedar wood veneer against the first wood face of the tight knot western red cedar wood core forming a facing wood veneered wood core including a clear grade vertical grain western red cedar veneered tight knot western red cedar wood core such that the first wood finishing face of the clear grade vertical grain western red cedar facing wood veneer is displayed to a viewer, thereby, a plurality of wood decking boards adapted to be arranged along interior longitudinal wood side edges of each other form an assembled simulated non-cactile clear vertical grain western red cedar outdoor deck floor of pre-configured dimensions wherein the clear grade vertical grain western red cedar veneered tight knot western red cedar wood core is configured including the thickness (T¹) of about 1½ inches, the width (W¹) of about 5½ inches; and the length (L¹) of about 8.00-20.00 feet inclusive;
removing the clear grade vertical grain western red cedar veneered tight knot western red cedar wood core from the automated hydraulic press;
cooling the clear vertical grain western red cedar veneered tight knot western red cedar wood core at ambient temperature; and
sizing the clear vertical grain western red cedar veneered tight knot western red cedar wood core through the planer or moulder to form the outdoor wood decking board configured including the thickness (T¹) of about 1½ inches, a width (W²) of about 5¼ inches, and the length (L¹) of about 8.00-20.00 feet.

80. The method, according to claim 79, wherein:
the first wood species of the wood core is formed from a common grade or general purpose grade of a North American Softwood species, wherein the North American Softwood species is selected from the group consisting of Western Red Cedar (Thuja plicate), (Thuj occidentalis), Douglas Fir (Pseudotsuga menziesii), Western Larch (Larix occidentalis), Alpine Larch (Larix lyallii), Alaskan Yellow Cedar(Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species); and
wherein the second wood species of the facing wood veneer, is selected from a superior grade clear grain of a North American Softwood species, wherein the North American Softwood species is selected from the group consisting of western red cedar, (Thuja plicate), (Thuja occidentalis), Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species).

81. The method, according to claim 79, wherein the facing wood veneer is formed from the second wood species, wherein the second wood species is an exotic hardwood species, wherein the exotic hardwood species is selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C, regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

82. The method, according to claim 79, further comprising providing a second facing wood veneer permanently seamlessly attached to the second wood face of the wood core via the pressure sensitive liquid adhesive.

83. The method, according to claim 79, further comprising sanding the veneered tight knot western red cedar wood core in preparation of staining the veneered tight knot western red cedar wood core.

84. The method, according to claim 79, further comprising applying a colorless wood conditioner to the clear grade vertical grain western red cedar veneered tight knot western red cedar wood core wherein the colorless wood conditioner comprises one or more agents, wherein an agent of the one or more agents is selected from the group comprising, fungicides, biocides, insecticides, water repellents, UV blockers, fire retardants, wood hardeners, and strength enhances.

85. The method, according to claim 79, wherein:
the length (L¹) of the wood core can be configured to a length selected from the group of lengths comprising, 8.00 feet, 10.00 feet, 12.00 feet, 14.00 feet, 16.00 feet, 18.00 feet, and 20.00 feet; and
the length (L¹) of the facing wood veneer can be configured to a length selected from the group of lengths comprising, 8.00 feet, 10.00 feet, 12.00 feet, 14.00 feet, 16.00 feet, 18.00 feet, and 20.00 feet.

86. The method, according to claim 79, wherein:
the length (L¹) of the wood core can be pre-configured to a length selected from the group of lengths comprising, 9.00 feet, 11.00 feet, 13.00 feet, 15.00 feet, 17.00 feet, 19.00 feet, and 21.00 feet; and
the length (L¹) of the facing wood veneer can be pre-configured to a length selected from the group of lengths comprising, 9.00 feet, 11.00 feet, 13.00 feet, 15.00 feet, 17.00 feet, 19.00 feet, and 21.00 feet.

87. The method, according to claim 79, wherein:
the wood core is configured including the thickness (T¹) of about 1½ inches, a width (W³) of about 3½ inches, and the length (L¹) of about 8.00-20.00 feet inclusive;
the wood core is sized via the planer or moulder to a configuration including the thickness (T⁵) of about 1⅜ inches, a width (W³) of about 3½ inches, and the length (L¹) of about 8.00-20.00 feet inclusive;
the facing wood veneer is configured including the thickness (T²) of about ⅛ inch, the width (W¹) of about 5½ inches, and the length (L¹) of about 8.00-20.00 feet inclusive;
the facing wood veneered wood core is configured including the thickness (T¹) of about 1/½ inches, the width (W³) of about 3½ inches, and the length of about 8.00-20.00 feet inclusive; and
the facing wood veneered wood core is sized via the planer or moulder to form the outdoor wood decking board to a configuration including the thickness (T¹) of about 1½ inches, a width (W⁴) of about 3¼ inches, and the length (L¹) of about 8.00-20.00 feet inclusive.

88. The method, according to claim 79, wherein:
the wood core is configured including a thickness (T⁴) of about 1⅛ inches, the width (W¹) of about 5½ inches, and the length (L¹) of about 8.00-20.00 feet inclusive;
the wood core is sized via the planer or moulder to a configuration including a thickness (T⁶) of about 1.0 inch, the width (W¹) of about 5½ inches, and a length (L¹) of about 8.00-20.00 feet inclusive;
the facing wood veneer is configured including the thickness (T²) of about ⅛ inch, the width (W¹) of about 5½ inches, and the length (L¹) of about 8.00-20.00 feet;
the facing wood veneered wood core is configured including the thickness (T⁴) of about 1⅛ inches, the width (W¹) of about 5½ inches, and the length (L¹) of about 8.00-20.00 feet inclusive; and
the facing wood veneered wood core is sized via the planer or moulder to form the outdoor wood decking board to a configuration including the thickness (T⁴) of about 1⅛ inches, the width (W ²) of about 5¼ inches, and the length (L¹) of about 8.00-20.00 feet inclusive.

89. The method, according to claim 79, wherein:
the wood core is configured including a thickness (T⁴) of about 1⅛ inches, a width (W³) of about 3½ inches, and the length (L¹) of about 8.00-20.00 feet inclusive;
the wood core is sized via the planer or moulder to a configuration including a thickness (T(⁵) of about 1.0 inch, the width (W³) of about 3½ inches, and the length (L¹) of about 8.00-20.00 feet inclusive;
the facing wood veneer is configured including the thickness (T²) of about ⅛ inch, the width (W³) of about 3½ inches, and the length (L¹) of about 8.00-20.00 feet inclusive;
the facing wood veneered wood core is configured including the thickness (T⁴) of about 1⅛ inches, the width (W³) of about 3½ inches, and the length (L¹) of about 8.00-20.00 feet inclusive; and
the facing wood veneered wood core is sized via the planer or moulder to form the outdoor wood decking board to a configuration including the thickness (T⁴) of about 1⅛ inches, a width (W⁴) of about 3¼ inches, and the length (L¹) of about 8.00-20.00 feet inclusive.

90. The method, according to claim 79, wherein:
the wood core is configured including the thickness (T¹) of about 1½ inches, a width (W⁵) of about 7¼ inches, and the length (L¹) of about 8.00 to 20.00 feet inclusive;
the wood core is sized via the planer or moulder to a configuration including the thickness (T⁵) of about 1⅜ inches, the width (W⁵) of about 7¼ inches, and the length (L¹) of about 8.00-20.00 feet inclusive;
the facing wood veneer is configured including the thickness (T²) of about ⅛ inch, the width (W⁵) of about 7¼ inches, and the length (L¹) of about 8.00-20 feet inclusive;
the facing wood veneered wood core is configured including the thickness (r) of about 1½ inches, the width (W⁵) of about 7¼ inches, and the length (L¹) of about 8.00-20.00 feet inclusive; and
the facing wood veneered wood core is sized via the planer or moulder to form the outdoor wood decking board to a configuration including the thickness (T¹) of about 1½ inches, a width (W⁶) of about 7⅛ inches, and the length (L¹) of about 8.00-20.00 feet inclusive.

91. The method, according to claim 79, wherein the pressure sensitive liquid adhesive is the melamine resin adhesive including a liquid hardener.

92. The method, according to claim 79, wherein the adhesive is polyvinylacetate.

93. The method, according to claim 79, wherein the pressure sensitive liquid adhesive is a crosslinking vinyl acetate, wherein the crosslinking vinyl acetate has a solid content of about 52% and a ph about 5.5-6.0.

94. The method, according to claim 79, wherein the pressure sensitive liquid adhesive is a crosslinking vinyl acetate, wherein the crosslinking vinyl acetate has a solid content of about 46% and a ph of about 4.5-5.5.

95. The method, according to claim 79, wherein the pressure sensitive liquid adhesive is a polymerized polyurethane reactive adhesive.

96. The method, according to claim 79, wherein the pressure sensitive liquid adhesive is a polyurethane resin adhesives.

97. A method of manufacturing an outdoor wood decking board for use in the construction of an outdoor deck floor, the method, comprising:
providing a first wood core formed from a first wood species as a three dimensional solid rigid wood body¹ including a thickness (T³) of about ¾ inch, a width (W¹) of 5½ inches, and a length (L¹) of about 8.00 feet, the first wood core including a first wood face¹, a second wood face¹ opposed to the first wood face¹, and dual opposite longitudinal wood side edges, wherein the first wood species is a tight knot western red cedar species thereby forming a first tight knot western red cedar wood core;
providing a second wood core formed from the tight knot western red cedar species as a three dimensional solid rigid wood body configured as a second tight knot western red cedar wood core including the thickness (T³) of about ¾ inch, the width (W¹) of 5½ inches, and the length (L¹) of about 8.00 feet thereby providing a second tight knot western red cedar wood core including a first wood face², a second wood face² opposed to the first wood face¹, and dual opposite longitudinal wood side edges²;
drying the first tight knot western red cedar wood core and the second tight knot western red cedar wood core to a moisture content suitable for receiving a pressure sensitive liquid adhesive;
providing the pressure sensitive liquid adhesive;
spreading the pressure sensitive liquid adhesive applied to the second wood face²of the second tight knot western red cedar wood core and to the second wood face¹ of the first tight knot western red cedar wood core through an adhesive spreading machine such that the pressure sensitive adhesive covers the entire second wood face² face of the second tight knot western red cedar wood core and the entire second wood face¹ of the first tight knot western red cedar wood core;
overlaying the second wood face²of the second tight knot western red cedar wood core against the second wood face¹of the first tight knot western red cedar wood core through an automated hydraulic press under heat and pressure enabling and operable for providing a visually seamless permanent attachment of the first of the second wood face¹ of the first tight knot western red cedar wood core against the second wood face¹ of the second tight knot western red cedar wood core forming a face-to-face wood core including a tight knot western red cedar face-to-face wood core simulating a single three dimensional solid rigid wood body having a thickness (T¹) of about 1½ inches, the width (W¹) of about 5½ inches, and the length of about 8.00 feet, wherein the first wood face¹ of the first tight knot western red cedar wood core is opposed to the first wood face² of the second tight knot western red cedar wood core;
removing the tight knot western red cedar face-to-face wood core from the automated hydraulic press;
cooling the tight knot western red cedar face-to-face wood core at ambient temperature; and
sizing the tight knot western red cedar face-to-face wood core via a planer or a moulder to a thickness (T⁵) of about 1⅜ inches, the width (W¹) of about 5½ inches, and the length of about 8.00 feet;
providing a facing wood veneer formed from a second wood species as a three dimensional solid rigid finishing layer including a thickness (T²) of about ⅛ inch, the width (W¹) of about 5½ inches, and the length (L¹) of about 8.00 feet, the first facing wood veneer including a first wood finishing face, a second wood finishing face opposed to the first wood finishing face, and dual opposing longitudinal facing wood veneer side edges, wherein the second wood species is a clear vertical grain western red cedar thereby providing a clear vertical grain western red cedar facing wood veneer;
spreading the pressure sensitive liquid adhesive through the adhesive spreading machine such that the pressure sensitive liquid adhesive covers the entire first wood face¹ of the first tight knot western red cedar wood core of the tight knot western red cedar face-to-face wood core;
overlaying the second wood finishing face of the clear vertical grain western red cedar facing wood veneer against the first wood face¹ of the first tight knot western red cedar wood core of the tight knot western red cedar face-to-face wood core:
laminating the clear vertical grain western red cedar facing wood veneer against the tight knot western red cedar face-to-face wood core through the automated hydraulic press under heat and pressure enabling and operable for providing a seamless permanent attachment of the second wood finishing face of the clear vertical grain western red cedar facing wood veneer against the first wood face¹ of the first tight knot western red cedar wood core of the tight knot western red cedar face-to-face wood core forming a facing wood veneered face-to-face wood core including a clear vertical grain western red cedar veneered tight knot western red cedar face-to-face wood core such that the first finishing face of the clear vertical grain western red cedar facing wood veneer is displayed to a viewer, thereby a plurality of wood decking boards adapted to be arranged along interior longitudinal wood side edges of each other thereby form an assembled simulated non-cactile clear vertical grain western red cedar outdoor deck floor formed of pre-configured dimensions including the thickness (T¹) of about 1½ inches, the width (W¹) of about 5½ inches, and the length (L¹) of about 8.00 feet; and
sizing the clear vertical grain western red cedar veneered tight knot western red cedar face-to-face wood core to form the outdoor wood decking board via a planer or moulder, the outdoor decking board configured including the thickness (T¹) of about 1½ inches, a width (W²) of about 5¼ inches, and the length (L¹) of about 8.00 feet.

98. The method, according to claim 97, wherein the pressure sensitive liquid adhesive is a polyvinylacetate.

99. The method, according to claim 97, wherein the pressure sensitive liquid adhesive is a melamine resin adhesive including a liquid hardener.

100. The method, according to claim 97, wherein the pressure sensitive liquid adhesive is a crosslinking vinyl acetate, wherein the crosslinking vinyl acetate has a solid content of about 52% and a ph about 5.5-6.0.

101. The method, according to claim 97, wherein the pressure sensitive liquid adhesive is a crosslinking vinyl acetate, wherein the crosslinking vinyl acetate has a solid content of about 46% and a ph of about 5.5-6.0.

102. The method, according to claim 97, further comprising applying a colorless wood conditioner flood coat via an emersion process wood conditioner to the clear vertical grain western red cedar veneered tight knot western red cedar face-to-face wood core wherein the colorless wood conditioner comprises one or more agents, wherein an agent of the one or more agents is selected from the group comprising, fungicides, biocides, insecticides, water repellants, UV blockers, fire retardants, wood hardeners, and strength enhances.

103. The method, according to claim 97, wherein:
the first wood core and the second wood core are each formed from the first wood species, wherein the first wood species is selected from the group consisting of a common grade or general purpose grade of North American Softwood species, wherein the North American Softwood species is selected from the group consisting of western red cedar (Thuja plicata), (Thuja occidentalis), a Douglas Fir (Pseudotsuga menziesii), Western Larch (Larix occidentalis), Alpine Larch (Larix lyallii), Alaskan Yellow Cedar (Chamaecyparis nootkatensis), Hemlock (Tsuga heterophylla), Port of Oxford Cedar (Chamaecyparis lawsoniana), Redwood (Sequoia sempervirens), and Pine/Spruce (Pinus species, Picea species); and
the facing wood veneer is formed from the second wood species, the second wood species selected from a superior grade North American Softwood species, wherein the North American Softwood species is selected from the group consisting of clear vertical grain western red cedar, (Thuja plicata), (Thuja occidentalis), Douglas Fir (Pseudotsuga menziesii), Western Larch (Larix occidentalis), Alpine Larch (Larix lyallii), Alaskan Yellow Ceda (Chamaecyparis nootkatensis), Hemlock (Tsuga heterophylla), Port of Oxford Cedar (Chamaecyparis lawsoniana), Redwood (Sequoia sempervirens), Pine/Spruce (Pinus species, Picea species).

104. The method, according to claim 97, wherein the facing veneer is formed from an exotic hardwood wood species, wherein the exotic hardwood species is selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

105. The method, according to claim 97, wherein:
the first wood core is configured including the thickness (T³) of about ¾ inch, a width (W³) of about 3½ inches, and the length (L¹) of about 8.00-20.00 feet inclusive;
the second wood core is configured including the thickness (T³) of about ¾ inch, the width (W³) of about 3½ inches, and the length (L¹) of about 8.00 feet-20.00 feet inclusive;
the face-to-face wood core is sized via the planer or moulder to the thickness of (T⁵) of about 1⅜ inches;
the facing wood veneer is configured including the thickness (T²) of about ⅛ inch, the width (W³) of about 3½ inches, and the length (L¹) of about 8.00-20.00 feet, and thereby, the facing wood veneered face-to-face wood core is configured with the thickness (T¹) of about 1½ inches, the width (W³) of about 3½ inches, and the length (L¹) of about 8.00-20.00 feet inclusive; and
the clear vertical grain western red cedar veneered tight knot western red cedar face-to-face wood core is sized via the planer or moulder to form the outdoor wood decking board configured including the thickness (T¹) of about 1½ inches, a width (W⁴) of about 3¼ inches, and the length (L¹) of about 8.00-20.00 feet inclusive.

106. The method, according to claim 97 wherein:
the first wood core is configured including the thickness (T³) of about ¾ inch, a width (W⁵) of about 7¼ inches, and the length (L¹) of about 8.00 feet-20.0 feet inclusive;
the second wood core is configured including the thickness (T³) of about ¾ inch, the width (W⁵) of about 7¼ inches, and the length (L¹) of about 8.00 feet-20 feet inclusive;
the face-to-face wood core is sized via the planer or moulder to the thickness of (T⁵) of about 1⅜ inches;
the facing wood veneer is configured including the thickness (T²) of about ⅛ inch, the width (W⁵) of about 7¼ inches, and the length (L¹) of about 8.00-20.00 feet inclusive, and thereby, the facing wood veneered face-to-face wood core is configured with the thickness (T¹) of about 1½ inches, the width (W⁵) of about 7¼ inches, and the length (L ¹) of about 8.00-20.0 feet; and
the clear vertical grain western red cedar veneered tight knot western red cedar face-to-face wood core is sized via the planer or moulder to form the outdoor decking board configured including the thickness (T¹) of about 1½ inches, a width (W⁶) of about 7⅛ inches, and the length (L¹) of about 8.00-20.00 feet inclusive.

107. A method of manufacturing an outdoor wood decking board for use in the construction of an outdoor deck floor, the method, comprising:
providing a series of wood cores, each wood core of the series of wood cores is embodied in a separate individual three dimensional solid rigid wood body formed from a first wood species, including a thickness (T³) of about ¾ inch, a width (W¹) of about 5½ inches, and a length (L¹) of about 8.00-20.00 feet inclusive, wherein each wood core includes a first wood face, a second wood face opposed to the first wood face, and dual opposite longitudinal wood side edges, wherein the first wood species is a tight knot western red cedar species, thereby providing a series of tight knot western red cedar wood cores;
providing a protract wood core, wherein the protract wood core is embodied in a separate individual three dimensional solid rigid wood body¹ formed from the first wood species, the tight knot western red cedar, thereby providing a tight knot western red cedar protract wood core configured including a thickness (T⁸) of about ½ inch, the width (W¹) of about 5½ inches, and the length (L¹) of about 8.00-20.00 feet inclusive wherein the tight knot western red cedar protract wood core includes a first wood face¹, a second wood face¹ opposed to the first wood face¹, and dual opposite longitudinal wood side edges¹;
drying the tight knot western red cedar wood core and the tight knot western red cedar protract wood core to a moisture content suitable to receive a pressure sensitive liquid adhesive;
positioning the protract wood core centrally within the series of wood cores;
providing the pressure sensitive liquid adhesive;
spreading the pressure sensitive liquid adhesive through an adhesive spreading machine such that the pressure sensitive liquid adhesive covers an entire interior wood face of each of the tight knot western red cedar wood cores of the series of wood cores including entire interior wood faces of the tight knot western red cedar protract wood core;
overlaying the interior wood faces of each of the tight knot western red cedar wood cores of the series of wood cores including the interior faces of the tight knot western red cedar protract wood core against each other arranged horizontally adjacent to each other;
pressing the overlaid tight knot western red cedar wood cores of the series of wood cores including the tight knot western red cedar protract wood core through an automated hydraulic press under heat and pressure enabling and operable for providing a visually seamless permanent attachment of each of the tight knot western red cedar wood cores including the tight knot western red cedar protract wood core to each other forming a tight knot western red cedar complex assembly block simulating a single three dimensional solid rigid wood body including a first comples wood face and a second complex wood face opposite to the first complex wood face, a first end, a second end, and complex opposite longitudinal wood side edges configured including a thickness (T⁷) of about 5¾ inches, the width (W¹) of about 5½ inches, and the length (L¹) of about 8.00-20.00 feet inclusive;
cutting the tight knot western red cedar complex assembly block through one or more frontal planes via a cutting machine to form one or more tight knot western red cedar complex wood core assemblies including a thickness (T¹) of about 1½ inches, a width of about (W⁹) 5¾ inches, and the length of about 8.00-20.00 feet inclusive, wherein each tight knot western red cedar complex wood core assembly including the first complex wood face, and the second complex second wood face opposite to the first complex wood face, and the complex opposite longitudinal wood side edges;
providing a tight knot western red cedar complex wood core assembly;
sizing the tight knot western red cedar complex wood core assembly via a planer or moulder to a thickness (T⁵) of about 1⅜ inches, the width (W¹) of about 5½ inches, and the length (L¹) of about 8.00-20.00 feet;
providing a facing wood veneer, formed from a third wood species, wherein the third wood species is an exotic hardwood species, as a three dimensional solid rigid finishing layer including a thickness (T²) of about ⅛ inch, the width (W¹) of about 5½ inches, and the length (L¹) of about 8.00-20 feet inclusive; wherein the second wood species is a clear vertical western red cedar species thereby forming a clear vertical grain western red cedar facing wood veneer, the dear vertical grain western red cedar facing wood veneer including a first wood finishing face, a second wood finishing face opposed to the first wood finishing face, and dual opposing longitudinal facing wood veneer side edges;
providing the pressure sensitive liquid adhesive;
spreading the pressure sensitive liquid adhesive to the first complex wood face of the tight knot western red cedar complex wood core assembly via the adhesive spreading machine such that the pressure sensitive liquid adhesive covers the entire first complex wood face of the tight knot western red cedar complex assembly;
overalying the second wood finishing face of the clear vertical grain western red cedar facing wood veneer against the first complex wood face of the tight knot western red cedar complex wood core assembly;
laminating the clear vertical grain western red cedar facing wood veneer against the first complex wood face of the tight knot western red cedar complex wood core assembly through an automated hydraulic press under heat and pressure enabling and operable for providing a visually seamless permanent attachment of the clear vertical grain western red cedar facing wood veneer against the tight knot western red cedar complex wood core assembly to form a clear vertical grain western red cedar veneered tight knot western red cedar complex wood core assembly configured including the thickness (T¹) of about 1½ inches; the width (W¹) of about 5½ inches, and a length (L¹) of about 8.00-20.00 feet inclusive;
removing the clear vertical grain western red cedar veneered tight knot western red cedar complex wood core assembly from the automated hydraulic press; and
sizing the clear vertical grain western red cedar veneered tight knot western red cedar complex wood core assembly via the planer or moulder to a configuration including the thickness (T¹) of about 1½ inches, a width (W²) of about 5¼ inches, and the length (L¹) of about 8.00-20.00 feet inclusive; wherein the clear vertical grain western red cedar veneered tight knot western red cedar complex wood core assembly includes the first wood finishing face of the clear vertical grain western red cedar facing wood veneer displayed to a viewer, thereby, a plurality of clear vertical grain western red cedar facing wood veneered tight knot western red cedar complex wood core assemblies adapted to be arranged along the interior longitudinal wood side edges of each other to form an assembled simulated non-cactile clear grade vertical grain western red cedar deck floor of pre-configured dimensions.

108. The method, according to claim 107, wherein the first wood species is any one of a common grade or general purpose grade of North American Softwood species, wherein the North American Softwood species is selected from the group consisting of (Thuja plicata), (Thuja occidentalis), Douglas Fir (Pseudotsuga menziesii), Western Larch (Larix occidentalis), Alpine Larch (Larix lyallii), Alaskan Yellow Ceda (Chamaecyparis nootkatensis), Hemlock (Tsuga heterophylla), Port of Oxford Cedar (Chamaecyparis lawsoniana), Redwood (Sequoia sempervirens), Pine/Spruce (Pinus species, Picea species).

109. The method, according to claim 107, wherein the facing wood veneer is formed from a second wood species is any one of a superior grade North American Softwood species, wherein the North American Softwood species is selected from the group consisting of (Thuja plicata), (Thuja occidentalis), Douglas Fir (Pseudotsuga menziesii), Western Larch (Larix occidentalis) Alpine Larch (Larix lyallii), Alaskan Yellow Ceda (Chamaecyparis nootkatensis), Hemlock (Tsuga heterophylla), Port of Oxford Cedar (Chamaecyparis lawsoniana), Redwood (Sequoia sempervirens), Pine/Spruce (Pinus species, Picea species).

110. The method, according to claim 107, wherein the facing wood veneer is formed from a third wood species, the third wood species including an exotic hardwood wood species, wherein the exotic hardwood species is selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).

111. The method, according to claim 107, wherein the pressure sensitive liquid adhesive is a polyvinylacetate.

112. The method, according to claim 107, wherein the pressure sensitive liquid adhesive is a melamine resin adhesive including a liquid hardener.

113. The method, according to claim 107, wherein the pressure sensitive liquid adhesive is a crosslinking vinyl acetate, wherein the crosslinking vinyl acetate has a solid content of about 52% and a ph about 5.5-6.0.

114. The method, according to claim 107, wherein the pressure sensitive liquid adhesive is a crosslinking vinyl acetate, wherein the crosslinking vinyl acetate has a solid content of about 46% and a ph of about 4.5-5.5.

115. The method, according to claim 107, wherein the pressure sensitive liquid adhesive is a polymerized polyurethane reactive adhesive.

116. The method, according to claim 107, wherein the pressure sensitive liquid adhesive is a polyurethane resin adhesives.

117. A method of manufacturing an outdoor wood decking board for use in the construction of an outdoor deck floor, the method, comprising;
providing a core formed from a rigid solid substrate as a three dimensional solid rigid body;
wherein the rigid solid substrate is a wood plastic composite enabling and operable to form a wood plastic composite core;
configuring the wood plastic composite core having a thickness (T¹) of about 1½ inches, a width (W¹) of about 5½ inches, and a length (L¹) of about 8.00-20.00 feet inclusive, the wood plastic composite core including a first face, a second face opposed to the first face, a first end, a second end, and opposite longitudinal side edges;
sizing the wood plastic composite core through a planer or a moulder to a thickness (T³) of about 1⅜ inches, the width (W¹) of 5½ inches, and the length (L¹) of 8.00-20.00 feet inclusive;
providing a facing wood veneer formed from a second wood species of superior grade clear grain North American Softwood species as a three diemensional solid rigid finishing layer, wherein the superior grade clear grain North American Softwood species is a clear grain western red cedar enabling and operable to provide a clear grain western red cedar facing wood veneer;
configuring the clear grain western red cedar facing wood veneer having a thickness (T²) of about ⅛ inch, the width (W¹) of about 5½ inches, and the length (L¹) of about 8.00-20.00 feet inclusive, the clear grain western red cedar facing wood veneer includes a first wood finishing face, a second wood finishing face opposed to the first wood finishing face, a first finishing end, a second finishing end, and opposing longitudinal facing wood veneer side edges;
providing a pressure sensitive liquid adhesive;
spreading the pressure sensitive liquid adhesive through an adhesive spreading machine such that the pressure sensitive liquid adhesive covers the entire first face of the wood plastic composite core;
overlaying the second finishing face of the clear grain western red cedar facing wood veneer against the first face of the wood plastic composite core;
laminating the second wood finishing face of the clear grain western red cedar facing wood veneer against the wood plastic composite through an automated hydraulic press under heat and pressure for providing a visually seamless permanent attachment of the clear grain western red cedar facing wood veneer against the wood plastic composite core forming a clear grain western red cedar veneered wood plastic composite core such that the first wood finishing face of the clear grain western red cedar facing wood veneer is displayed to a viewer, thereby, a plurality of wood decking boards adapted to be arranged along interior longitudinal side edges of each other form an assembled simulated non-cactile clear grain western red cedar outdoor deck floor of pre-configured dimensions wherein the clear grain western red cedar veneered wood plastic composite core is configured including the thickness (T¹) of about 1½ inches, the width (W¹) of about 5½ inches; and the length (L¹) of about 8.00-20.00 feet inclusive;
removing the clear grain western red cedar veneered wood plastic composite core from the automated hydraulic press;
cooling the clear grain western red cedar veneered wood plastic composite core at ambient temperature; and
sizing the clear grain western red cedar veneered plastic wood core through the planer or moulder to form the outdoor wood decking board configured including the thickness (T¹) of about 1½ inches, a width (W²) of about 5¼ inches, and the length (L¹) of about 8.00-20.00 feet inclusive.

118. The method, according to claim 117, wherein the rigid solid substrate is a cement board.

119. The method, according to claim 117, wherein the pressure sensitive liquid adhesive is a polyvinylacetate.

120. The method, according to claim 117, wherein the pressure sensitive liquid adhesive is a melamine resin adhesive including a liquid hardener.

121. The method, according to claim 117, wherein the pressure sensitive liquid adhesive is a crosslinking vinyl acetate, wherein the crosslinking vinyl acetate has a solid content of about 52% and a ph about 5.5-6.0.

122. The method, according to claim 117, wherein the pressure sensitive liquid adhesive is a crosslinking vinyl acetate, wherein the crosslinking vinyl acetate has a solid content of about 46% and a ph of about 4.5-5.5.

123. The method, according to claim 117, wherein the pressure sensitive liquid adhesive is a polymerized polyurethane reactive adhesive.

124. The method, according to claim 117, wherein the pressure sensitive liquid adhesive is a polyurethane resin adhesives.

125. The method, according to claim 117, wherein the second wood species is any one of a superior grade North American Softwood species, wherein the North American Softwood species is selected from the group consisting of (Thuja plicata), (Thuja occidentalis), Douglas Fir (Pseudotsuga menziesii), Western Larch (Larix occidentalis), Alpine Larch (Larix lyallii), Alaskan Yellow Ceda (Chamaecyparis nootkatensis), Hemlock (Tsuga heterophylla), Port of Oxford Cedar (Chamaecyparis lawsoniana), Redwood (Sequoia sempervirens), Pine/Spruce (Pinus species, Picea species).

126. The method, according to claim 117, wherein the facing wood veneer is formed from a third wood species, the third wood species including an exotic hardwood wood species, wherein the exotic hardwood species is selected from the group consisting of African Padauk (Pterocarpus soyauxii); African Walnut (Lovoa trichilioides); African Mahogany Khaya anthotheca; Khaya grandifoliola; Khaya ivorensis; Khaya senegalensis; Hondoran Mahogany-Swietenia macrophylla; and Cuba Mahogany Swietenia mahogany; and Mexican Mahogany (Swietnia bumilis), Swietenia mahogani; Bamboo (Phyllostachys and Bambusa genera); Bosse, Guarea (Guarea spp., G. cedrata and G. thompsonii); Bulletwood, Massaranduba (Manilkara bidentata); Burma Padauk (Pterocarpus macrocarpus); Cancharana (Cabralea cangerana); Cebil (Anadenanthera colubrina); Chico Zapote, Zapote, Sapodilla (Manilkara zapota); Cumaru (Dipteryx odorata); Ipe (Handroanthus species); Iroko (Milicia excelsa, M. regia (syn. Chlorophora excelsa, C. regia)); Jatoba (Hymenaea courbaril); Koa (Acacia Koa); Santos Mahogany (Myroxylon balsamum), (Meliaceae species); Makore (Tieghemella species); African Padauk (Pterocarpus soyauxii); Purple Heart (Peltogyne spp.); River Red Gum (Eucalyptus camaldulensis); Sapele (Entandrophragma cylindricum); Shedua (Ovangkol) (Guibourtia ehia); Sirari (Guibourtia hymenaeifolia); Spanish Cedar (Cedrela odorata); Tamarind (Tamarindus indica); Teak (Tectona grandis); Ebony Blackbead (Ebenopsis ebano); African Blackwood (Dalbergia melanoxylon); and Bismarck Black Myzomela (Myzomela pammelaena).
